(19) United States
(12) Patent Application Publication
(10) Pub. No.: US 2017/0309093 A1
(43) Pub. Date: Oct. 26, 2017

(54) VEHICLE OPERATION MONITORING, OVERSEEING, DATA PROCESSING AND OVERLOAD MONITORING METHOD AND SYSTEM

(71) Applicant: Chunkui FENG, Shenzhen (CN)

(72) Inventor: Chunkui FENG, Shenzhen (CN)

(21) Appl. No.: 15/592,218

(22) Filed: May 11, 2017

Related U.S. Application Data
(63) Continuation of application No. PCT/CN2015/094348, filed on Nov. 11, 2015.

(30) Foreign Application Priority Data
Nov. 11, 2014 (CN) 2014106330626
Jul. 23, 2015 (CN) 2015104419697
Nov. 10, 2015 (CN) 201510758385.2

(51) Int. Cl. G07C 5/08

(52) U.S. Cl. CPC G07C 5/0808

(57) ABSTRACT

The present invention discloses a method and system for data measurement and calculation, monitoring, surveillance and processing of integrated vehicles. In the method, a measurement and calculation object is one of vehicle operation parameters; data at least including a joint operation value of the measurement and calculation object is acquired for identifying the power transmission conditions of a vehicle; the joint operation value of the measurement and calculation object is a result obtained by calculation based on the acquired value of input parameters; the calculation is calculation based on a longitudinal dynamic model of the vehicle; and the input parameters are all parameters in the model except the measurement and calculation object.

### FIELD OF THE INVENTION

The present invention relates to the field of vehicle technology, and more specifically, to a method combining data detecting, monitoring and processing and system thereof.

### BACKGROUND OF THE INVENTION

A vehicle is one of the most important means of transportation and is closely related to life safety of drivers and passengers.

According to structural division, the vehicle generally has a power system for generating power and a (mechanical) transmission system for transferring power; the power system generally includes an energy supply unit, a power control unit and a power unit; and any one or more components which can be operated in a rotating state in the power system and the (mechanical) transmission system for transferring the power of the vehicle can be called rotary operation type power or transmission components of the vehicle.

According to division by power system categories, the vehicle has a fuel power system, an electric power system, a hybrid power system, etc.; fuel power vehicles include gasoline-powered vehicles, diesel-powered vehicles, natural gas-powered vehicles and the like; electric power vehicles include plug-in electric vehicles, fuel cell electric vehicles and the like; and hybrid power vehicles simultaneously include two or more power systems, such as fuel power systems, electric power systems, etc.

An existing fuel power vehicle generally has a fuel power system and a mechanical transmission system; the fuel power system generally includes a fuel supply system, an engine control system and a fuel engine, wherein the fuel engine generally has a cylinder body, a piston and a power outputting crankshaft mechanism; the mechanical transmission system generally includes a fuel engine output shaft, a driving wheel, and an intermediate mechanical transmission component (including a transmission shaft, a transmission gear mechanism and the like) between the fuel engine output shaft and the driving wheel; the fuel engine output shaft, the driving wheel and the intermediate mechanical transmission component may be operated in a high-speed rotating state, and any one or more components in the serial assemblies can be called rotary operation type power or transmission components of the vehicle.

An existing electric vehicle generally also has the electric power system and the mechanical transmission system; the electric power system generally includes a power supply unit, a motor driving device and a motor; any one or more components in a motor rotor, a motor output shaft, the driving wheel and the intermediate mechanical transmission component between the motor output shaft and the driving wheel in the electric vehicle can be called rotary operation type power or transmission components of the electric power vehicle; some wheel hub motor vehicles can further integrate the power system and the mechanical transmission system into a whole.

Because various stress sensors cannot be conveniently installed on the rotary operation type power or transmission components of the vehicle instead of fixed operation components for the convenience of detection of inner stress conditions of the various components, if a stress or torque sensor is installed on a fixed supporting assembly, real stress conditions of a rotating component are inconveniently detected, and if the sensor is installed inside the rotating component, a signal is inconvenient to transmit or a sensor power supply unit is inconvenient to install. Thus, an existing torque sensor which can be applied to the rotary operation type power or transmission components of the vehicle is high in cost; and low-cost monitoring of operation conditions (particularly early faults) of the rotary operation type power or transmission components of the vehicle is a worldwide problem.

In order to solve the problem above, solutions are divided into two categories in the prior art:

A, a local device type monitoring solution: an existing tire pressure monitoring system can be monitored only when the tire pressure or wheel speed obviously changes, has low response speed and does not have any monitoring capability on deformation (out-of-round) of the tire or on operation of other rigid rotating components; and the monitoring system does not have any monitoring effect on vehicles (such as high-speed rail vehicles and track vehicles) adopting rigid wheels (including the driving wheel).

B, a safety limit threshold value of universal vehicle operation parameters overruns that in a comparative technical solution:

in the prior art, multiple technologies of acquiring a joint operation value of vehicle mass exist so as to perform various variable speed control, brake and stability control, adaptive cruise control (ACC), ABS (anti-lock braking system) control, etc.; multiple methods and devices for calculating vehicle fuel consumption also exist so as to deduce behaviors of a driver for monitoring and training the driver and assisting a team owner, a transport company and a similar company as well as an insurance company in management; and multiple technical solutions for detecting the rotating speed of the rotating components as well as longitudinal velocity and longitudinal acceleration of the vehicle also exist so as to realize overspeed limit and other functions.

Because hundreds of vehicle operation conditions may exist and the vehicle is in switch of states such as low/high-speed, light/heavy load, acceleration/deceleration, uphill/downhill and the like at any time, the vehicle operation parameters (such as the longitudinal velocity, longitudinal acceleration, vehicle mass, torque, current, etc.) may have great changes in normal operation conditions. Therefore, in the prior art, simple response can be given only when the vehicle operation parameters exceed safety limit threshold values (such as a highest speed limit, an acceleration, safe load capacity, a maximum torque, current, etc.); before the vehicle operation parameters exceed the preset safety limit threshold values, vehicle operation safety conditions are inconvenient to be monitored, and high-sensitivity early monitoring is also inconvenient to be realized. Generally warning can be given only after passive and lagging waiting of serious safety accidents (such as breakage of a transmission main shaft and burst of a transmission gear, including tire burst in absence of a tire pressure monitoring system). A new system or method is required for identifying the operating condition of the vehicle or whether the situation is abnormal. The operating condition includes a vehicle power transmission condition and/or an overload condition.

### SUMMARY OF THE INVENTION

One of the technical problems to be solved in the present invention is to provide a technical solution for identifying the operating condition of the vehicle or judging whether the situation is abnormal.

A method for identifying power transmission conditions of a vehicle, comprising a solution:

a measurement and calculation object is one of vehicle operation parameters; the data at least comprising a joint operation value of the measurement and calculation object are acquired for identifying the power transmission conditions of the vehicle; the joint operation value of the measurement and calculation object is a result calculated based on the acquired values of the input parameters; the calculation is a calculation based on the longitudinal dynamic model of the vehicle; and the input parameters are all parameters in the model except the measurement and calculation object.

the method further comprises any one or more of the following characteristics A1, A2 and A3: A1, the parameter during calculation comprises or is a pavement slope; A2, if the model comprises rolling resistance, a calculation formula of the rolling resistance comprises the rolling resistance coefficient; and A3, when the measurement and calculation object is any one of the parameters to be measured and/or the source power parameters and/or the mechanical operation parameters, the acquired value of the gross vehicle mass included in the input parameters is the actual value.

Longitudinal dynamic model of the vehicle is a formula (fq=m2*(g*f*cos θ+g*sin θ+a)+fw) or a transformation of the formula, or the longitudinal dynamic model of the vehicle is a formula (Δa=ΔF/m2) or a transformation of the formula.

### BRIEF DESCRIPTION OF THE DRAWINGS

FIG. 1 is a schematic diagram of a handling method in the present invention;

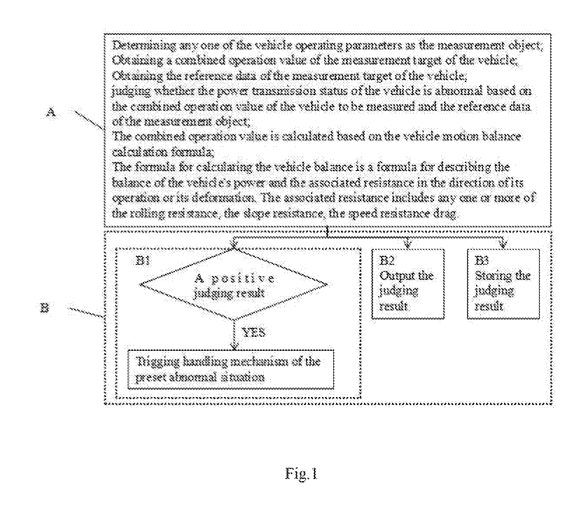

FIG. 2 is a schematic diagram of a monitoring system for a vehicle controlled to operate by a power unit in the present invention; and

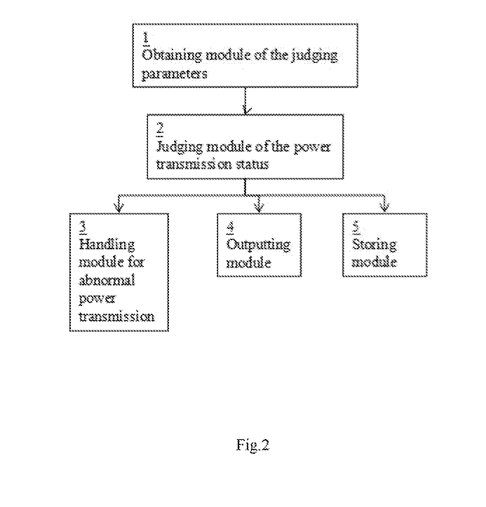

FIG. 3 is a schematic diagram showing a vehicle operation state.

### DETAILED DESCRIPTION OF THE INVENTION

In the present invention, data is a value and is equal to the value. For example, joint operation data is equal to a joint operation value, a measured value is equal to measured data, preset data is equal to a preset value, etc. A meaning of a direct combination of a plurality of well-known nouns is equal to a meaning of connection for adding a word “of” in the plurality of well-known nouns. For example, preset data is data which is preset, etc. A meaning of a direct combination of an unknown noun and a well-known noun is equal to a meaning of connection for adding a word “of” in the unknown noun and the well-known noun. For example, the joint operation data is data of joint operation (is also, data obtained by joint operation), a power transmission situation is a situation of transmission of power, etc. A calculation rule in the present invention, that is, a rule, is also correspondence, i.e. a model is a formula.

In the present invention, A is close to B means that an absolute value of a difference of A and B is less than a preset value; a range A is within a range B means that an upper limit value of the range A is less than or equal to an upper limit value of the range B, and a lower limit value of the range A is more than or equal to a lower limit value of the range B.

Analysis and research of data: the data (that is, parameter values) in the present invention generally has multiple attributes, i.e. time attributes, acquiring ways, range and the like. According to division of the time attributes, the data can be divided into current data, historical data and predicted data; the current value is a real-time value in absence of limited description; the historical data refers to data generated at a past time point; and time of data preferably refers to generated time of the data, and does not preferably refer to valuing time.

According to division of the acquiring ways, the data (or the parameter values) can be divided into measured, set and joint operation; and the data obtained by the joint operation (i.e. obtained by calculation based on a vehicle longitudinal dynamic model) is called joint operation data (or a joint operation value).

The set in the present invention refers to “is set”, i.e. preset, and set data is preset data (i.e. a preset value). The preset data can be further divided into system preset data (that is, a system preset value), manual preset data (that is, a manual preset value), instruction data (that is, an instruction value, i.e. instruction preset data), and a learning value of current operation; the manual preset data (or the manual preset value) is also called manual input data (or a manual input value); and the learning value of operation at that time is called a learning value for short.

The learning value of current operation generally refers to a numerical value obtained according to vehicle motion balance calculation performed when set conditions are met in a current operation process, i.e. the joint operation value is obtained through the vehicle motion balance calculation performed in advance, and also can be understood to be obtained according to a pre-acquired joint operation value.

The system preset data includes a historical record value, a fuzzy algorithm value and a system default value; and the historical record value includes a historical record original value, a historical record actual value, etc.

The measured data (or the measured value) is relatively easy to understand and refers to numerical values measured based on a sensor (or a hardware facility), such as an attack angle, a road gradient and the like measured by a dipmeter, etc. Values of position and speed measured based on information of a satellite navigation system (such as Beidou or GPS) also belong to measured values. Data obtained based on the measured data and through common calculation also belongs to a measured value. For example, torque T is measured and divided by a radius so as to obtain force, and the force is also a measured value. Special declaration: a result obtained based on partial measured data (such as source power parameters) and by performing vehicle motion balance calculation (the manner is a core point of the present invention) does not belong to a measured value, and is a joint operation value.

According to division of properties of data, the data can be divided into an actual value, instruction data (or an instruction value), a reasonable range (including a reasonable value), a safety range (a safety value), a special meaning value, etc.

In the present invention, any solution or data can be equivalently replaced into other technical solutions. Any formula in the present invention can be freely transformed, so that any parameter in the formula is transferred to the left of an equal sign of the formula to serve as a target parameter (or a measurement and calculation object), and other parameters are equivalently placed on the right so as to calculate the target parameter (or the measurement and calculation object); the transformation in the present invention is equivalent transformation.

Vehicle operation parameters: all parameters influencing a vehicle operation state, and/or all parameters related to vehicle operation, and/or all vehicle-related parameters can be called the vehicle operation parameters for short. Source power parameters, vehicle mass, system operation parameters (including mechanical operation parameters, system intrinsic parameters and mass change type object mass) in the present invention belong to the vehicle operation parameters; the parameters can be multiple parameters or parameter groups; and the system operation parameters in the present invention are system operation parameter groups. Other parameters which are not enumerated one by one in the present invention can be correspondingly classified by referring to parameter selection approaches and technical characteristics according to the concept of the present invention.

Derived parameters: parameters obtained by performing derivation, transformation, name change, deviation value increase, filtering, compensation interference, RLS algorithm processing, recursive least square processing and the like on the basis of any parameter in the present invention are called the derived parameters of the parameters, and all the derived parameters still belong to an original parameter type.

A third range in the present invention also can be called a conventional range (i.e. a compliance range), and the third range can refer to a normal range or a calibration range or a rated range of the parameter. The calibration range refers to a range when the parameter is in a preset or reasonable calibration state, and the calibration state is also called a nominal state or a standard state; the calibration range also can be a nominal range or a standard range. Correspondingly, in the present invention, the conventional value of the parameter is a value in the third range and refers to a normal value or a calibration value or a rated value of the parameter; the calibration value of the parameter refers to a value in the calibration range of the parameter and is preferably a central value in the calibration range; and the calibration value also can be a nominal value or a standard value.

A fourth range in the present invention refers to a safety range of the parameter; a safety range of the vehicle operation parameters (also can be called a safety limit threshold value or a safety permission value or a safety threshold value or a safety limit threshold value or a safety threshold value or a safety value) is a preset value of the vehicle operation parameters for preventing operation condition abnormality (or accidents) from occurring, or is a present value which is set according to a design specification of the power system so as to avoid device damage, such as a current safety value I_ena, a voltage safety value U_ena, a driving torque safety value T_ena, a power safety value P_ena, etc.; the safety values of the parameters can further include values set according to natural limit attributes of the vehicle operation parameters; for example, an upper limit value in a safety range of carried goods mass is naturally a maximum vehicle load safety value m_ena (also can be called legal loading capacity or maximum vehicle safety load mass), and a lower limit value in the safety range of the carried goods mass is naturally 0; a safety value of gross vehicle mass is a sum of safety values of no-load mass and carried goods mass; for example, an upper limit value in a safety range of residual fuel mass mf0 is fuel mass in maximum volume which can be loaded by a fuel container, and a lower limit value in the safety range of mf0 is naturally 0; an upper limit value in a safety range of fuel consumption fm2 is naturally a limit value which is comprehensively determined by various limit states (i.e. a maximum fuel duty which can be provided by a fuel supply pipeline in unit time, and other parameters), and a lower limit value in the safety range of fm2 is naturally 0; and in the present invention, the lower limit value in the safety range is also a minimum value in the safety value, and the upper limit value in the safety range is also a maximum value in the safety value.

An acceptable range of the parameters (i.e. a reasonable range) refers to a range of the parameters capable of realizing a certain purpose with practical value or representing natural attributes of the parameters (including input parameters); current actual values of the parameters, or values in the third range or values in the fourth range are values capable of representing natural attributes of the parameters (including the input parameters); the acceptable range can be the third range or the fourth range or the second range and is determined according to purposes; for example, power transfer condition identification and abnormality monitoring, etc. in the present invention are certain purposes with practical values; and when no limited description is provided, all the ranges in the present invention are the acceptable range (i.e. the reasonable range).

On the range, the third range is within the fourth range; the second permission range in the present invention can be called the second range for short; the first permission range can be called the first range for short; the second range refers to a range used for identifying the power transfer conditions and is a range with a special meaning; when a certain parameter is a parameter to be measured (i.e. a variable parameter), the second range of the parameter can float along with a normal change of an actual value of the parameter, and even float in a curve form; and an absolute value of the parameter can be less than an absolute value of the fourth range, and can also be more than the absolute value of the fourth range.

Apparently, any one or more of the first range, the second range, the third range, the fourth range and the acceptable range of the vehicle operation parameters can be preset; any parameter can be preset, and the standard value, the third range and the fourth range of the parameter can be adjusted; for example, a standard value of acceleration of gravity can be preset as 9.81, the third range can be preset as (9.5-10.5), the fourth range can be preset as (8.5-11.5), etc.

In the present invention, all parameters or data or solutions not explained in detail can be reasonably explained and induced according to the technical solutions or conception provided by the present invention. In the present invention, all preset data (i.e. preset value (particularly system preset values)) can be acquired by performing a manual trial and error method, a limited number of tests, type tests and any one or more ways in the prior art by production service providers, professional testing institutions or users of vehicles.

Apparently, the operation in the present invention mainly refers to operation without mechanical connection between the vehicle and ground facilities.

An unmeasurable parameter refers to that a value of the parameter cannot be acquired through a measured way during vehicle operation; measurable or unmeasurable is determined by hardware conditions of the vehicle; for example, if a certain vehicle is not provided with a sensor for measuring the parameter, the parameter is unmeasurable; a tire radius can be measured only in a static state by a ruler and is generally unmeasurable during vehicle operation; the gross vehicle mass can be weighed by a platform scale and generally cannot be measured during operation; generally speaking, the speed, the source power parameter, the longitudinal acceleration, wind resistance fw and the mass change type object mass (particularly fuel mass therein) belong to measurable parameters; common system intrinsic parameters, such as no-load vehicle mass m0, an efficiency coefficient, a rolling resistance coefficient f, an integrated transmission ratio im, a driving wheel radius R1 (also can be represented by R), the acceleration of gravity g, etc., are generally unmeasurable parameters during operation; and values of the unmeasurable parameters generally can be preset or selected through vehicle motion balance calculation only.

The parameter to be measured refers to that a difference value between a preset value of the acquired parameter and a current value of the parameter exceeds a preset reasonable (or set) range at a certain moment of normal operation of the vehicle, that is, the preset value of the acquired parameter cannot be used for describing a real situation of the parameter and cannot be normally used, namely, the current value of the parameter cannot be acquired in a preset manner. For example, the source power parameter, the speed, the longitudinal acceleration, the wind resistance fw and the mass change type object mass (particularly the fuel mass therein) belong to the parameter to be measured; the parameter to be measured can be also understood as the variable parameter; and the value of the parameter to be measured is acquired based on a measured value of the sensor.

1. Basic Description:

1.1. The present invention is mainly applicable to vehicles capable of being controlled to run along a pavement or a track by the power unit. The road surface includes a highway pavement, and the track includes a railway track. When limited description is provided, the operation in the present invention refers to longitudinal operation.

1.2. Overview of a Power Unit: referring to a unit for directly driving the vehicles to longitudinally operate along the pavement or the track.

The power unit of an electric power system is a motor, including an alternating-current motor, a direct-current motor, a wheel hub motor, etc. The power unit of a fuel power system refers to a fuel engine; and the power unit of a hybrid power system indicates that the unit is capable of simultaneously and directly driving the vehicles to longitudinally operate by virtue of two or more kinds of power (such as the motor, the fuel engine, etc.).

1.3. Overview of a Power Control Unit:

The power control unit of the electric power system is a motor driving device including a frequency converter, a servo driver, an integrated controller with motor driving capability, etc.; the power control unit of the fuel control system is a fuel engine control system; and the power control unit of the hybrid power system is a hybrid power control system.

1.4. Overview of an Energy Supply Unit:

The energy supply unit of the electric power system can be called a power unit and refers to a device for providing driving energy for the motor driving device, the motor and the vehicle, including power battery packs, hydrogen cells, nuclear energy, a solar energy power source, etc.; the energy supply unit of the fuel power system also can be called a fuel supply system, such as a fuel container (such as a fuel tank), a fuel supply pipe (such as an oil delivery pipe), etc.; and the energy supply unit of the hybrid power system can be called a hybrid energy supply system and can simultaneously include two or more energy supply units, such as a fuel supply system, a power unit, etc.

1.5. Descriptions of specific devices included in the power system: apparently, the power system in the present invention refers to the included devices after an acquisition point of a source power parameter signal in the complete power system.

In the electric power system, if the acquisition point of the source power parameter signal is at an input end of the power unit, the electric power system simultaneously includes three devices of the vehicle, that is, the power unit, the motor driving device and the motor; if the acquisition point is at an output end of the power unit or at an input end of the motor driving device, the electric power system simultaneously includes two devices: the motor driving device and the motor; and if the acquisition point is at an output end of the motor driving device or an input end of the motor, the electric power system only includes the motor.

In the fuel power system, if the acquisition point of the source power parameter signal is at a fuel input end of a fuel injection system of the vehicle, the fuel power system simultaneously includes the fuel injection system, a fuel engine and other devices of the vehicle; and if the acquisition point of the source power parameter signal is at a fuel injection output end of the fuel injection system of the vehicle, the fuel power system includes the fuel engine, etc.

The power unit, the power control unit and the energy supply unit are arbitrarily combined into a whole or into an integrated system.

1.6. For acquisition of values of parameter groups or parameters in the present invention, acquiring ways include the following: measuring and reading preset values and the like; reading parameter values of an external device and local parameter values; reading manners include remote reading through communication manners (such as CAN, 485, 232, WIFI, Bluetooth, infrared, etc.) and network transmission manners (such as various wired and wireless networks), etc.

2. Definitions of source power parameters of the vehicle: a parameter capable of representing or calculating force or torque or power for directly driving the vehicle to longitudinally operate is a source power parameter. The force is a force formed by the power system of the vehicle and can be called source power, that is power or driving force for short. Because the operation in the present invention is longitudinal operation, the power is longitudinal power; the source power parameters are power parameters; an operation direction refers to a movement direction; the source power parameter is generated based on the power system of the vehicle; source power parameters generated based on the electric power system are called electric power parameters; source power parameters generated based on the fuel power system are called fuel power parameters; and source power parameters generated based on two or more power systems are called hybrid power parameters.

The electric power parameters include motor drive parameters, rear-end electric power parameters, etc. In the present invention, the electric power parameters with electric parameter attributes acquired by the motor and the motor front end (including the power unit, the motor driving device, etc.) are classified into motor drive parameters (also can be called electric drive parameters or front-end electric power parameters).

The fuel power parameters include front-end fuel power parameters, rear-end fuel power parameters, etc. The front-end fuel power parameters generally refer to fuel power parameters acquired by front-end components of a fuel engine output crankshaft (such as an engine cylinder, a fuel supply system, etc.).

The hybrid power parameters also include front-end hybrid power parameters, rear-end hybrid power parameters, etc.

In order to conveniently describe, source power parameters of a non-motor drive parameter type can be defined and include any one or more source power parameters of the rear-end electric power parameters, the fuel power parameters and the hybrid power parameters.

2.1. Definitions of Electric Power Parameters of the Vehicle:

The electric parameters include electric power, electromagnetic torque, current, voltage, motor rotating speed, etc., and can be divided by the devices into electric parameters of the motor, the motor driving device and the power unit.

The electric parameters of the motor mainly include: a motor voltage Uo, motor current Io, a power factor φ1 (i.e., φ)), electric power Po (i.e. Pm), an electromagnetic torque Te, motor rotating speed n1, rotating speed n0 of a rotating magnetic field, etc.

The electric parameters of the motor driving device include: an output voltage U2o, output current I2o, an output power factor φ2, output electric power P2o, an electromagnetic torque Te, an input voltage U2i (also can be represented by Ui), input current I2i (also can be represented by Ii), input electric power P2i, a direct-current bus voltage Udc of a driver, a torque current component iq, etc,

The torque current component iq refers to torque current obtained by stripping an excitation component of motor current of a vector control type motor driving device (such as a frequency converter or a servo driver) through vector transformation, and has relatively direct correspondence with the motor torque; and through a conversion factor Ki of the torque current and the electromagnetic torque, Ki*iq can be used for directly calculating the torque.

The electric parameters of the power unit include: an output voltage U3o (also can be represented by Ub1), output current I3o (also can be represented by Ib1), output electric power P3o, a power factor φ3, etc. An external power supply type power unit (such as a tracked electric locomotive) can further include: an input voltage U3i, input current I3i, input electric power P3i, etc., as well as a voltage U4 (also can be represented by Ub2) fed back into the power unit from a motor generation end during motor braking and current I4 (also can be represented by Ib2) fed back into the power unit from the motor generation end during motor braking.

Adjacent pre-stage output electric parameters and post-stage input electric parameters are functionally connected and can be replaced with one another during calculation. For example, Uo is equal to U2o, Io is equal to I2o, etc.

The electromagnetic torque Te in the present invention refers to motor torque obtained by calculating voltage or current or magnetic field parameters of the motor, and is easy and convenient to measure, low in cost and high in precision. The electromagnetic torque Te does not include a mechanical torque obtained on the motor output shaft or other mechanical transmission shafts based on a mechanical stress measurement principle (such as a dynamic torque tester); and the two torques have major differences in measurement principles, measurement ways and measurement cost performance.

2.1.8. The electric parameters in the present invention also can be divided into motor drive parameters and electric auxiliary parameters.

Common motor drive parameters include but not limited to the following several types: electric power (which refers to active power in the present invention in absence of limited conditions), an electromagnetic torque, current (which can be used for calculating torque and force; iq, Io*cos φ1, I2*cos φ2, Io*cos φ1, I3*cos φ3, etc.; and the current in the present invention refers to a torque current component or an active component in the current in the absence of the limited conditions, electromechanical combined parameters (referring to parameters formed by combining the electric power, the electromagnetic torque or the current above), etc.

The electromagnetic torque: such as Te, a Te value can be acquired by reading internal parameters of the motor driving device (such as a frequency converter or a servo driver), or the Te value is acquired by first acquiring an electric power value P and a motor rotating speed value n1 (or by measuring the output voltage and output current of the motor driving device) and then calculating; Te=P(w)*9.55/n1. The electric auxiliary parameters refer to parameters (such as motor operation state words, motor control instruction words) for matching and identifying motor operation conditions and motor states, etc.

2.1.9. The rear-end electric power parameters mainly include electric power parameters acquired on mechanical components of the motor rear end (such as the motor output shaft, the driving wheel, and an intermediate mechanical transmission component between the motor output shaft and the driving wheel, etc.).

2.2. Definitions of the fuel power parameters: the fuel power parameters include front-end fuel power parameters, rear-end fuel power parameters, etc. The front-end fuel power parameters generally refer to fuel power parameters acquired from the front-end components of the fuel engine output crankshaft (such as the engine cylinder, the fuel supply system, etc.); and the rear-end fuel power parameters mainly include fuel power parameters measured at the engine rear end (the fuel engine output shaft, the driving wheel, and the intermediate mechanical transmission component between the engine output shaft and the driving wheel (including a transmission shaft, a transmission gear mechanism, etc.)).

2.2.1 The fuel power parameters of the engine include: a fuel consumption rate fm1 in the engine, cylinder pressure F1, driving power Pr1, driving torque Tr1, driving force Ff1, airflow C1 in the cylinder, etc.

2.2.2 The fuel power parameters of the fuel supply system include: a fuel consumption rate on an input side of the fuel injection system, a fuel consumption rate on an output side of the fuel injection system, throttle opening, a throttle pedal position, a fuel consumption rate in a fuel feed pipe from the fuel tank to the engine (or a fuel injection pump), etc.

2.2.3. The fuel power parameters measured at the engine rear end (the fuel engine output shaft, the driving wheel, and the intermediate mechanical transmission component between the fuel engine output shaft and the driving wheel (including the transmission shaft, the transmission gear mechanism, etc.)) include the driving torque, the driving power, the driving force, etc.

2.2.4. Classified from parameter properties, the fuel power parameters include: driving power, driving torque, driving force, a fuel consumption rate, cylinder pressure, fuel power combined parameters (parameters formed by combining the fuel power parameters above), etc. In order to be conveniently understood by those skilled in the art, the fuel power parameters in the present invention are generally converted into fuel power parameters at the fuel engine output end (generally the output shaft) so as to participate in calculation; and in practical applications, the parameters can also be set as fuel power parameters of other parts by users.

Driving power: a power value Pr1 can be acquired by acquiring a percentage of the power through engine load report data of some engines and multiplying by maximum engine power (or acquiring the torque and rotating speed of the signal acquisition point first). The acquired fuel consumption rate can be transformed into the driving power Pr1 of the fuel engine by an energy conversion coefficient.

Driving torque: such as Tr1, a Tr1 value can be acquired through measurement by a torque sensor; or the torque value Tr1 is acquired by acquiring a driving power value and a rotating speed value of the signal acquisition point and then calculating (or acquiring a percentage through the engine load report data and multiplying by a maximum engine torque).

Driving force Ff: a driving force Ff value of the fuel engine can be acquired by acquiring the power value Pr1 or torque value Tr1 through the engine load report data and dividing the torque value by a related radius (or dividing the power value by a speed of a linear operation component).

Cylinder pressure F1: a cylinder pressure value acquisition manner 1: acquiring a value of the cylinder pressure F1 by using a cylinder pressure sensor. Generally speaking, F1 is averaged or filtered, etc. and transformed by a related efficiency coefficient so as to obtain the driving force Ff1 of the fuel engine, or the F1 is transformed into the driving torque Tr1 of the fuel engine. When the cylinder pressure F1 is an instantaneous value, attention needs to be paid to a combustion initiation phase.

Fuel consumption rate: hundreds of acquisition solutions exist. For example, the fuel consumption rate is measured by a flow sensor and acquired by processing information such as injection frequency and pulse width of the fuel injection system, throttle opening, the throttle pedal position, manifold pressure, vacuum degree, etc.; or a fuel consumption rate of a gasoline engine is deduced through airflow flowing through the engine (fresh airflow and/or exhaust gas flow).

2.3. Hybrid power parameters: front-end hybrid power parameters are generally combinations of the motor drive parameters and the front-end fuel power parameters; rear-end hybrid power parameters are generally combinations of the rear-end electric power parameters and the rear-end fuel power parameters; the rear-end hybrid power parameters also can be an integral source power parameter calculated on vehicle rear-end components under a combined action of the electric power system and the fuel power system (a power unit output shaft, a driving wheel, and an intermediate mechanical transmission component between the power unit output shaft and the driving wheel (including a transmission shaft, a transmission gear mechanism, etc.)). The parameter can include driving torque, driving power, driving force, etc., and generally can be measured and calculated by a torque sensor or other force sensors.

2.4. The source power parameters in the present invention at least include a group of source power parameters in parameter contents and can also simultaneously include a plurality of groups of source power parameters.

3. The vehicle mass in the present invention mainly includes the following parameters: carried goods mass m1 and data including the carried goods mass, such as gross vehicle mass m2.

3.1. The vehicle mass in the present invention preferably refers to the gross vehicle mass. The gross vehicle mass m2 is generally composed of the carried goods mass m1, no-load mass m0 and mass change type object mass mf. The gross vehicle mass m2 and/or the carried goods mass m1 can be called the vehicle mass. The carried goods mass m1 refers in particular to mass of loaded personnel and goods except net vehicle weight and also can be called carrying mass. The carried goods mass is equivalent to the carrying mass.

3.2. In order to be conveniently understood by those skilled in the art, the no-load vehicle mass m0 can be classified as system intrinsic parameters in system operation parameter groups aftermentioned on parameter types. The no-load mass m0 is mass during no load of the vehicle or net weight and can be accurately obtained by presetting (such as, reading manufacturer parameters, etc.) or weighing by a platform scale. The mass change type object mass mf can be classified as system operation parameters aftermentioned on parameter types, refers to variable mass in the operation process and mainly includes fuel mass. The fuel mass includes any one or more data of residual fuel mass mf0, mass mf1 of consumed fuel and fuel mass mf2 at a historical record point.

3.3. Specific division of m1 and m0 can be freely selected by the system or manually. For example, mass of a driver and in-car service personnel relatively fixed in an electric bus can be classified into the no-load vehicle mass m0 and also can be classified into the carried goods mass m1.

Plug-in pure electric vehicles (as well as high-speed trains and tramcars): m2=m0+m1;

Pure fuel power vehicles: m2=m1+m0+mf0, or: m2=m1+m0+mf2−mf1;

Fuel cell type electric vehicles: m2=m1+m0+mf0, or: m2=m1+m0+mf2−mf1.

4. The system operation parameter groups in the present invention refer to all parameters in the vehicle operation parameters except the vehicle mass and source power parameters and mainly include the following three categories of parameters: mechanical operation parameters, system intrinsic parameters and mass change type object mass. The system operation parameters of the vehicle are essentially parameters of basic conditions of power transfer of the vehicle and/or inherent attributes and/or motion results (such as a speed, an acceleration, etc.) of the vehicle generated under a dynamic action, and the inherent attributes refer to inherent attributes of the vehicle and/or an environment.

4. A. The mass change type object mass mainly includes the fuel mass. Fuels in fuel power vehicles mainly include gasoline, diesel, gas, etc. In electric vehicles powered by fuel cells, fuels mainly include hydrogen, ethanol, etc. In the electric vehicles powered by the fuel cells in the present invention, the fuel refers to energy supply type fuel. Because the power unit for directly driving the vehicle to longitudinally operate is the motor, the vehicle is still classified as the electric power vehicle. A fuel cell power and fuel oil power hybrid power vehicle includes two kinds of fuel mass, that is, mass of fuel (such as hydrogen) of fuel cells, and mass of ordinary fuels (such as gasoline, diesel, etc.).

4.1. The mechanical operation parameters in the present invention: parameters of which the size (that is, amplitude) can be controlled by an operator in the vehicle operation parameters except the source power parameters and the vehicle mass are the mechanical operation parameters; and/or: parameters to be measured in the vehicle operation parameters except the source power parameters and the vehicle mass are the mechanical operation parameters. The mechanical operation parameters in the present invention are essentially variable parameters in the basic conditions of the power transfer of the vehicle and/or parameters of the motion results (such as the speed, the acceleration, etc.) of the vehicle generated under the dynamic action, and mainly include but not limited to the following parameters: a longitudinal velocity Vₓ (also, i.e. V1), a longitudinal acceleration a (also, i.e. \dot{V}), road gradient θ, wind resistance fw, a frontal windward speed V2, a bend coefficient δ, a steering angle, an integrated force factor coefficient kaθ, an angular acceleration β (also can be represented by ω0) of an internal comprehensive rotating rigid body, etc.

4.1.1. Acquisition of the longitudinal velocity Vₓ: a Vₓ value is measured by a velocity sensor arranged on a vehicle body and indirectly acquired by measuring a rotating speed n1 of the power unit. All parameters associated with the velocity can be used for acquiring the Vₓ value (such as an operation frequency FR of the power control unit (such as the frequency converter), an angular velocity of the power unit, an angular frequency of the power control unit, a rotating speed of a gear, an angular velocity of an intermediate rotating component and a linear velocity of an intermediate transmission component). The Vₓ value is indirectly acquired through the longitudinal acceleration a (integral) and can be acquired through GPS and remote locating information.

4.1.2. Acquisition of the longitudinal acceleration a: the longitudinal acceleration a is directly measured by an acceleration sensor arranged on the vehicle body. For example, an output signal of the acceleration sensor further includes a g*sin θ value, and (g*sin θ+a) can be merged. The longitudinal acceleration a can be indirectly measured by virtue of the rotating speed n1 of the power unit or the longitudinal velocity Vₓ (derivation).

4.1.3. Road gradient θ: referring to an included angle between a vehicle driving pavement or track and a horizontal line. When the vehicle is operated towards an uphill direction: 90°>θ>0°; when sin θ is a positive value, it is indicated that kinetic energy is converted into potential energy, and more power needs to be consumed compared with that during horizontal operation; when the vehicle is horizontally operated: θ=0; when the vehicle is operated towards a downhill direction: 360°>θ>270°; when sin θ is a negative value, it is indicated that the potential energy is converted into the kinetic energy, and the vehicle may consume less power compared with that during horizontal operation, and even may enter a braking state.

A θ value acquisition manner: the θ value is acquired through measurement by a longitudinal obliquity angle sensor or a spirit level arranged on the vehicle body. θ values of specific routes and tracks in specific positions can be acquired through GPS information or other pre-stored databases and network systems, etc. Particularly for high-speed rail vehicles, rail cars and other track fixed vehicles, the θ value (or along with δ and/or f) can be directly read according to a position information lookup table by presetting a database in which the position information corresponds to the road gradient θ (and/or along with the curve coefficient δ and/or a rolling resistance coefficient f). For a vehicle, if the path is a path passed and learned, the manner can be adopted.

4.1.4. Acquisition of air drag, that is, the wind resistance fw: measurement and calculation of the wind resistance fw may achieve key effects in a process of monitoring high-speed operation of the vehicle.

Manner 1: acquiring the longitudinal velocity Vₓ of the vehicle and then calculating a fw value. A formula for reference is as follows: fw=(½)*C_{d}*(p0*A₀*(Vₓ)²), wherein C_{d} is a wind resistance coefficient of the vehicle, p0 is air density and A₀ is a windward area of the vehicle; C_{d}, p0 and A₀ belong to the system intrinsic parameters and all can be acquired by reading the system preset values.

Manner 2: arranging an independent wind speed and direction test instrument on the vehicle, measuring the frontal windward speed V2 during vehicle operation and then calculating the fw value. A formula for reference is as follows: fw=(½)*C_{d}*(p0*A₀*(V2)²).

Manner 3: arranging an independent wind pressure or wind resistance sensor on the vehicle, directly measuring wind pressure or wind resistance in unit area during vehicle operation, and further calculating the wind resistance fw value according to correlation coefficients.

4.1.5. Curve coefficient δ: referring to a turning coefficient of the vehicle during current operation. When the vehicle is turned, the size of the driving force of the vehicle is influenced.

A δ value of δ=K(α) can be acquired by measuring a turning angle α through an operation track of the vehicle or the acceleration transducer or a rotating angle sensor arranged on a steering wheel; a specific function relationship between the angle α and the δ value can be tested in a form of vehicle manufacturers or professional detection institutions; and on a pavement which is relatively straight or has a turning degree less than a set angle (such as 30°), the δ value can be set as 1 or be directly neglected.

4.1.6. An angular acceleration β of the internal comprehensive rotating rigid body: the internal comprehensive rotating rigid body refers to a rigid body formed by integrally converting all rigid mechanical rotating components in an inner transmission system of the vehicle. The parameter β can be acquired by a rotating speed sensor or acquired by acquiring the rotating speed n1 of the power unit or the longitudinal velocity Vₓ of the vehicle or the longitudinal acceleration a of the vehicle and then calculating.

4.2. In the present invention, the system intrinsic parameters refer to parameters related to the inherent attributes of the vehicle and/or the environment; and/or: the parameters of which the sizes (that is, amplitudes) are not controlled by the operator in the vehicle operation parameters except the source power parameters and the vehicle mass are the system intrinsic parameters; and/or: unmeasurable parameters in the vehicle operation parameters except the source power parameters and the vehicle mass are the system intrinsic parameters; and/or: presetable parameters in the vehicle operation parameters except the source power parameters and the vehicle mass are the system intrinsic parameters. The system intrinsic parameters in the present invention refer to the parameters brought by the inherent attributes of the vehicle or the environment and can also be called system set parameters.

4.2.1. Common system intrinsic parameters include but not limited to the following: no-load body mass m0 of the vehicle (also, i.e. no-load proper mass or unladen mass or net weight, etc.), a rolling resistance coefficient f (i.e. u1), an integrated transmission ratio im, a rear-end transmission ratio im3, a radius R1 (i.e. R) of the driving wheel, an equivalent radius R0 of the engine output crankshaft connected with the cylinder piston, a transformation coefficient Ki of torque current and electromagnetic torque, a transformation coefficient Ko of an active component of motor current and the electromagnetic torque, an efficiency coefficient Km of the mechanical transmission system, an efficiency coefficient Kea of the electric power system, an efficiency coefficient or a transformation coefficient Kfa of the fuel power system, a rear-end efficiency coefficient Km3, rotating inertia L0 of the internal comprehensive rotating rigid body, the wind resistance coefficient C_{d} (i.e., C_{d}), the air density p0, the windward area A₀ (i.e., S), acceleration of gravity g, a preset time range of parameter values, etc. The system intrinsic parameters in the present invention further include all other parameters of which the amplitude of normal conditions can be preset by the system except the gross vehicle mass.

Detailed description of the system intrinsic parameters is as follows:

4.2.2. The efficiency coefficient Kea of the electric power system, the efficiency coefficient Km of the mechanical transmission system and the efficiency coefficient or the transformation coefficient Kfa of the fuel power system.

4.2.2.1. The efficiency coefficient Kea of the electric power system includes: an efficiency coefficient Ke of the motor (referring to conversion efficiency from the electric power of the motor to mechanical output power of the motor shaft), an efficiency coefficient K21 from the motor driving device to the motor (which also can be represented by k13, referring to conversion efficiency from the input power of the motor driver to the electric power of the motor when the motor operation conditions are in an electric state, as well as conversion efficiency from the output power of a power supply to the electric power of the motor), an efficiency coefficient K31 from the power supply to the motor (referring to conversion efficiency from the input power of the power supply to the electric power of the motor in the electric state), an efficiency coefficient K41 from the motor braking power to the power supply (referring to an efficiency coefficient from the motor braking power to power fed back to the power unit in a motor braking state), etc.

4.2.2.2. The efficiency coefficient Km of the mechanical transmission system can also be called mechanical transmission system efficiency for short. Km refers to an efficiency coefficient of integrated transmission of components including the output shaft of the power unit (such as the motor or the fuel engine) of the vehicle, the driving wheel, and the intermediate transmission component between the output shaft of the power unit and the driving wheel. In order to cope with possible fluctuations of the Km value in different speed ranges, a one-dimension function Km_{(VX)} one can be set, namely, corresponding Km values are selected according to different speed ranges (such as zero speed, low speed and high speed). When the vehicle is in different operation states (power unit driving operation or power unit braking operation), the Km values can be respectively set as different values according to different operation conditions of the power unit.

An electromechanical transmission integrated efficiency coefficient Kem can be called electromechanical transmission integrated efficiency Kem; Kem=Ke*Km.

4.2.2.3. The efficiency coefficient or the transformation coefficient Kfa of the fuel power system: because different fuel power parameters have different signal acquisition positions/modes, Kfa includes a plurality of subdivision parameters. In order to be conveniently described and understood by those skilled in the art, efficiency coefficients or transformation coefficients of all fuel power systems are summarized by Kfa in the present invention. Kfa may specifically include corresponding Kf1, KKf2, Kf3 . . . Kfn, etc.

4.2.2.3.1. For example, when the fuel power parameter is the fuel consumption rate fm1 in the engine, the fuel consumption rate fm1 can be converted into the driving power Pr1 of the fuel engine by using an energy conversion coefficient Kf1, and then Pr1=fm1*Kf1.

4.2.2.3.2. For example, when the fuel power parameter is the fuel consumption rate fm2 at the fuel input end of the fuel injection system, the fuel consumption rate fm2 can be converted into the driving power Pr1 of the fuel engine by using an energy conversion coefficient Kf2, and then Pr1=fm2*Kf2.

4.2.2.3.3. For example, when the fuel power parameter is the cylinder pressure F1 of the fuel engine (and the F1 can be subjected to peak-to-mean conversion or filtering, etc.), an efficiency coefficient Kf3 is needed to convert the cylinder pressure F1 into the driving power Ff1 of the fuel engine, and then Ff1=F1*Kfa; or the F1 is converted into the driving torque Tr1 of the fuel engine, and then Tr1=F1*Kf3*R0.

4.2.2.3.4. For example, when the fuel power parameter is the airflow C1 of the fuel engine (and the C1 can be subjected to peak-to-mean conversion or filtering, etc.), the airflow C1 can be converted into the driving power Pr1 of the fuel engine by using an energy conversion coefficient Kf4, and then Pr1=C1*Kf4. Generally speaking, the power can be calculated by using the airflow C1 only in the gasoline engine because the airflow and fuel of the gasoline engine have a relatively fixed stoichiometric ratio. An intake manifold of the diesel engine is not throttled, which is not convenient to calculate the power by C1.

4.2.2.3.5. For example, when the fuel power parameter is the load report data (a power value) Pr2 of the fuel engine (and Pr2 can be subjected to peak-to-mean conversion or filtering, etc.), serial filtering and percentage calculation can be performed by using an energy conversion coefficient Kf5, the load report data (the power value) Pr2 is converted into the driving power Pr1 of the fuel engine, and then Pr1=Pr2*Kf5.

4.2.2.3.6. For example, when the fuel power parameter is the load report data (a torque value) Tr2 of the fuel engine (and Tr2 can be subjected to peak-to-mean conversion or filtering, etc.), serial filtering and percentage calculation can be performed by using an energy conversion coefficient Kf6, the load report data (the torque value) Tr2 is converted into the driving torque Tr1 of the fuel engine, and then Tr1=Tr2*Kf6.

Because the fuel power parameters have more acquisition modes, efficiency coefficients or conversion coefficients of the fuel power system have more types, which are not enumerated one by one in the present invention. According to the principle of the efficiency coefficient or the conversion coefficient Kfa of the fuel power system, regardless of the types, a corresponding coefficient Ka of a source power parameter corresponding to power for driving the vehicle to longitudinally operate can be set for any one source power parameter of all vehicles. The power is equal to a value *Ka of the source power parameter. The Ka value can be obtained through type tests, a limited number of manual trial and error methods and other combinations of the prior art. For example, by acquiring preset values of a certain source power parameter of a magnetic levitation vehicle and a corresponding coefficient Ka corresponding to the source power parameter, power of the magnetic levitation vehicle can be calculated, and a longitudinal dynamic model of the vehicle can be further set so as to perform vehicle motion balance calculation. For example, a train in a pipeline in a US Tesla company can be monitored by adopting the technical solution provided in the present invention. Apparently, the related corresponding coefficient Ka and/or the conversion coefficient Kfa can be a single efficiency coefficient, or a parameter including the efficiency coefficient, that is, a parameter formed by combining the efficiency coefficient, or a combined parameter including the efficiency coefficient. For example, the driving force (such as fq or Fx) of the vehicle is obtained by multiplying a certain source power parameter (such as motor current i1) of the motor by a certain corresponding coefficient or conversion coefficient (such as Ka1) and then Ka1 is the parameter including the efficiency coefficient.

4.2.2.4. The current, voltage, rotating speed and torque of the vehicle may be variable, but basic values such as k31, k21, k14 and Ke (under certain conditions) cannot be greatly changed. The change of the values k31, k21 and k14 means that abnormal conditions such as short circuit or open circuit, parameter variation and the like may exist in a rectifier bridge or an IGBT (Insulated Gate Bipolar Transistor) inside the power supply or the motor driver. The change of the Ke value means that variation of serious consequences may be caused by parameter variation of a rotating magnetic field inside the motor or short circuit or open circuit of a motor winding. Therefore, the values k31, k21, k14 and Ke above not only serve as efficiency coefficients of the electric power system, but also can serve as an important basis of safety conditions of the electric power system.

The Kfa value of the efficiency coefficient or conversion coefficient of the fuel power system can serve as an important basis of safety conditions of the fuel power system and is generally reflected as the efficiency of the fuel engine. For example, when engine cylinder scoring occurs or a piston sealing effect is poor, the Kfa value is reduced.

Change of the Km value of the efficiency coefficient of the mechanical transmission system may represent changes of operation conditions of the mechanical transmission system of the vehicle including the power unit output shaft, the driving wheel and the intermediate mechanical transmission component between the power unit output shaft and the driving wheel. For example, serious wear or deformation or brittle rupture of a gear, etc. may cause variations of serious consequences. The mechanical torque and rotating speed of the vehicle may be variable, and even friction force can change along with the size of a load, but a basic Km value cannot be greatly changed, otherwise serious faults may be caused. Therefore, the Km value can serve as not only an efficiency coefficient of the mechanical transmission components, but also an important basis of safety conditions of the mechanical transmission components.

The values k31, k21, k14 and Ke serving as measurement and calculation objects are directly monitored, or indirectly monitored by calculating joint operation values of other measurement and calculation objects (such as the vehicle mass), so that the operation conditions of the electric power system of the vehicle can be monitored. By directly or indirectly monitoring the Kfa, the operation conditions of the fuel power system of the vehicle can be monitored.

A comprehensive efficiency coefficient Keem of the electric power system of one vehicle can be further set and includes the efficiency coefficient Kea of the electric power system, Keem=Km*Kea. A Keem value is generally relatively high (which can be higher than 90%), and Keem can be set as 1 when imprecise calculation is performed. A comprehensive efficiency coefficient Kfam of the fuel power system of one vehicle can be further set and includes the efficiency coefficient Kfa of the fuel power system, Kfam=Km*Kfa.

Apparently, in the present invention, without the limited descriptions, regardless of vehicle types, the efficiency coefficient represents efficiency of a power component and/or a transmission component between the signal acquisition point of the source power parameter and the driving wheel used for the vehicle motion balance calculation. The power component and/or the transmission component is called a to-be-monitored power transmission component. The efficiency coefficient is also called energy transfer efficiency of the to-be-monitored power transmission component. Due to a principle of energy conservation, reduction of the efficiency coefficient means that the energy transfer efficiency of the to-be-monitored power transmission component is reduced, which means increase of internal loss, increase of internal resistance or resistance, heat increase, poor safety conditions and the like, and then a failure risk of the to-be-monitored power transmission component is increased. Therefore, the efficiency coefficient can be used for reflecting and analyzing the operation conditions of the to-be-monitored power transmission component of the vehicle. The operation conditions particularly refer to wear and/or safety conditions. Generally, the signal acquisition point of the source power parameter can be moved to a front signal point in the power system as much as possible, and the power component can be monitored and protected in a wider range by virtue of the vehicle motion balance calculation.

The efficiency coefficient or the parameter including the coefficient serves as a measurement and calculation object, and a joint operation value of the efficiency coefficient is calculated based on the longitudinal dynamic model of the vehicle; or a joint operation value of a certain measurement and calculation object is calculated based on the longitudinal dynamic model of the vehicle. The efficiency coefficient is included in input parameters of the model. The efficiency coefficient can be used for analyzing the operation conditions of the to-be-monitored power transmission component of the vehicle (or further analyzing whether the component is abnormal). By comparing the joint operation value of the measurement and calculation object with reference data, whether the power transfer conditions during vehicle operation are abnormal can be judged.

Embodiments of an Efficiency Coefficient:

Energy conversion efficiency from a detection point of a certain source power parameter located on a transfer link of energy (and/or power) of a vehicle to a driving wheel is k, power of the detection point is detected as p1, and k is calculated according to a formula k*p1=p2, wherein the energy transfer link is an energy supply unit (such as a power supply)→a power control unit (such as a frequency converter)→a power unit (such as a motor)→a transmission system→the driving wheel, and p2 is a driving power formed by driving force, is also a sum of power corresponding to rolling resistance, grade resistance, variable speed resistance and wind resistance and is equal to power calculated by a longitudinal dynamic equation (i.e. a longitudinal motion balance calculation formula of the vehicle), i.e. p2 can be calculated by the longitudinal motion balance calculation of the vehicle. Then, the calculated k is compared with a preset value (generally a calibration value) of the energy conversion efficiency from the detection point to the driving wheel, and whether the energy (and/or the power) between the detection point and the driving wheel is abnormal is further judged, i.e., whether operation conditions of the system related to power transfer in the vehicle are abnormal can be judged. In the present invention, the transmission system is a mechanical transmission system.

For example, when the detection point is an input point of the energy supply unit (such as the power supply), k=k1*k2*k3*k4, wherein k1 is an energy conversion rate of the energy supply unit (such as the power supply) and is equal to input power/output power of the energy supply unit (such as the power supply); k2 is an energy conversion rate of the power control unit (such as the frequency converter) and is equal to the output power of the energy supply unit (such as the power supply)/output power of the power control unit (such as the frequency converter); k3 is an energy conversion rate of the power unit (such as the motor) and is equal to the output power of the power control unit (such as the frequency converter)/output power of the power unit (such as the motor); and k4 is an energy conversion rate of the transmission system and is equal to the output power of the power unit (such as the motor)/output power of the transmission system. When the detection point is an input point of the power control unit (such as the frequency converter), k=k2*k3*k4.

Because the transmission system can be further divided into N subsystems, respective corresponding energy conversion rates of the corresponding subsystems are k41, k42, . . . , k4N, and then k4 is equal to a product of the respective corresponding energy conversion rates of the corresponding subsystems.

4.2.3. Rolling resistance coefficient f: referring to a rolling resistance coefficient between a rolling wheel (that is, a wheel) of the vehicle and a pavement (or a track).

For a vehicle driving on an ordinary highway, an inflatable rubber tire, that is, a rubber wheel, can be used, the rolling resistance coefficient f of the tire is mainly determined by air pressure p1 of the tire, a wear condition kt of the tire and a pavement behavior kr, and a value of the rolling resistance coefficient f can be described by a mathematical functional expression: f(k0,p1,kt,kr), wherein k0 is a correction factor. Kt, p1 and a reference value of f under a standard pavement behavior kr can be set by vehicle manufacturers or professional detection institutions. Different correction factors k0 can be set for correcting changes of f reference in different speed, load and pavement gradient ranges.

Slow change of kt does not cause sudden change of a value of f, and change of f caused by change of kr can be simply identified and distinguished by virtue of visual inspection of a driver and passengers, so the value of f is mainly determined by the air pressure p1 of the tire when the change of the values kt and kr is neglected. Under the same road condition and the same load capacity, when the air pressure p1 of the tire is insufficient, the greater the deformation of the tire is (the greater the out-of-roundness is), the greater the value of f is, the higher the vehicle operation resistance is (the tire is easily heated and even burst during high-speed operation). A principle is that: a circular object is easy to roll, an elliptical object is difficult to roll, and multilateral rhombohedron, square and triangular object are more difficult to roll.

A formation principle of the rolling resistance coefficient f is analyzed, a deformation formula of (f=fc*fr) or (f=fc+fr), f=f(fc, fr) of the rolling resistance coefficient f can be set, and the rolling resistance coefficient f is formed based on fc and fr, wherein fc is a rolling resistance coefficient component related to the vehicle and is directly related to the wheel deformation (out-of-roundness) and/or wheel wear conditions; and fr is a rolling resistance coefficient component related to the road condition, and a fr value of the current road section can be obtained through preset map information or a position information lookup table. A calculation formula of f and fc (such as (fc*fr) or (fc+fr)) is substituted into any longitudinal dynamic model of the vehicle so as to replace the rolling resistance coefficient f, and a fc value of can be further obtained. Value(s) of any one or more of f and fr can be measured by sensors. For example, the current road condition (i.e. whether the road is a cement pavement or a grassland, etc.) can be identified by an optical sensor or an ultrasonic or radar sensor on the vehicle. For example, hardness of the current pavement can be detected by a mechanical sensor connected with the rolling wheel by virtue of the rolling wheel arranged on the vehicle so as to identify the f and/or fr of the current pavement.

The rolling resistance coefficient f (particularly the rolling resistance coefficient component fc related to the vehicle) or a parameter including the coefficient serves as a measurement and calculation object, and the rolling resistance coefficient f (particularly fc) is calculated based on the longitudinal dynamic model of the vehicle so as to perform direct monitoring; or a joint operation value of a certain measurement and calculation object is calculated based on the longitudinal dynamic model of the vehicle, and the parameter f (particularly fc) is included in the input parameters of the model so as to perform indirect monitoring. The rolling resistance coefficient can be used for analyzing safety conditions of the wheels (or further analyzing whether the wheels are abnormal), so that early warning can be given to risk of tire burst. By comparing the joint operation value of the measurement and calculation object with reference data, whether the power transfer during vehicle operation is abnormal can be judged.

If tire burst suddenly occurs during the vehicle operation, the wheel deformation (out-of-roundness) is rapidly increased due to gas leakage, the air pressure p1 of the tire is rapidly reduced, and then the joint operation value of the measurement and calculation object is greatly and suddenly changed. According to analysis of an operation principle of the inflatable tire, due to pressure produced by deadweight of the vehicle, internal pressure change is slow before great gas leakage, and wheel speed change is also slow, however, as long as the tire has slight gas leakage, the tire deformation (out-of-roundness) is immediately caused due to a heavy load of the vehicle. Therefore, whether the power transfer is abnormal is monitored by monitoring operation resistance change (caused by deformation of the rolling wheels (including the driving wheel). Compared with the prior art for monitoring the tire pressure by virtue of the air pressure or wheel speed, the mode in the present invention is more rapid and effective.

Rigid rolling wheels are generally used on tracked electric locomotives (such as high-speed rail vehicles, track vehicles, etc.) driven on fixed tracks, and the rolling resistance coefficient f of the rolling wheels is mainly determined by deformation of the rolling wheels, or a friction coefficient with the track and wear conditions. A (pressure sensor type or wheel speed type) tire pressure monitoring technology cannot be used by the rigid rolling wheels, and generally manual spot check type ultrasonic detection can be performed only after the vehicle is stopped. Therefore, the solutions in the present invention are needed. The safety conditions of the wheels are monitored during the vehicle operation (or whether the wheels are abnormal is further judged). The safety conditions of the wheels refer to the deformation (out-of-roundness) and/or wear conditions of the wheels. Increase of the rolling resistance coefficient f generally means poor safety conditions of the wheels (i.e. aggravation of the deformation (out-of-roundness) and/or wheel wear).

4.2.4. Integrated transmission ratio im: referring to an integrated transmission ratio of components including a power unit output shaft, a driving wheel and an intermediate transmission component between the power unit output shaft and the driving wheel; im of part of vehicles is a fixed value, while im of part of vehicles can be changed according to different transmission gears.

4.2.5. Descriptions of other parameters: a transmission ratio from a parameter selection point of a rear-end source power parameter to the driving wheel is called a rear-end transmission ratio im3, and an efficiency coefficient from the parameter selection point of the rear-end source power parameter to the driving wheel is called a rear-end efficiency coefficient Km3.

4.2.6. Values of system intrinsic parameters generally have preset values (particularly system preset values) and can be given by a central controller of the vehicle. The value of the fc can be acquired according to the preset values.

During the vehicle operation, value(s) of any one or more parameters of road gradient θ, the rolling resistance coefficient f and the rolling resistance coefficient component fr related to the road condition at any road position can be calculated based on position information of the road or acquired from measured data of the sensor. The position information can be acquired based on map information and/or satellite positioning and/or a wireless network except a satellite positioning system.

5. Interpretation of Source Power Combined Parameters:

Any parameter (including vehicle mass and system operation parameters) and a source power parameter are combined into a calculation expression, and then the calculation expression becomes the source power combined parameters. The source power combined parameters are also classified as source power parameters. According to different power system categories, the source power combined parameters are also divided into electric power combined parameters, fuel power combined parameters and hybrid power combined parameters, wherein the electric power combined parameters include electromechanical combined parameters and rear-end electric power combined parameters.

Typical examples of the electromechanical combined parameters are as follows: ((Ke*Km)*(k12*Po/Vₓ) represents driving force calculated according to motor power, and (Te*im/R) represents driving force calculated according to electromagnetic torque Te.

Typical examples of the fuel power combined parameters are as follows: (Km*Pr1/Vₓ) represents driving force calculated according to driving power Pr1 of a fuel engine, and (Tr1*im/R) represents driving force calculated according to driving torque Tr1 of the fuel engine.

Typical examples of the hybrid power combined parameters are as follows: (Tr3*im3/R) represents driving force calculated according to driving torque Tr3 of the hybrid power system.

6. Combined Parameters Not Including Source Power Parameters:

6.1. Mechanical combined parameters: when parameter in the mechanical operation parameters, the vehicle mass and the system intrinsic parameters are combined into a calculation expression including the mechanical operation parameters, and the calculation expression becomes the mechanical combined parameters which are still classified as the mechanical operation parameters.

Typical examples of the mechanical combined parameters are as follows: (g*f*cos θ+g*sin θ+a) represents an integrated force factor related to the mass and can also be called a coefficient X1 having a direct product relationship with the mass; for example, (m2*g*f*cos θ) represents rolling resistance of the vehicle, (m2*g*sin θ) represents the gradient resistance of the vehicle, (m2*a) represents the variable speed resistance of the vehicle, and (m2*g*f*cos θ+m2*g*sin θ+m2*a+fw) represents mechanical integrated operation force of the vehicle. Apparently, the mechanical integrated operation force is related resistance of the vehicle in an operation direction. The related resistance includes one of the rolling resistance, the gradient resistance, the variable speed resistance and the wind resistance, or includes a sum of at least two of the rolling resistance, the gradient resistance, the variable speed resistance and the wind resistance.

6.2. When parameters of the vehicle mass and the system intrinsic parameters are combined into a calculation expression including the vehicle mass, the calculation expression becomes mass combined parameters which are also classified as the vehicle mass. (m1+m0), (m2−m0), etc. belong to the vehicle mass. Although m2*g, m1*g and other parameters become gravity withstood by objects, the parameters are still classified as the vehicle mass in the present invention.

6.3. When two or more of the system intrinsic parameters are combined into a calculation expression (such as ((Ke*Km)*(im/R)) or (im/R), etc.), the calculation expression is still classified as the system intrinsic parameters.

7. Vehicle conditions in the present invention mainly refer to conditions of the power system and the transmission system of the vehicle. If the vehicle has excellent parts and lubrication and less wear, a good vehicle condition index is high; and if the vehicle is seriously worn, the good vehicle condition index is low. The road condition information mainly refers to pavement smoothness. The higher the pavement smoothness is, the higher the good road condition index is. Load conditions mainly refer to conditions of loading personnel or goods in the vehicle, and if the personnel in the vehicle frequently jump or the goods in the vehicle freely roll, a good load condition index is low. The position information in the present invention can be acquired in manners such as GPS, a digital map, etc.

8. Description of the “Vehicle Controlled to Operate by the Power Unit” in the Present Invention:

8.1. The present invention specifies that: the “vehicle controlled to operate by the power unit” refers to a state in which the vehicle is independently controlled to operate by the power unit. The state generally does not include all “vehicle controlled to operate by a non-power unit” states such as vehicle parking, flameout, neutral slip or mechanical braking, etc., because the latter state is inconvenient to monitor the operation of the vehicle by acquiring and calculating the source power parameters.

8.2. The “vehicle controlled to operate by the power unit” state or the “vehicle controlled to operate by the non-power unit” states can be identified by the central controller of the vehicle, or by acquiring a “forward or backward or stop” state of a power unit driving state and matching with action state information of a mechanical brake.

8.3. A time starting point and ending point may exist in the “vehicle controlled to operate by the power unit” state in the present invention.

A moment of entering the “vehicle controlled to operate by the power unit” state from the “vehicle controlled to operate by the non-power unit” states can be set as the starting point of a time period of the “vehicle controlled to operate by the power unit” state; and a moment of entering the “vehicle controlled to operate by the non-power unit” states such as vehicle parking, mechanical braking, neutral slip, etc. from the “vehicle controlled to operate by the power unit” state can be set as the ending point of the time period of the “vehicle controlled to operate by the power unit” state.

Duration of each time period of the “vehicle controlled to operate by the power unit” state can last for long time (several hours) or short time (several minutes or seconds), and the time period of the “vehicle controlled to operate by the power unit” state is and is equal to an “operation process”. Even if in the same vehicle, some parameters, particularly the carried goods mass m1 of the vehicle may be changed in different time periods of the “vehicle controlled to operate by the power unit” state (i.e., different operation processes). If the quantity of the passengers is increased, m1 is naturally increased, and if the quantity of the passengers is decreased, m1 is naturally decreased and may cause a great fluctuation.

9. Power unit operation conditions, including the power unit driving state, a power unit braking state and other operation conditions.

9.1. When the power unit of the vehicle is the motor, the power unit driving state can be called an electric state for short, and the power unit braking state is a motor braking state (including regenerative feedback electric braking, energy consumption braking, etc.); when the power unit of the vehicle is the fuel engine, the power unit operation conditions are divided into a fuel engine driving state, a fuel engine braking state, etc.; and when the power unit of the vehicle is a hybrid power unit, the power unit operation conditions are divided into a hybrid power unit driving state, a hybrid power unit braking state, etc.

In the aftermentioned embodiments 1-32 provided by the present invention, the vehicle is moved forward under the control of the power unit by default. Related monitoring and protection can be performed during reverse by using the serial technical solutions provided in the present invention.

In order to conveniently describe and understand the present invention for those skilled in the art, the following parameter setting methods of 9.2 and 9.3 are specified in the present invention:

9.2. When the vehicle is in the electric state, motor rotating speed n1 and longitudinal velocity Vₓ are specified as positive values, and various motor drive parameters (such as power, torque and current) are positive values. In a similar way, when the vehicle is in the fuel engine driving state (or the hybrid power unit driving state), engine rotating speeds n1 and Vₓ are specified as positive values, and various fuel power parameters (or hybrid power parameters) are positive values.

9.3. In the present invention, n1 and Vₓ are still specified as the positive values in the motor braking state. If the various motor drive parameters (such as the power, the torque and the current) are negative values, and mechanical driving force calculated according to electric energy is also a negative value. It indicates that the motor is in a state for converting mechanical energy into electric energy. In a similar way, n1 and Vₓ are still specified as the positive values in the fuel engine driving state (or the hybrid power unit driving state). If the fuel power parameters (or hybrid power parameters) are measured by a torque sensor at this moment, n1 and Vₓ need to be specified as the negative values.

9.4. Identification Methods of the Power Unit Operation Conditions are as Follows:

Identification methods of the motor operation conditions are as follows: method 1: when the electromagnetic torque Te and the motor rotating speed n1 are in the same direction, the vehicle is in the electric state, and when the electromagnetic torque Te and the motor rotating speed n1 are in opposite directions, the vehicle is in the motor braking state; method 2: when Udc is less than the peak of U2i, the vehicle tends to be in the electric state, otherwise the vehicle tends to be in the motor braking state; method 3, when n1 is less than n0, the vehicle tends to be in the electric state, and when n1 is more than n0, the vehicle tends to be in the motor braking state; method 4, when a value of a source power parameter or mechanical integrated operation force (m2*g*f*cos θ+m2*g*sin θ+m2*a+fw) is positive, the vehicle can be judged to be in the driving state, and then the vehicle needs to absorb power represented by the source power parameter so as to drive the vehicle to longitudinally operate, otherwise the vehicle is in the braking state, and then dynamic energy or potential energy of the vehicle can be fed back to the body or braking is needed.

Critical switching area identification method 5: a critical state identification threshold value Te_gate can be set, and when |Te|<Te_gate, the present motor operation condition can be judged to be in a critical switching area. Then, the calculation accuracy is influenced, and calculation or monitoring of the parameters can be suspended.

Critical switching area identification method 6: when an absolute value of the mechanical integrated operation force (or the source power parameter) is lower than a preset threshold value (e.g., 5-10% of a rated value), the present power unit operation condition can be judged to be in the critical switching area.

For certain vehicles, the operation conditions and critical switching areas of the vehicles can be identified by directly reading information of a power unit control system (such as an OBD system of the fuel engine). In general, whether the operation conditions of the vehicles are in the critical switching areas can be judged by comparing whether some pre-selected parameters exceed a preset range, wherein the pre-selected parameters are preferably the source power parameter and/or the mechanical integrated operation force.

10. Network systems in the present invention include but not limited to: various wired or wireless mobile 3G and 4G networks, Internet, Internet of things, a local area network, etc. The network systems may include corresponding man-machine interaction interfaces, storage systems, data processing systems, mobile phone APP systems, etc. and are used for monitoring the vehicle operation conditions.

The present invention preferably serves as a set of the technical solutions instead of a document of pure physical descriptions, and takes vehicle motion balance calculation as a core technical solution. Basic technical solutions and technological ways for acquiring parameter values serve as preferred selections for dividing data types. For example, since real values of the gross vehicle mass m2 and carried goods mass m1 (inconvenient to frequently measure by a platform scale) need to be acquired by the vehicle motion balance calculation, the gross vehicle mass m2 and carried goods mass m1 are classified as vehicle mass parameters. A value of no-load vehicle mass m0 can be obtained by a preset value, so the no-load vehicle mass m0 is classified as the system intrinsic parameter. Because a value of fuel mass is in continuous change during the vehicle operation, and an actual value of the fuel mass generally needs to be acquired by measurement, the fuel mass is classified as the system operation parameter. Other parameters which are not enumerated one by one in the present invention can be correspondingly classified according to parameter selection ways and technical characteristics.

any one technical solution in the present invention can be used in other types of vehicles and other types of technical solutions in the present invention.

In the present invention, a measurement and calculation object can also be called a direct monitoring object or a target parameter.

A joint operation value in the present invention is a joint operation original value. The joint operation value only represents a data type or a data acquisition way and indicates that the value is a result obtained based on calculation of a longitudinal dynamic model of a vehicle; or a value of the measurement and calculation object is obtained based on the calculation of the longitudinal dynamic model of the vehicle and is a joint operation value of the measurement and calculation object. The joint operation value of the measurement and calculation object can include a direct joint operation value and an indirect joint operation value. For example, vehicle motion balance calculation is performed according to source power parameters and system operation parameters of the vehicle so as to obtain gross vehicle mass m2, and then m2 is the direct joint operation value; and carried goods mass m1 or no-load vehicle mass m0 is calculated according to m2, and then m1 or m0 is the indirect joint operation value. In the present invention, the joint operation value can also be called a theoretical value or an estimated value.

Calculation of the joint operation value based on the vehicle motion balance calculation has an infinite number of realization manners (such as embodiments 1-33, formulas 13.1-13.6, embodiment 41, etc. in subsequent documents). Acquisition of the joint operation value of the measurement and calculation object of the vehicle can be performed by referring to the following embodiments:

Notes: in order to conveniently understand, when the measurement and calculation object is a source power parameter or a system operation parameter, a suffix_cal may be added after a parameter name in an expression of the joint operation value. If an efficiency coefficient of a mechanical transmission system has a parameter name Km, the joint operation value is expressed by Km_cal; and if a rolling resistance coefficient has a parameter name μl or f, the joint operation value is expressed by μ1_cal or f_cal.

When a power unit in embodiments 1-40 in the present invention is a motor, the vehicle is in a motor-controlled operation state. Formulas in the following embodiments are obtained based on calculation of a longitudinal kinetic equation of the vehicle. Certainly, other power units (such as a fuel engine, an air engine and the like) can be used, and corresponding source power parameters can be selected according to corresponding power units so as to be applied to other types of vehicles.

Embodiments 1, 2, 6 and 13: having the same thought as that of subsequent embodiments 4 and 5, see in embodiments 4 and 5.

Embodiment 3: acquisition of a joint operation value of vehicle mass (operation conditions: variable speed operation twice, pavement gradient and wind resistance are neglected, and the vehicle is in a power unit driving state): m2=(fq2−fq1)/(a2−a1); (formula A3-4-3); m1=m2−m0.

fq2 and a2 are driving force and longitudinal acceleration acquired at time2; Te2 is electromagnetic torque acquired at time2; fq2=KeKm (Te2*im/R1); fq1 and a1 are driving force and longitudinal acceleration acquired at time1; Te1 is electromagnetic torque acquired at time1; fq1=KeKm (Te1*im/R1); m2=(KeKm(Te2−Te1)*im/R1)/(a2−a1); (formula A3-4-4).

Embodiment 4: acquisition of the joint operation value of the vehicle mass (the longitudinal acceleration and the wind resistance are neglected, and the vehicle is in the power unit driving state): m2=(Pm/V1)/(g*μ1*cos θ+g*sin θ); (formula A4-1).

Embodiment 5: acquisition of the joint operation value of the vehicle mass:

In the power unit driving state: m2=Kem*(|Te|*im/R1)/(g*μ1*cos θ+g*sin θ+a); (formula A5-2-2).

In a power unit braking state: m2=(((−|Te|)*im/R1)/Kem)/(g*μ1*cos θ+g*sin θ+a), m1=m2−m0.

Embodiment 7: acquisition of the joint operation value of the vehicle mass of the vehicle:

In the power unit driving state m2=(Kem*(|Te|*im/R1)/δ−fw−L0*ω0)/(g*μ1*cos θ+g*sin θ+a);

In the power unit braking state: m2=((((−|Te|)*im/R1)/Kem)/δ−fw−L0*ω0)/(g*μ1*cos θ+g*sin θ+a), m1=m2−m0; simplified, δ can be set as 1, and L0 can be neglected.

Embodiment 8: see in subsequent embodiment 28, having the same thought.

Embodiment 9: acquisition of a joint operation value Kem_cal of an electromechanical transmission integrated efficiency coefficient of the vehicle; models are as follows:

In the power unit driving state: Kem_cal=(m2*g*μ1*cos θ+m2*g*sin θ+m2*a+fw)/(Te*im/R1).

In the power unit braking state: Kem_cal=(Te*im/R1)/(m2*g*μ1*cos θ+m2*g*sin θ+m2*a+fw).

Embodiment 10: acquisition of a joint operation value μ1_cal of a rolling resistance coefficient of the vehicle:

In the power unit driving state: μ1_cal=(Kem*(|k12*cos φ*Uo*Io/V1)−m2*g*sin θ−m2*a−fw)/(m2*g*cos θ).

In the power unit braking state: μ1_cal=((−|(k12*cos φ*Uo*Io)|/V1)/Kem−m2*g*sin θ−m2*a−fw)/(m2*g*cos θ).

k12 is a constant and has a value of 1.732; a substituted calculation formula of k12*cos φ*Uo*Io is as follows:

(k12*cos φ*Uo*Io)=(k13*Ui*Ii)=(k13*Ub1*Ib1)=Pm,

(k12*cos φ*Uo*Io)=(U4*I4/k14)=(Ub2*Ib2/k14)=Pm.

Torque and rotating speed integrated force-measuring calculation formula 1: (Te*im/R1)=(Te*n1/9.55/V1); fw=(1/2)*Cd*(p0*S*(V2)²); longitudinal velocity V1 can directly replace V2.

Embodiment 11: acquisition of joint operation values m1 and m2 of the vehicle mass (in the power unit driving state by default):

m2=((Ke*Km)*(Te*im/R)−fw)/(g*f*cos θ+g*sinθ+a), m1=m2−m0.

Embodiment 12: acquisition of the joint operation values m1 and m2 of the vehicle mass (in the power unit driving state by default):

m2=((Ke*Km)*(P2o/Vₓ)−fw)/(g*f*cos θ+g*sin θ+a), m1=m2−m0.

Embodiment 14: acquisition of the joint operation values m1 and m2 of the vehicle mass of the vehicle (wind resistance is neglected, and the vehicle is in the power unit driving state):

m2=((Ke*Km)*(P2o/Vₓ)−fw)/(g*f*cos θ+g*sin θ+a), m1=m2−m0.

Description of an extended solution of embodiment 14: (iq*Ki) in embodiment 4 can be replaced with (Io*cos φ1*Ko) or (k21*I2o*cos φ2*Ko) or (k31*I3o*cos φ3*Ko).

Embodiment 15: having the same thought as that of embodiment 3; fq2 is replaced with (P2o_2/Vₓ2), fq1 is replaced with (P2o_1, Vₓ1 and a1 are respectively electric power, longitudinal velocity and longitudinal acceleration acquired at tim1; P2o_2, a2 and Vₓ2 are respectively vehicle operation parameters (the electric power, longitudinal velocity and longitudinal acceleration) acquired at tim2 different from the time point tim1; and a2≠a1.

Embodiment 16: acquisition of the joint operation values m1 and m2 of the vehicle mass (in the power unit driving state by default):

m2=(k31*(Ke*Km)*(P3i/Vₓ)−fw)/(g*f*cos θ+g*sin θ+a), m1=m2−m0.

Embodiment 17: acquisition of a joint operation value of the vehicle mass of the vehicle:

In the power unit driving state: m2=((Ke*Km)*(Te*im/R)−fw)/(g*f*cos θ+g*sin θ+a).

In the power unit driving state: m2=(−|(Te*im/R)|/(Ke*Km)−fw)/(g*f*cos θ+g*sin θ+a), m1=m2−m0.

Embodiment 18: acquisition of the joint operation values m1 and m2 of the vehicle mass of the vehicle (an operation condition: the power unit driving state, the motor refers to two motors (of the same model) in a parallel drive manner, and Te1 and Te2 refer to respective electromagnetic torque of the two motors:

m2=((Ke*Km)*(Te1+Te2)*im/R−fw)/(g*f*cos θ+g*sin θ+a), m1=m2−m0.

Description of an extended solution of embodiment 18: in a similar way, a vehicle driven by N motors in parallel can be calculated by using an extended technical solution in the present embodiment. For example, (Te1+Te2) in the present embodiment is replaced with (Te1+Te2+ . . . +TeN).

Embodiment 19: acquisition of a joint operation value of the vehicle mass of the vehicle (an operation condition: the power unit driving state, three motor driving devices are in a parallel drive manner, and P2i_1, P2i_2 and P2i_3 respectively refer to input electric power of the motor driving devices):

m2=(k21*(Ke*Km)*(P2i_1+P2i_2+P2i_3)/Vₓ−fw)/(g*f*cos θ+g*sin θ+a), m1=m2−m0.

Description of an extended solution of embodiment 19: in a similar way, a vehicle driven by N motor driving devices in parallel can be calculated by using an extended technical solution in the present embodiment. For example, (P2i_1+P2i_2+P2i_3) in the present embodiment is replaced with (P2i_1+ . . . +P2i_N).

Embodiment 20: acquisition of a joint operation value of the vehicle mass of the vehicle (two power units supply power in parallel, and P3i_1 and P3i_2 refer to input power of each power unit)

When all motors of the vehicle are in an electric state:

m2=(k31*(Ke*Km)*(P3i_1+P3i_2)/Vₓ−fw)/(g*f*cos θ+g*sin θ+a), m1=m2−m0.

When not all the motors of the vehicle are in the electric state, vehicle motion balance calculation can be suspended.

Description of an extended solution of embodiment 20: in a similar way, a vehicle powered by N power units in parallel can be calculated by using an extended technical solution in the present embodiment. For example, (P3i_1+P3i_2) in the present embodiment is replaced with (P3i_1+ . . . +P3i_N).

Embodiment 21: acquisition of the joint operation values m1 and m2 of the vehicle mass of the vehicle (an operation condition: fuel mass is neglected, and a power unit operation condition is that the vehicle is in a power unit driving state); an electromechanical combined parameter fq is essentially mechanical driving force acting on a driving wheel obtained based on electric parameter calculation; fq=(Ke*Km)*(Te*im/R);

m2=(fq−fw)/(g*f*cos θ+g*sin θ+a), m1=m2−m0.

Embodiment 22: acquisition of a joint operation value of the vehicle mass (an operation condition is that the vehicle is in a power unit driving state).

An electromechanical combined parameter Tq is essentially mechanical torque acting on a driving wheel based on measurement and calculation of electric parameters; Tq=(Ke*Km)*Te*im;

m2=(Tq/R−fw)/(g*f*cos θ+g*sin θ+a), m1=m2−m0.

Embodiment 23: acquisition of a joint operation value of the vehicle mass of the vehicle (an operation condition is that the vehicle is in a power unit driving state); an electromechanical combined parameter Pq is essentially mechanical power for driving the vehicle to longitudinally operate obtained based on calculation of electric parameters; Pq=(Ke*Km)*P2o;

m2=(Pq/Vₓ−fw)/(g*f*cos θ+g*sin θ+a), m1=m2−m0.

Embodiment 24: having the same thought as that of embodiment 7, and is omitted.

Embodiment 25: acquisition of a joint operation value Km_cal of an efficiency coefficient of a mechanical transmission system; the thought is the same as that of embodiment 9, and is omitted.

Embodiment 26: acquisition of a joint operation value f_cal of a rolling resistance coefficient; the thought is the same as that of embodiment 10, and is omitted.

Embodiment 27: acquisition of a joint operation value fw_cal of wind resistance of the vehicle (an operation condition is that fuel mass is neglected; a power unit operation condition is that the vehicle is in a power unit driving state; dual motors are in a parallel driving manner; Po_1 and Po_2 refer to output power of each motor).

fw_cal=(Po_1+Po_2)*(Ke*Km)/Vₓ−m2*(g*f*cos θ+g*sin θ+a).

Embodiment 28: acquisition of a joint operation value Te_cal of electromagnetic torque of the vehicle (an operation condition is that the vehicle is in a power unit driving state).

Te_cal=(m2*(g*f*cos θ+g*sin θ+a)+fw)/((Ke*Km)*im/R).

Embodiment 29: acquisition of a joint operation value fq_cal of an electromechanical combined parameter fq of the vehicle; the electromechanical combined parameter fq belongs to source power parameters; fq=(Ke*Km)*(Te*im/R), fq is essentially mechanical driving force acting on a driving wheel based on measurement and calculation of electric parameters (an operation condition: fuel mass is neglected; and a power unit operation condition is that the vehicle is in a power unit driving state).

fq_cal=m2*(g*f*cos θ+g*sin θ+a)+fw

Embodiment 30: acquisition of a joint operation value fr_cal of a mechanical combined parameter fr of the vehicle; the mechanical combined parameter fr belongs to mechanical operation parameters in system operation parameters; fr=m2*(g*f*cos θ+g*sin θ+a), fr is essentially vehicle driving force acting on a driving wheel which does not include wind resistance; (a power unit driving state);

When the vehicle is in a motor braking state or in a critical switching area, this calculation is suspended.

When the vehicle is in an electric state: fr_cal=((Ke*Km)*(P2o/Vx)−fw)

Embodiment 31: acquisition of the joint operation values m1 and m2 of the vehicle mass (an operation condition: the power unit driving state); m2=((Ke*Km)*(Te*im/R)/δ−(fw+fb+L0*β))/(g*f*cos θ+g*sin θ+a), m1=m2−m0.

Embodiment 32: acquisition of a joint operation value Km_cal of the efficiency coefficient of the mechanical transmission system; the thought is the same as that of embodiment 9, and is omitted.

Embodiment 33: acquisition of joint operation values of the vehicle mass of the vehicle (during backward operation of the vehicle, a vehicle forward/backward state is given by a central controller of the vehicle). A thought of a specific calculation model is the same as that of embodiment 7, and is omitted. According to technical solutions in the present embodiment, during vehicle reverse, related vehicle operation parameters can also be measured and calculated and can be further monitored.

By referring to embodiments in the present invention, any measuring, calculating, identifying and monitoring method and/system provided by the present invention can be implemented during reverse.

The following typical calculation formulas are used for calculation based on the longitudinal dynamic model of the vehicle (i.e. vehicle motion balance calculation): Fₓ is a longitudinal driving force of the vehicle.

13.1. A conventional longitudinal dynamic model of the vehicle is: Fx=m2*g*f*cos θ+m2*g*sin θ+m2*a+fw (formula 13.1)

13.2. Increase of braking force fb: Fx=m2*g*f*cos θ+m2*g*sin θ+m2*a+fw+fb (formula 13.2)

13.3. Increase of rotating inertia L0*β of an internal comprehensive rotating rigid body: Fx=m2*g*f*cos θ+m2*g*sin θ+m2*a+fw+L0*β; (formula 13.3)

13.4. Increase of a curve coefficient δ: Fx=(m2*g*f*cos θ+m2*g*sin θ+m2*a+fw)*δ; (formula 13.4)

Together with the longitudinal dynamic model of the vehicle shown in the formulas 13.1, 13.2, 13.3 and 13.4 above, as shown in embodiments 1-33 provided by the present invention, the longitudinal dynamic model of the vehicle in the present invention (i.e. a vehicle motion balance model) includes a constant speed operation state and a variable speed operation state. By integrating the calculation formulas above and calculation formulas in other embodiments, an integrated longitudinal dynamic model of the vehicle (i.e. the vehicle motion balance model) can be summarized as: E=m*X1−Y1; (formula 13.5)

When Y1 is neglected, the model is: E=m*X1; (formula 13.6),

wherein, m is vehicle mass; E is a source power parameter; X1 is a coefficient having a direct product relationship with the mass and includes any one or more parameters of the rolling resistance coefficient, the longitudinal acceleration, the pavement gradient and the efficiency coefficient of the mechanical transmission system; Y1 is a component without a direct product relationship with the mass and includes the wind resistance. X1 and Y1 are the system operation parameters of the vehicle; and when a power unit controlling the vehicle operation is a motor, the source power parameter is a motor driving parameter.

In any solution and any paragraph of the present invention: the calculation based on the longitudinal dynamic model of the vehicle is and is equal to the vehicle motion balance calculation.

As shown in embodiment 28 and embodiment 1, in “calculation” of the present invention referring to the calculation model (i.e. a formula), the source power parameter in the calculation based on the longitudinal dynamic model of the vehicle (i.e. the vehicle motion balance calculation) can be on the left in an equal sign of the calculation model (i.e. the formula), or on the right in the equal sign of the calculation model (i.e. the formula). “Parameters being calculated” in the present invention can refer to calculated input parameters or measurement and calculation objects (i.e calculated output parameters). Parameters in the “parameters being calculated” refer to parameters in the “longitudinal dynamic model of the vehicle”. Participation in calculation in the present invention refers to “participating in calculation of the longitudinal dynamic model of the vehicle”, that is, “included in the longitudinal dynamic model of the vehicle”, i.e. “certain parameters included in the longitudinal dynamic model of the vehicle”.

According to multiple realization manners recorded in the present application document (such as embodiments 1-33, formulas 13.1-13.6, embodiment 41, etc.), apparently, a vehicle motion balance principle is essentially a combination of a principle of energy conservation and/or Newton's law and/or vehicle operation characteristic factors. The principle of energy conservation refers to that energy (or power) output by a power system of the vehicle is equal to energy (or power) consumed outside the power system of the vehicle, and/or energy (or power) absorbed by the power system of the vehicle is equal to energy (or power) fed back outside the power system of the vehicle. The Newton's law refers to longitudinal dynamics balance of the vehicle. The vehicle operation characteristics refer to that: the vehicle is longitudinally operated along a pavement or a track under control of the power system; wheels of the vehicle roll and longitudinally operate along the pavement or the track, so rolling resistance (m2*g*f*cos θ) naturally exists during the vehicle operation; if the vehicle is operated in a non-direct contact manner (such as a magnetic levitation vehicle, etc.), a rolling resistance coefficient f is close to zero; a gradient θ naturally exists on the pavement (or the track), so gradient resistance (m2*g*sin θ) naturally exists in the vehicle. Because the vehicle is generally operated in a non-vacuum state, the vehicle rubs with air to generate wind resistance (i.e air resistance) fw. When the vehicle operates at a speed close to zero or a speed lower than a preset value, fw is equal to 0. When longitudinal velocity of the vehicle is changed, variable speed resistance (m2*a) naturally exists in the vehicle, and when the velocity is constant, (m2*a)=0. In the present invention, the vehicle motion balance refers to the longitudinal dynamics balance of the vehicle, that is, power of the vehicle in an operation direction is balanced with related resistance. The related resistance includes any one or more of the rolling resistance, gradient resistance, variable speed resistance and wind resistance. The longitudinal dynamic model of the vehicle is a formula for describing the balance between the power of the vehicle in the operation direction or a variant formula. Certainly, the related resistance can further include other unimportant resistance lower than the preset value (such as fb, L0*β, etc.) The operation direction refers to a movement direction. Apparently and undoubtedly: in the present invention, the longitudinal dynamics balance of the vehicle is a vehicle motion balance calculation formula, i.e. the vehicle motion balance model. In the present invention, the model is a formula, i.e. an equation. The vehicle motion balance calculation is calculation (or calculating) based on the longitudinal dynamic model of the vehicle. In the present invention, the longitudinal dynamic model of the vehicle refers in particular to a longitudinal driving dynamics model of the vehicle.

According to all embodiments of the embodiments 1-33 except embodiments 2 and 15, apparently, for a vehicle of which wheels are rolled and longitudinally operated along the pavement or the track (i.e. a wheeled vehicle), when the rolling resistance is included in the longitudinal dynamic model of the vehicle, the rolling resistance coefficient f is one of core factors of calculation of the rolling resistance (m2*g*f*cos θ), that is, the rolling resistance is obtained by calculation based on parameters including the rolling resistance coefficient f at least. Great defects may exist in a calculation solution of the rolling resistance without considering the rolling resistance coefficient f. Only in a vehicle of which operation characteristics have major differences from those of the wheeled vehicle and a vehicle which is operated on the pavement or the track in a non-mechanical contact manner (such as the magnetic levitation vehicle), the rolling resistance coefficient f is close to zero, and then the rolling resistance (m2*g*f*cos θ) is close to zero. Track vehicles (such as a tank, etc.) also belong to special vehicles in the wheeled vehicles, and a crawler can be considered as an integral rigid wheel.

In the present invention, the calculation based on the longitudinal dynamic model of the vehicle (i.e. the vehicle motion balance calculation) refers to calculation of another parameter according to any two of parameters including gross vehicle mass, source power parameters and system operation parameters at least. For example, power unit operation conditions and other data are included in the embodiments 9, 10 and 17. Braking force fb is further included in the aftermentioned formula 13.2.

When the measurement and calculation object is the vehicle mass, the joint operation value of the measurement and calculation object is obtained by calculation according to data including the source power parameters and the system operation parameters at least, that is, the input parameters include the system operation parameters and the source power parameters.

When the measurement and calculation object is the source power parameter, the joint operation value of the measurement and calculation object is obtained by calculation according to data including the gross vehicle mass and the system operation parameters, that is, the input parameters include the system operation parameters and the gross vehicle mass.

When the measurement and calculation object is the system operation parameter, the joint operation value of the measurement and calculation object is obtained by calculation according to data including the gross vehicle mass and the source power parameters, that is, the input parameters include the gross vehicle mass and the source power parameters.

For example, a correlation table of the vehicle mass, the source power parameters and the system operation parameters of the vehicle is preset. A value of another parameter can be calculated by looking up the table when any two parameters are input. The table can be considered as a special formula and a fixing and quantifying formula. The table or a mathematical formula can be considered as a model. For example, correspondences between the power and the system operation parameters (particularly the mechanical operation parameters therein) can be obtained one by one through a lookup table of the longitudinal dynamic model of the vehicle under the condition that the gross vehicle mass m2 is fixed. Calculation performed by simplifying or neglecting some parameters based on the longitudinal dynamic model of the vehicle is a transformation of the longitudinal dynamic model of the vehicle and is also in the scope of the concept of the present invention.

In the present invention, understood from another perspective, the longitudinal dynamic model of the vehicle is a formula for describing the balance between the power of the vehicle in the operation direction and the related resistance and transformation formulas thereof. The related resistance includes any one or more (combined resistance) of the rolling resistance, gradient resistance, variable speed resistance and wind resistance, or includes one of the rolling resistance, the gradient resistance, the variable speed resistance and the wind resistance, or includes a sum of any more of the rolling resistance, the gradient resistance, the variable speed resistance and the wind resistance, wherein the sum is the combined resistance.

The longitudinal dynamic model of the vehicle can be a typical formula for describing the balance between the power of the vehicle in the operation direction and the related resistance (such as fq=Fx=m2*(g*f*cos θ+g*sin θ+a)+fw), or a longitudinal dynamic model of the vehicle for the transformation based on a difference value of two parameters acquired at different time points, or other transformation formulas of the typical formula.

The formula for describing the balance between the power of the vehicle in the operation direction and the related resistance or the transformation formula thereof includes transformation of at least one of the power Fx, the rolling resistance fμ, the gradient resistance f_{θ}, the variable speed resistance fa and the wind resistance fw.

A transformation formula of the power Fx includes: F−fb−L0*β, and Fₓ=F−F0, wherein F represents force of the motor or the engine acting on the vehicle.

A transformation formula of F includes: (Kem*k12*cos φ*Uo*Io)/Vₓ, (Km*Pr1)/Vₓ, (Km*fm1*Kf1)/Vₓ, ((Ke*Km)*(P2o/Vₓ), ((Ke*Km)*(Te*im/R), Kem*k12*cos φ*Uo*Io/Vₓ, (Kem*k13*Ui*Ii)/Vₓ, (Kem*k13*Ub1*Ib1)/Vₓ, and (Kem*Pm)/Vₓ.

A transformation formula of F0 includes: fb+L0*β, wherein F0 represents total resistance in the motor or the engine, fb represents a braking force component, L0 represents rotating inertia of the internal comprehensive rotating rigid body, β represents an angular acceleration of the internal comprehensive rotating rigid body, and when β is equal to 0, it indicates that the angular acceleration of the internal comprehensive rotating rigid body is zero or is equal to the angular acceleration of the internal comprehensive rotating rigid body.

Kem represents an electromechanical transmission integrated efficiency coefficient, k12 is a preset constant, φ is a power factor, Uo is a motor voltage, Io is motor current, Km represents an efficiency coefficient of the mechanical transmission system, Pr1 represents driving power of the fuel engine, Vₓ represents longitudinal velocity of the vehicle, fm1 represents a fuel consumption rate in the engine, Kf1 represents an energy conversion coefficient, Ke represents an efficiency coefficient of the motor, P2o represents electric power output by the motor, Te represents electromagnetic torque, Pm represents electric power of the motor, im represents an integrated transmission ratio, R represents a radius of the driving wheel, k13 represents an efficiency coefficient from a motor driving device to the motor, Ui represents an input voltage of the motor driving device, Ii represents input current of the motor driving device, Ub1 represents an output voltage of the power unit, and Ib1 represents output current of the power unit.

A transformation manner of the rolling resistance fμ includes: fμ=m2*g*f*cos θ, wherein m2 represents the gross vehicle mass, g represents acceleration of gravity, f represents the rolling resistance coefficient, θ represents the pavement gradient, and when fμ is equal to 0, it indicates that the rolling resistance coefficient f is zero or is neglected.

A transformation manner of the gross vehicle mass m2 includes: m1+m0, m1+m0+mf2−mf1 and m1−m0+mf0, wherein m1 is carried goods mass, m0 represents no-load vehicle mass, mf0 represents residual fuel mass, mf1 represents consumed fuel mass, and mf2 represents fuel mass at a historical record point.

A transformation manner of the gradient resistance f_{θ} includes: f_{θ}=m2*g*sin θ, and when f_{θ} is equal to 0, it indicates that the pavement gradient θ is zero or is neglected.

A transformation manner of the variable speed resistance fa includes: fa=m2*a, and when fa is equal to 0, it indicates that the acceleration a is zero or is neglected.

A transformation manner of the wind resistance fw includes: fw=(1/2)*Cd*(p0*A0*(Vx)²), wherein Cd represents a wind resistance coefficient of the vehicle, p0 represents air density, A0 represents a windward area of the vehicle, Vx represents the longitudinal velocity, and when fw=0, it indicates that fw is equal to 0 or is neglected.

The formula for describing the balance between the power of the vehicle in the operation direction and the related resistance or the transformation formula further includes that: integral transformation is simultaneously performed on two sides of the equal sign relative to the same variable. An integral transformation manner includes that: an integral of the power to time is energy, an integral of force to displacement is energy, an integral of velocity to the time is a displacement, an integral of the acceleration to the time is velocity, and an integral of the force to the time is an impulse.

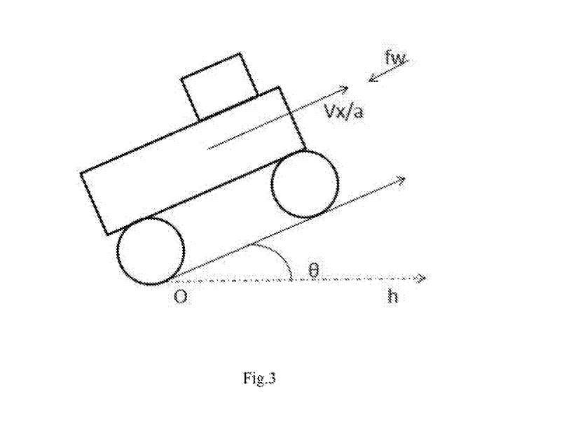

FIG. 3 is the diagram showing a vehicle operation state, wherein, the connecting line of O and h represents the horizontal line; θ represents the road slope; fw represents for the air resistance to the vehicle, i.e. wind resistance; Vx represents for the longitudinal speed; a represents for the longitudinal acceleration.

Purposes and to-be-solved technical problems in the present invention are as follows: one or more solutions (including a method (#1) or a system (#1) aftermentioned or a method (#2) or a system (#2) aftermentioned or a method (#3) or a system (#3) aftermentioned) are provided for identifying operation conditions of the vehicle. The operation conditions of the vehicle refer in particular to power transmission conditions of the vehicle. In the present invention, the power transmission conditions of the vehicle refer to conditions of a system related to the power transmission in the vehicle. A core invention idea of the present invention is acquisition of joint operation values of measurement and calculation objects of the vehicle, wherein the joint operation values of measurement and calculation objects are results obtained by calculation based on values of the acquired input parameters, and the calculation is calculation based on the longitudinal dynamic model of the vehicle for identifying the operation conditions of the vehicle. The input parameters are all parameters except the measurement and calculation objects in the model. Based on the content in the present invention, those skilled in the art can understand that the power is acquired by a signal acquisition point of the source power parameters and indicated by the source power parameters. Apparently, the system related to the power transmission in the vehicle refers to a power system and/or a transmission component and/or a wheel after the signal acquisition point of the source power parameters in the vehicle. Apparently, the system related to the power transmission is a system related to the parameters in the measurement and calculation objects and in the longitudinal dynamic model of the vehicle. The system related to the power transmission in the vehicle can also be called a to-be-monitored power transmission component. The conditions refer in particular to safety conditions or health conditions or working conditions or operation conditions. The identification refers to analysis or judgment or calculation or indication. The power transmission conditions are also conditions of the system related to the power transmission in the vehicle, that is, safety conditions and/or health conditions of the power system and/or the transmission component and/or the wheel after the signal acquisition point of the source power parameters in the vehicle. In the present invention, the safety conditions of the wheel refer to wheel deformation (out-of-roundness) and/or wheel wear conditions and/or radius change conditions of the wheel. If the wheel is excessively worn, the radius of the wheel is inevitably reduced. Tire leak causes tire deformation first and may cause reduction of the wheel radius. Preferably, the safety conditions of the system related to the power transmission in the vehicle refer in particular to efficiency conditions of power transmission of the to-be-monitored power transmission component (i.e. the size of the efficiency coefficient) and/or the rolling resistance coefficient of the wheel (particularly a rolling resistance coefficient component fc related to the vehicle therein). Preferably, the system related to the power transmission in the vehicle is a rotary operation type power or transmission component. Preferably, the safety conditions of the wheel refer to the wheel deformation (out-of-roundness) and/or wheel wear conditions. Abnormality of the operation conditions of the system related to the power transmission in the vehicle is also power transmission fault. The technical solutions provided in the present invention can be used for avoiding generating more serious and unpredictable safety accidents (including shaft breakage, car crash, etc.). Like cancer diagnosis of human medicine, if a cancer is discovered at an advanced stage, it generally means the end of life, and if early warning can be given, the cancer can be discovered early, it generally means normal survival. Therefore, the present technical solution has important practical significance on safety operation of the vehicle.

The vehicle operation condition can also refer to a condition whether the vehicle is overloaded, i.e. whether personnel/goods loaded in the vehicle is overweight.

The purposes of the present invention are achieved by the following technical solutions:

I, The present invention provides a method (#1) for measuring and calculating vehicle operation parameters, including the following steps:

presetting and calculating a longitudinal dynamic model of a vehicle of a measurement and calculation object, wherein the measurement and calculation object is one of the vehicle operation parameters;

acquiring values of input parameters, wherein the input parameters are all parameters except the measurement and calculation object in the longitudinal dynamic model of the vehicle, that is, the input parameters are parameters required for calculating a value of the measurement and calculation object according to the longitudinal dynamic model of the vehicle; and calculating the value of the measurement and calculation object according to the acquired values of the input parameters and the longitudinal dynamic model of the vehicle.

The present invention further provides a system (#1) for measuring and calculating the vehicle operation parameters. The system (#1) has a measurement and calculation device used for realizing the technical solution in the method (#1) above, that is, the system (#1) includes a presetting module, a parameter acquisition module and a calculation module. The presetting module is used for presetting and calculating the longitudinal dynamic model of the vehicle of the measurement and calculation object, wherein the measurement and calculation object is one of the vehicle operation parameters; the parameter acquisition module is used for acquiring values of the input parameters, wherein the input parameters are all parameters except the measurement and calculation object in the longitudinal dynamic model of the vehicle; and the calculation module is used for calculating the value of the measurement and calculation object according to the acquired values of the input parameters and the longitudinal dynamic model of the vehicle.

Preferably, in the method (#1) or the system (#1), the measurement and calculation object refers to parameters for representing attributes of a power system and/or a transmission system in unmeasurable parameters and/or system intrinsic parameters.

In the present invention, the parameters for representing the attributes of the power system and/or the transmission system in the unmeasurable parameters and/or the system intrinsic parameters are called parameters closely related to safety in the power or transmission system and belong to parameters of a second category. The parameters include an efficiency coefficient, a rolling resistance coefficient, an integrated transmission ratio, a driving wheel radius, etc. The parameters closely related to the safety do not include a windward area A₀ of the vehicle. Due to wind resistance, the windward area has slight influence when the vehicle is operated at a low speed and cannot achieve an effective safety monitoring effect.

For example, the measurement and calculation object is the efficiency coefficient or a parameter including the efficiency coefficient, e.g., in embodiment 9, an electromechanical transmission integrated efficiency coefficient Kem of the vehicle serves as the measurement and calculation object, (Kem(Te*im/R1)) can be taken as the measurement and calculation object, and the measurement and calculation object (Kem(Te*im/R1)) includes the efficiency coefficient Kem. For example, the measurement and calculation object is the rolling resistance coefficient or a parameter including the rolling resistance coefficient, e.g. in embodiment 10, a rolling resistance coefficient μ1 of the vehicle serves as the measurement and calculation object, (g*μ1*cos θ) can be taken as the measurement and calculation object, and the measurement and calculation object (g*μ1*cos θ) includes the rolling resistance coefficient μ1.

Embodiment 1 of the measurement and calculation method (#1):

S1, determining an efficiency coefficient KeKm as a measurement and calculation object, wherein a formula A3-4-4 in the present invention is transformed to obtain (KeKm=m2(a2−a1)R1/((Te2−Te1)*im)), and the formula is A3-5; and

S2, acquiring a reasonable value of each input parameter: e.g., acquiring values of parameters to be measured therein (acquiring measured values of input parameters (Te2, a2) at time2, and acquiring measured values of input parameters (Te1, a1) at time1); acquiring preset standard values of presetable parameters (R1, im); acquiring an actual value of gross vehicle mass m2; and calculating a value of the measurement and calculation object according to the values of the acquired input parameters and a longitudinal dynamic model (A3-5) of the vehicle, wherein the value obtained by calculation can be considered as an actual value of the efficiency coefficient (KeKm) at time2.

Embodiment 2 of the measurement and calculation method (#1):

S1, determining a rolling resistance coefficient f of the vehicle as a measurement and calculation object, transforming a formula in embodiment 26, and determining a longitudinal dynamic model of the vehicle as: f_cal=((Ke*Km)*Te3*im/R1)−fw−m2*(g*sin θ+a))/(m2* g*cos θ), (formula A3-6); and

S2, acquiring a reasonable value of each input parameter: e.g. assuming that time3 is a time point close to the time point time2 in embodiment 1 above; acquiring values of parameters to be measured therein (a measured value of an input parameter (Te3, a, fw, θ) at time3 is acquired; acquiring a preset standard value of a presetable parameter (Ke, Km, R1, im, g); acquiring an actual value of gross vehicle mass m2 at time3; and calculating a value of the measurement and calculation object according to the values of the acquired input parameters and a longitudinal dynamic model (A3-6) of the vehicle. Because time3 is close to the time point time2, the value of the efficiency coefficient (KeKm) acquired at time2 can be considered as an actual value at time3. The value obtained by calculation according to the formula (A3-6) can be considered as an actual value of the rolling resistance coefficient f at time3. A value of the current road section fr can be obtained by a preset lookup table of map information or position information, and an actual value of a rolling resistance coefficient component fc related to the vehicle at time3 can be further obtained.

Effects of the method (#1) or the system (#1): the method (#1) or the system (#1) has significances on safety monitoring, supervision and data processing of the vehicle; if the measurement and calculation object is the rolling resistance coefficient or the parameter including the rolling resistance coefficient, the calculation results can be used for reflecting conditions of the rolling resistance coefficient, that is, safety conditions of wheels; if the measurement and calculation object is the efficiency coefficient or the parameter including the efficiency coefficient, the calculation results can be used for reflecting wear and/or safety conditions of a to-be-monitored power transmission component of the vehicle; if the measurement and calculation object is an integrated transmission ratio or a parameter including the integrated transmission ratio, the calculation results can be used for reflecting conditions of the integrated transmission ratio, and abnormality of the integrated transmission ratio generally represents a serious fault of a mechanical transmission system of the vehicle; and if the measurement and calculation object is a driving wheel radius or a parameter including the driving wheel radius, the calculation results can be used for reflecting conditions of the driving wheel radius, and abnormality of the driving wheel radius generally occurs when serious potential safety hazards such as tire burst, radius reduction and the like occur.

The present invention also provides a method (#2) for identifying the power transmission conditions of the vehicle; the method (#2) includes a solution A:

A. The measurement and calculation object is one of the vehicle operation parameters; the data at least including the joint operation value of the measurement and calculation object are acquired for identifying the power transmission conditions of the vehicle; the joint operation value of the measurement and calculation object is a result calculated based on the acquired values of the input parameters; the calculation is the calculation based on the longitudinal dynamic model of the vehicle; the input parameters are parameters required to calculate the value of the measurement and calculation object according to the longitudinal dynamic model of the vehicle, i.e., the input parameters are all parameters in the model except the measurement and calculation object.

Further, the solution A further includes any one or more of the following characteristics A1, A2 and A3: A1, the parameter during calculation includes or is a pavement slope; A2, if the model includes rolling resistance, the calculation formula of the rolling resistance includes the rolling resistance coefficient; for example, the rolling resistance is equal to (m2*g*f*cos θ); A3, when the measurement and calculation object is any one of the parameters to be measured and/or the source power parameters and/or the mechanical operation parameters, the acquired value of the gross vehicle mass included in the input parameters is the actual value. In the present invention, the “parameters in calculation” can refer to the calculated input parameters or the measurement and calculation object (i.e., the calculated output parameters); and the parameters in the “parameters in calculation” can also be understood as the parameters in the “longitudinal dynamic model of the vehicle”.

Certainly, A3 can also be replaced with a solution A4: regardless of the type of the measurement and calculation object, when the input parameters include the gross vehicle mass, the value of the gross vehicle mass is the actual value, i.e., when the measurement and calculation object is any one of the vehicle operation parameters except the vehicle mass, the value of the gross vehicle mass included in the input parameters is the actual value.

The present invention also provides a system (#2) for identifying the power transmission conditions of the vehicle; and the system (#2) includes a processing module for realizing the function of the solution A.

Preferably, in the method (#2) or the system (#2), “the measurement and calculation object is one of the vehicle operation parameters, and the data at least including the joint operation value of the measurement and calculation object is acquired for identifying the power transmission conditions of the vehicle” includes any one or more of the following solutions B1, B2, B3 and B4:

B1: the measurement and calculation object is one of the vehicle operation parameters; the data at least including the reference data of the measurement and calculation object and the joint operation value of the measurement and calculation object are acquired; and the power transmission conditions of the vehicle are identified based on the data;

B2: when the measurement and calculation object is any one of the vehicle mass and/or the unmeasurable parameters and/or the system intrinsic parameters, the data at least including the joint operation value of the measurement and calculation object are acquired; and the data are outputted and/or stored;

B3: when the measurement and calculation object is any one of the vehicle operation parameters except the unmeasurable parameters and/or the system intrinsic parameters, the data at least including the joint operation value of the measurement and calculation object and related data of the measurement and calculation object are acquired; the data are outputted and/or stored; the related data of the measurement and calculation object are data including the second permissive range of the measurement and calculation object and/or the actual value of the measurement and calculation object; and

B4: when the related data of the measurement and calculation object are displayed on the man-machine interfaces of in-vehicle electronic equipment and/or portable personal consumer electronics.

The solution B1 can be understood as a standard and complete technical solution automatically performed by hardware and software devices, for identifying the power transmission conditions of the vehicle.

Any one of the solutions B2, B3 and B4 is used for identifying the power transmission conditions of the vehicle; the identification solution can be understood as a non-standard and indirect solution as well as a technical solution convenient for the drivers, the passengers and the managers to automatically identify the power transmission conditions of the vehicle.

The joint operation value of the measurement and calculation object is outputted and/or stored to form the historical record original value of the parameters; the actual value of the measurement and calculation object is outputted and/or stored to form the historical record actual value of the parameters; a difference value between the joint operation value and the actual value of the measurement and calculation object is outputted and/or stored to form a historical record difference value of the measurement and calculation object; and apparently, the historical record difference value of the measurement and calculation object is the difference value between the historical record original value and the historical record actual value of the measurement and calculation object.

In the present invention, the portable personal consumer electronic products are divided into in-vehicle products and out-vehicle products, and preferably refer to in-vehicle portable personal consumer electronic products naturally in absence of limited description.

Preferably, in the solution B2, the data at least including the joint operation value of the measurement and calculation object are data at least including the joint operation value of the measurement and calculation object and multiple types of identification data of the measurement and calculation object; the multiple types of identification data of the measurement and calculation object are the related data of the measurement and calculation object and/or the reference data of the measurement and calculation object; and the related data of the measurement and calculation object are data at least including the second permissive range and/or the actual value and/or the calibration value of the measurement and calculation object.

Preferably, in the solution B3, the “data at least including the joint operation value of the measurement and calculation object and the related data of the measurement and calculation object” are the data at least including the joint operation value of the measurement and calculation object, the related data of the measurement and calculation object and the reference data of the measurement and calculation object; and the related data of the measurement and calculation object are data at least including the second permissive range and/or the actual value of the measurement and calculation object.

Preferably, in the solution B1, the identification for the power transmission conditions of the vehicle is to judge whether the power transmission conditions of the vehicle are abnormal.

The acquisition in the present invention may include reception of the joint operation value of the measurement and calculation object transmitted by external devices (such as an OBD system of a vehicle, or a motor driving device, or a vehicle ECU) in a wireless or wired communication manner. The wired communication manner includes USB or CAN bus. Vehicle operation parameters can be received through wired and/or wireless communication manners, and the joint operation value of the measurement and calculation object is obtained by calculation based on a longitudinal dynamic model of the vehicle. The value can also be acquired through the following solution, and the solution includes the following step A:

S100, taking any one of the vehicle operation parameters as the measurement and calculation object; and

S200, determining the longitudinal dynamic model of the vehicle for calculating the measurement and calculation object; acquiring values of input parameters, wherein the input parameters are all parameters except the measurement and calculation object in the longitudinal dynamic model of the vehicle; and calculating the measurement and calculation object according to the values of the input parameters and the longitudinal dynamic model of the vehicle, wherein the acquired values of the input parameters in the longitudinal dynamic model of the vehicle are reasonable values (can also be called qualified values).

For example, in embodiment 9 above, a value of a source power parameter (that is, electromagnetic torque Te) is acquired, a value of vehicle mass (m2) and values of system operation parameters (g, μ1, θ, a, fw, im and R1) are acquired in a preset time range, and a joint operation value Kem_cal of the electromechanical transmission integrated efficiency coefficient is calculated through the longitudinal dynamic model of the vehicle provided in embodiment 9.

For example, in embodiment 12 above, a value of a source power parameter (that is, motor output electric power P2o) is acquired, values of system operation parameters (Ke, Km, Vx, fw, g, f, θ and a) in a preset time range are acquired, and a value of m2 is calculated through the longitudinal dynamic model of the vehicle (m2=((Ke*Km)*(P2o/Vₓ)−fw)/(g*f*cos θ+g*sin θ+a)) provided in embodiment 12.

In the present invention, reference data of the measurement and calculation object refers to data used for matching with the joint operation value of the measurement and calculation object to identify power transmission conditions of the vehicle. The identification refers to comparison and/or judgment, and the conditions refer in particular to conditions whether the power transmission conditions are abnormal. Because a single data cannot form complete comparison and/or judgment, the reference data needs to be set as reasonable data capable of achieving the purpose. The reference data of corresponding measurement and calculation objects can be set according to differences of one of or differences of more of setting methods of the measurement and calculation objects, the longitudinal dynamic model of the vehicle and the input parameters of the longitudinal dynamic model of the vehicle.

In the present invention, the reference data includes or is power transmission condition identification data. The power transmission condition identification data includes or is a power transmission condition identification difference or any one or two pieces of data in a power transmission condition identification value. In order to simply and conveniently describe, the power transmission condition identification value in the present invention can also be called a second permissive range including a power transmission condition identification upper limit value (i.e. a second permissive upper limit value) and/or a power transmission condition identification lower limit value (i.e. a second permissive lower limit value). In the present invention, the power transmission condition identification difference can also be called a first permissive range, that is, a permissive deviation value, and the deviation value includes a power transmission condition identification upper limit difference value (i.e. a first permissive upper limit value) and/or a power transmission condition identification lower limit difference value (i.e. a first permissive lower limit value).

For the reference data in the present invention, data properties (including data types or data acquisition ways) and value or set time of the reference data need to be considered. Typical setting solutions of the reference data are as follows:

1, When the measurement and calculation object is any one parameter of parameters to be measured and/or source power parameters and/or mechanical operation parameters and/or mass change type object mass:

the reference data of the measurement and calculation object is data including an actual value of the measurement and calculation object and/or the second permissive range of the measurement and calculation object at least; the second permissive range is a range used for identifying the power transmission conditions and is set based on the actual value. Namely, the reference data of the measurement and calculation object includes or is the actual value, or the reference data includes the actual value and the first permissive range or the reference data is the actual value and the first permissive range or the reference data includes or is the second permissive range. The second permissive range is composed of the actual value and the first permissive range and is equal to the actual value and the first permissive range.

A demonstration method (4) for setting the reference data is as follows: the actual value and/or the second permissive range of the measurement and calculation object can be set according to a measured value, and the selecting time of the reference data of the measurement and calculation object (i.e. the actual value and/or the second permissive range) and selecting time of the joint operation value may be in a preset time range, as shown in embodiments 40, 42 and 43.

Or, a demonstration method (5) for setting the reference data is as follows: the actual value and/or the second permissive range of the measurement and calculation object can be according to a historical record value of the measurement and calculation object, and a difference degree between a vehicle operation condition during selection of the historical record value and a current vehicle operation condition is lower than a preset threshold value.

In the present invention, if the difference degree between the vehicle operation condition during selection of the historical record value and the current vehicle operation condition is lower than the preset threshold value, it means that: parameters in corresponding vehicle operation conditions during generation of the historical record value are respectively consistent with parameters in the current vehicle operation condition, and the parameters in the vehicle operation condition include vehicle mass, vehicle velocity, a longitudinal acceleration, external environment information of the vehicle, source power parameters, etc. Apparently, the vehicle operation conditions refer to types and amplitudes of parameters included in the input parameters; the external environment information refers to environment information influencing a vehicle operation state except a vehicle body, such as pavement gradient, wind speed, a rolling resistance coefficient fr related to road conditions, etc. The consistency refers to that the sizes of the parameters are the same or close to one another, and if the parameters have directions, the directions of the parameters are the same or close to one another.

2, When the measurement and calculation object is any one parameter of unmeasurable parameters and/or system intrinsic parameters:

the reference data of the measurement and calculation object is data including a calibration value and/or an actual value and/or a second permissive range at least. The second permissive range is a range used for identifying the power transmission conditions. Namely, the reference data of the measurement and calculation object includes or is the second permissive range, or the reference data includes the calibration value or is the actual value; or the reference data includes the calibration value and a first permissive range; or the reference data is the calibration value and the first permissive range.

The second permissive range can be composed of the calibration value and the first permissive range, and then the second permissive range is equal to the calibration value+the first permissive range. The second permissive range can also be composed of the actual value and the first permissive range, and then: the second permissive range is equal to the actual value and the first permissive range.

A demonstration method (3) for setting the reference data is as follows: data in the reference data of the measurement and calculation object, that is, the calibration value and/or the actual value and/or the second permissive range, can be set by a joint operation value acquired according to a preset value and/or by vehicle motion balance calculation performed when set conditions are met. Subsequent embodiments 36, 37 and 38 are taken as reference examples.

3, When the measurement and calculation object is any one parameter in the vehicle mass:

the reference data of the measurement and calculation object is data including an actual value of the measurement and calculation object and/or a second permissive range of the measurement and calculation object at least; the second permissive range is a range used for identifying the power transmission conditions and is set based on the actual value; and an actual value of the vehicle mass can be set by multiple manners.

The second permissive range can be composed of the actual value and the first permissive range, and then the second permissive range is equal to the actual value and the first permissive range. Namely, the reference data of the measurement and calculation object includes or is the actual value, or the reference data includes or is the second permissive range, or the reference data includes the actual value and the first permissive range, or the reference data is the actual value and the first permissive range.

A demonstration method (2) for setting the reference data is as follows: an actual value of vehicle mass can be set by a preset value (mesosystem default value), as shown in embodiment 39. An actual value of m1 or m2 can be manually input, or can be set according to a measured value. For example, a weighing sensor is arranged on the vehicle for measuring carried goods mass.

Or, a demonstration method (1) for setting the reference data is as follows: preferably, an actual value of vehicle mass is set by a joint operation value acquired by vehicle motion balance calculation performed when set conditions are met, as shown in embodiments 34, 35 and 41. The method is one of core solutions of the present invention. By establishing a self-learning mechanism, the reference data (the actual value or the second permissive range) can be automatically and flexibly adjusted along with normal change of a load, and then the monitoring sensitivity can be improved. The method is particularly applicable to a condition that the measurement and calculation object is vehicle mass which may be greatly changed in different operation processes (such as public traffic vehicles, freight cars, ordinary private vehicles, where personnel or goods may be frequently loaded or unloaded).

In the present invention, the set conditions include two conditions, that is, manually preset conditions and/or a certain set parameter reaches a preset value. The manually preset conditions include manually input acknowledgement signals. Meeting set conditions can also be called conforming to the set conditions.

Regardless of types of the measurement and calculation objects, a demonstration method (6) for setting the reference data is as follows: a first permissive range is a preset value; and a value of the first permissive range can be obtained through a manual trial and error method or an empirical method, and the method is low in accuracy and low in efficiency. A method for setting the first permissive range according to a historical record difference value is one of preferable methods. Parameter setting accuracy and power transmission condition monitoring sensitivity can be hierarchically improved, a monitoring false alarm rate is reduced, and fuzzy control becomes accuracy control, as shown in 5B1 and/or 5B2 below: 5B1: The first permissive range of the measurement and calculation object is set according to a difference value between a historical record original value and a historical record actual value of the measurement and calculation object (i.e., a power transmission condition identification difference value); and 5B2: An actual value and/or a second permissive range of the measurement and calculation object is set according to the historical record original value of the measurement and calculation object for power transmission condition identification.

5A5—(Technical Solutions of Fuzzy Algorithm Values)—Implementation Details: setting the reference data according to a system default value lacks of flexibility; setting the reference data according to a manual set value lacks of intelligence; setting the reference data through a fuzzy algorithm is a preferable manner, and intelligence of the system can be improved. The fuzzy algorithm includes any one or more of fuzzy algorithm rules below: reference data with a highest usage frequency in the past can counted and analyzed according to a certain number of operation times; or reference data with a maximum number of selection times in recent operation times is selected; or reference data during the latest operation is automatically selected; or reference data is set by setting different weighting exponents of each data; reference data is set by integrating statistical analysis of the times and the weighting exponents, etc.

In the prior art, a research on power transmission condition identification of the vehicle (particularly monitoring of abnormal conditions) is insufficient, and a measurement and calculation method for accurately measuring quantitative data of the power transmission conditions of the vehicle is still blank. The current Internet of vehicles and Internet need to acquire numerous data (even need to build a huge big data system with high cost), and it is not easy to accurately identify wear/aging/safety conditions of a vehicle power system. In the present invention (which only needs one or two pieces of data), the power transmission conditions of the vehicle (particularly performance conditions of rotary operation type power or transmission components of diagnosed vehicles) are convenient for users/traffic polices/insurance companies to directly and simply identify at low cost.

In the present invention, condition information of the vehicle refers in particular to condition information of power transmission of the vehicle. Most basically, the condition information can be divided into two grades: normal and abnormal. The condition information can be further subdivided into condition information 1 and/or condition information 2. In the present invention, the difference value data obtained by calculation based on the joint operation value of the measurement and calculation object refers to a difference value between the joint operation value of the measurement and calculation object and reference data of the measurement and calculation object. Generally speaking, when an absolute value of the difference value tends to be great, it indicates that the power transmission condition of the vehicle tends to be poor; when the measurement and calculation object is any one parameter in the vehicle operation parameters except the unmeasurable parameters and/or system intrinsic parameters, the reference data is an actual value; and when the measurement and calculation object is any one of the unmeasurable parameters and/or the system intrinsic parameters in the vehicle operation parameters, the reference data is a calibration value or an actual value.

Condition information 1: the condition information of the power transmission of the vehicle has a limited number of grades not less than 2 (i.e., N grades, N≧2).

The reference data is a preset range, and the range is used for identifying the power transmission conditions of the vehicle. When the measurement and calculation object is any one of the unmeasurable parameters and/or the system intrinsic parameters, the grades generally refer to data obtained by comparing and judging the joint operation value of the measurement and calculation object and a range defined by the reference data of the measurement and calculation object; and the vehicle conditions are set in different grades by judging whether the joint operation value of the measurement and calculation object is in a certain range defined by the reference data. When the measurement and calculation object is any one parameter of the vehicle operation parameters except the unmeasurable parameters and/or the system intrinsic parameters, the grades generally refer to data obtained by comparing and judging difference value data obtained by calculation based on the joint operation value of the measurement and calculation object and the range defined by the reference data of the measurement and calculation object.

The grades can be understood as data obtained by comparing the reference data of the measurement and calculation object. Generally in each settable combination, compared with a later description, a previous description indicates that the vehicle condition is in a better grade, e.g. a grade A is better than a grade B. Certainly, a system or a user can specify that B is better than A, etc.

For example, a subdivision solution for a vehicle condition with 2 grade: for example, the vehicle condition information can be sequentially represented by data in A/B, or 1/2, or superior/inferior, or upper/lower, or I/II and other combinations.

For example, a subdivision solution for a vehicle condition with 3 grade: for example, the vehicle condition information can be sequentially represented by data in AB/C, or 1/2/3, or superior/ordinary/inferior, or upper/medium/lower, or I/II/III or green/yellow/red colors or 3 different acoustical signals and other combinations.

Subdivision solutions of the condition information 1 with a grade number of 2 or 3 or other values can be considered as variant solutions of a reference solution of the condition information 1. For example, with respect to the joint operation value of a certain measurement and calculation object (such as an efficiency coefficient), a second range (i.e., a power transmission condition identification range) can be set in N different ranges (N>1), and then (N+1) different grades can be obtained, e.g., in the subdivision solution with the grade number of 2, A/1/superior/upper/I can be used for representing normal, and correspondingly, B/2/inferior/lower/II can be used for representing abnormal; e.g., in the subdivision solution with the grade number of 3, A or B can be used for representing normal (correspondingly C is used for representing abnormal), and A can be used for representing normal (correspondingly B and C are used for representing abnormal); e.g., when the power transmission condition of the vehicle is normal (no abnormality or fault), the subdivision solution with the grade number of 2 or 3 above can indicate how excellent the health condition of the vehicle is (at which health grade); and when the power transmission condition of the vehicle is abnormal, the subdivision solution with the grade number of 2 or 3 above can characterize an abnormality degree of the health condition of the vehicle (i.e., at which abnormality grade), that is, how serious the fault is?

Condition information 2: acquisition of multiple types of identification data of a measurement and calculation object refers to output and/or storage of data including related identification data of the measurement and calculation object and a joint operation value of the measurement and calculation object at least. Apparently, output and/or storage of two or more pieces of data naturally refers to output and/or storage of the data into the same space and/or the same system, and the data itself is the condition information. For example, as shown in embodiment 38 in the present invention, if a joint operation value f_cal of a rolling resistance coefficient and power transmission condition identification data (a calibration value f and/or an upper limit value S_ref1 and/or a lower limit value S_ref2) are displayed on the left and right in parallel, when parameter values on the left and right are close to one another, it naturally indicates that the current power transmission condition is good, and when the parameter values on the left and right have great differences, it naturally indicates that the current power transmission condition is poor. The condition information 2 can be understood as pre-processing data, that is, the data is not compared with reference data of the measurement and calculation object, and a user further judges whether the condition is normal and performs further grading. The solution contributes to manually and intuitively identifying the vehicle conditions in hearing and seeing manners.

A ratio obtained based on data including related identification data of the measurement and calculation object and the joint operation value of the measurement and calculation object at least is also condition information, and the condition information can be considered as a transformation of the condition information 2. The ratio is preferably a percentage, and can be described by a numerical value and graphic information such as a progress bar, a cursor pattern and the like.

When the measurement and calculation object is any one parameter of unmeasurable parameters and/or system intrinsic parameters, in an example 1 for identifying the condition information of the vehicle based on the joint operation value and reference data of the measurement and calculation object: a first preferable object of the measurement and calculation object is an efficiency coefficient (particularly efficiency of a to-be-monitored power transmission component), e.g., a range 1 of the reference data of the measurement and calculation object is a range of more than or equal to 95%, a range 2 of the reference data of the measurement and calculation object is a range of less than 95% and more than 90%, and a range 3 of the reference data of the measurement and calculation object is a range of less than or equal to 90%. When the efficiency coefficient is within the range 1 of the reference data, the vehicle condition is set as a grade represented by A or 1 or superior or upper; when the efficiency coefficient is within the range 2 of the reference data, the vehicle condition is set as a grade represented by B or 2 or ordinary or medium; and when the efficiency coefficient is within the range 3 of the reference data, the vehicle condition is set as a grade represented by C or 3 or inferior or lower. A second preferable object of the measurement and calculation object is a rolling resistance coefficient f, particularly a rolling resistance coefficient component fc related to the vehicle. For example, a range 1 of the reference data of the measurement and calculation object is a range of less than or equal to 0.01, a range 2 of the reference data of the measurement and calculation object is a range of less than 0.015 and more than 0.01, and a range 3 of the reference data of the measurement and calculation object is a range of more than or equal to 0.015. When fc is within in the range 1 of the reference data, the vehicle condition is set as a grade represented by A or 1 or superior or upper; when fc is within in the range 2 of the reference data, the vehicle condition is set as a grade represented by B or 2 or ordinary or medium; and when fc is within in the range 3 of the reference data, the vehicle condition is set as a grade represented by C or 3 or inferior or lower.

When the measurement and calculation object is any one parameter of the vehicle operation parameters except the unmeasurable parameters and/or the system intrinsic parameters, the condition information of the vehicle is identified, as shown in examples 2 and 3 for identifying the condition information of the vehicle below:

Example 2 for identifying the condition information of the vehicle:

When the measurement and calculation object is gross vehicle mass m2, a joint operation value m2_cal of the gross vehicle mass m2 in the same time period and an actual value m2_org serving as reference data are acquired, a range 1 of the reference data of the measurement and calculation object is a range of less than or equal to 100 KG, a range 2 of the reference data of the measurement and calculation object is a range of less than 200 KG and more than 100 KG, and a range 3 of the reference data of the measurement and calculation object is a range of more than or equal to 200 KG When an absolute value (m2_cal−m2_org|) of a difference value between the joint operation value (m2_cal) of the measurement and calculation object and the reference data (m2_org) of the measurement and calculation object is within the range 1 of the reference data, the vehicle condition is set as a grade represented by A or 1 or superior or upper; when the absolute value (m2_cal−m2_org|) of the difference value between the joint operation value (m2_cal) of the measurement and calculation object and the reference data (m2_org) of the measurement and calculation object is within the range 2 of the reference data, the vehicle condition is set as a grade represented by B or 2 or ordinary or medium; and when the absolute value (m2_cal−m2_org|) of the difference value between the joint operation value (m2_cal) of the measurement and calculation object and the reference data (m2_org) of the measurement and calculation object is within the range 3 of the reference data, the vehicle condition is set as a grade represented by C or 3 or inferior or lower.

Example 3 for identifying the condition information of the vehicle: when the measurement and calculation object is motor torque T in the source power parameters, a joint operation value T_cal of the motor torque T in the same time period and an actual value T_org serving as reference data acquired in a measured manner are acquired, a range 1 of the reference data of the measurement and calculation object is a range of less than or equal to 20 N.M, a range 2 of the reference data of the measurement and calculation object is a range of less than 50 N.M and more than 20 N.M, and a range 3 of the reference data of the measurement and calculation object is a range of more than or equal to 50 N.M. When an absolute value (T_cal−T_org|) of a difference value between the joint operation value (T_cal) of the measurement and calculation object and the reference data (T_org) of the measurement and calculation object is within the range 1 of the reference data, the vehicle condition is set as a grade represented by A or 1 or superior or upper; when the absolute value (T_cal−T_org|) of the difference value between the joint operation value (T_cal) of the measurement and calculation object and the reference data (T_org) of the measurement and calculation object is within the range 2 of the reference data, the vehicle condition is set as a grade represented by B or 2 or ordinary or medium; and when the absolute value (T_cal−T_org|) of the difference value between the joint operation value (T_cal) of the measurement and calculation object and the reference data (T_org) of the measurement and calculation object is within the range 3 of the reference data, the vehicle condition is set as a grade represented by C or 3 or inferior or lower.

In a similar way, by referring to the examples 2 and 3 for identifying the condition information of the vehicle above, any other parameter of parameters to be measured and/or measurable parameters and/or vehicle mass and/or source power parameters and/or mechanical operation parameters and/or mass change type object mass can serve as the measurement and calculation object (e.g., longitudinal velocity or a longitudinal acceleration is taken as the measurement and calculation object), and the condition information of the vehicle is set.

When the measurement and calculation object is any one parameter of the unmeasurable parameters and/or the system intrinsic parameters, a calibration value of the measurement and calculation object can serve as reference data. By referring to the examples 2 and 3 for identifying the condition information of the vehicle above, the condition information of the vehicle is set.

In a solution B1 of a method (#2) or a system (#2), setting of the reference data and input parameters can be correlated with one another, and the following principles can be used: at least one preset value is taken in the reference data and the input parameters of the measurement and calculation object, and a number of parameters with preset values in the input parameters is determined. Except the parameters with the preset values in the reference data and input parameters of the measurement and calculation object, other parameters refer to actual values.

The preset values include calibration values or historical record values in the same state of a current vehicle operation state. The historical record values in the same state of the current vehicle operation state refer to that a difference degree between vehicle operation conditions during selection of the historical record values and the current vehicle operation condition is lower than a threshold value.

For example, in embodiment 1 of the measurement and calculation method (#1), reference data of R1, im and kekm serve as the preset values, and all other parameters such as m2, a2, a1, Te2 and Te1 are actual values; in embodiment 2 of the measurement and calculation method (#1), reference data of Ke, Km, R1, im, g and f are the preset values, and all other parameters such as Te3, fw, m2, θ and a are the actual values; and in embodiment 41, Ke, Km1, im1, R1_1, Km2, Kf3, R0, im2 and R1_2 are the preset values, and reference data of all other parameters such as Te, F1, fw and m2 are the actual values.

Situation 1: when only one of the reference data and the input parameters of the measurement and calculation object is taken as the preset value:

For example, if the reference data of the measurement and calculation object is the preset value, all the input parameters are the actual values; when the measurement and calculation object is a parameter capable of describing attributes of a certain component in the vehicle, the power transmission condition of the vehicle can specifically represent conditions of the component, e.g. in a joint operation formula of kem in embodiment 9, when reference data of Kem is the preset value and all the input parameters are the actual values, whether the part (such as a transmission component) described by kem is abnormal can be monitored. In embodiment 1, when the reference data of m2 is a preset value (obtained by self-learning) and all the input parameters are the actual values, conditions of a part described by m2 (e.g. whether the vehicle body is complete or whether carried goods drop or not) can be monitored. In embodiment 11, when the reference data of μ1 is a preset value and all the input parameters are the actual values, conditions of a part represented by μ1 (whether the tire has sudden gas leakage) can be monitored.

For example, the reference data of the measurement and calculation object is the actual value, one of the input parameters is the preset value, and the preset value is used for monitoring whether parameter with the preset value in the input parameters is abnormal. It should be understood that, when the input parameter with the preset value is a parameter capable of describing attributes of a certain component of the vehicle, the power transmission condition of the vehicle can specifically represent the conditions of the component. By taking embodiment 2 as an example for describing, when the reference data of m2 is an actual value, μ1 is a preset value, while the other parameters are the actual values, then whether μ1 is abnormal can be monitored. If the reference data of m2 is a preset value, ki is a preset value, while the other parameters are the actual values, then whether ki is abnormal can be monitored.

Situation 2: when N preset values exist in the reference data and the input parameters of the measurement and calculation object, N≧2:

The reference data of the measurement and calculation object is taken as the preset value, (N−1) preset values exist in the input parameters, and the preset values are used for monitoring whether the parameters with the preset values in the input parameters of the measurement and calculation object are abnormal. Continuously taking embodiment 2 as an example for describing, when the reference data of m2 is a preset value, μ1 in the input parameters is a preset value, while the other parameters are the actual values, then whether the m2 and μ1 are abnormal can be monitored; and when the reference data of m2 is the preset value, μ1 and ki in the input parameters are the preset values, while the other parameters are the actual values, then whether the m2, μ1 and ki are abnormal can be monitored.

For example, the reference data of the measurement and calculation object is the actual value, N preset values exist in the input parameters and are used for monitoring whether the parameters with the preset values in the input parameters are abnormal. For example, in embodiment 8, when the reference data of Te is an actual value, m2, μ1, im and R1 in the input parameters are preset values, while the other input parameters are the actual values, then whether m2, im and R1 are abnormal can be monitored; and when the reference data of Te is the actual value, m2, μ1, im, θ and R1 in the input parameters are the preset values, while the other input parameters are the actual values, then whether m2, im, θ and R1 are abnormal can be monitored.

It should be understood that, other conditions about correlations between numbers of the preset values and actual values in the reference data and the input parameters and corresponding specific purposes can be handled by those skilled in the art on the basis of the descriptions and specific embodiments above, and unnecessary details are avoided herein.

Further, in the solution B1 of the method (#2) or the system (#2) above, identification of the power transmission conditions of the vehicle refers to judging whether the power transmission conditions of the vehicle are abnormal, that is, an extended solution 1 of the solution B1 is as follows: whether the power transmission conditions of the vehicle are abnormal is judged based on the data including the reference data of the measurement and calculation object and the joint operation value of the measurement and calculation object. In the present invention, the abnormality of the power transmission conditions can be called power transmission abnormality for short.

Operation of the vehicle is essentially an energy and power transmission process; when the vehicle is driven to operate by a power unit, energy is transferred from an energy supply unit (such as a fuel tank or a power supply) to the power unit (i.e., a fuel engine or a motor) and converted into power and is transferred step by step by virtue of a mechanical transmission system so as to further drive the vehicle to move; the energy supply unit and the power unit of the vehicle represent suppliers of the power, and source power parameters of the vehicle represent supply information of the power; the mechanical transmission system represents a transferring body of the power, and the driven wheel (along with loaded personnel and goods) may represent a receptor of the power; and vehicle mass represents the most basic attribute of the power receptor, system operation parameters of the vehicle represent basic conditions of the power transmission (i.e., the system intrinsic parameters) as well as motion results of the vehicle generated under the action of the power, that is, mechanical operation parameters (such as longitudinal velocity, a longitudinal acceleration, etc.).

If the power transmission conditions are abnormal (if abnormal loss of the energy (or power) is increased): assuming that a monitoring system takes the source power parameters as measurement and calculation objects, when other conditions (such as gradient, velocity, acceleration, etc.) are invariable, a deviation value of the source power parameters (actual values and joint operation values obtained by vehicle motion balance calculation) is increased because more energy or power needs to be consumed; assuming that the longitudinal velocity serves as a measurement and calculation object, when the other conditions (such as the gradient, the velocity, the acceleration, etc.) are invariable, a deviation value of the longitudinal velocity (the actual value and the joint operation value) of the vehicle may be increased; and assuming that the vehicle mass serves as a measurement and calculation object, when the other conditions (such as the gradient, the velocity, the acceleration, etc.) are invariable, a joint operation value of the vehicle mass may be changed. Therefore, by comparing the joint operation value of the measurement and calculation object with reference data, whether the power transmission conditions during vehicle operation are abnormal can be judged.

Identification manner 1: by taking an efficiency coefficient or a parameter including the efficiency coefficient or a rolling resistance coefficient (particularly fc therein) or a parameter including the rolling resistance coefficient as a measurement and calculation object, a second range used for power transmission condition identification of the measurement and calculation object is established (generally preset), a calculation result (i.e., a joint operation value) of the measurement and calculation object is obtained based on a longitudinal dynamic model of the vehicle, and whether the calculation result is out of the second range is compared. If the calculation result is out of the second range, the power transmission is abnormal.

Identification manner 2: or a measurement and calculation object is calculated based on the longitudinal dynamic model of the vehicle, and an efficiency coefficient and/or a rolling resistance coefficient are (is) included in the calculated input parameters. The calculation result of the measurement and calculation object obtained based on the longitudinal dynamic model of the vehicle is compared with the second range used for power transmission condition identification, and whether the calculation result is out of the second range is compared. If the calculation result is out of the second range, the power transmission is abnormal.

In the present invention, the power transmission abnormality includes any one or more conditions in the following 1A1 and 1A2:

1A1. A difference value between a joint operation value of the measurement and calculation object and a reference value is out of a first permissive range (i.e., a power transmission condition identification difference value, or a first deviation value, or a permissive deviation range); when the measurement and calculation object is any one parameter in parameters to be measured and/or source power parameters and/or mechanical operation parameters and/or mass change type object mass and/or vehicle mass, the reference value is an actual value; and when the measurement and calculation object is any one parameter in unmeasurable parameters and/or system intrinsic parameters, the reference value is an actual value or a calibration value.

1A2. The joint operation value of the measurement and calculation object is out of a second permissive range (i.e., a power transmission condition identification value, or a power transmission condition identification range).

The second permissive range is also a range used for identification of the power transmission conditions. The second permissive range is a range used for analyzing and identifying operation conditions of a system related to power transmission in the vehicle, is set according to the reference value of the measurement and calculation object, needs to be close to the reference value as much as possible so as to improve the monitoring sensitivity, but needs to keep an appropriate difference value from the reference value so as to reduce an error trigger rate of monitoring. The difference value of some numbers is the first permissive range. If a power transmission condition identification upper limit value is set to be 1.2-1.5 times that of the reference value, or a power transmission condition identification lower limit value is set to be 0.7-0.9 time that of the reference value, etc., the second permissive range is equal to the reference value and the first permissive range.

According to actual technical solutions and effects, the solution 1A1 is equal to the solution 1A2, and only expression manners of the two solutions are different. In a similar way, the solution 1A1 is transformed so as to obtain the solution 1A2: the second permissive range is set according to the joint operation value, the reference value of the measurement and calculation object is compared and judged with the second permissive range for identifying the power transmission conditions, and the solution is feasible, i.e., the second permissive range is equal to the joint operation value and the first permissive range.

The situation 1A1 includes the following situations of 1A11 and/or 1A12: 1A11: A difference value between the joint operation value and the reference value of the measurement and calculation object is greater than a first permissive upper limit value; and 1A12: The joint operation value and the reference value of the measurement and calculation object is smaller than a first permissive lower limit value.

The 1A12 condition includes the following situations of 1A21 and/or 1A22: 1A21: The joint operation value of the measurement and calculation object is greater than the second permissive upper limit value; and 1A22: The joint operation value of the measurement and calculation object is smaller than the second permissive lower limit value.

Preferably, the second permissive range of the measurement and calculation object (i.e., a power transmission condition identification value) is within a safety range of the measurement and calculation object (i.e., a safety limit threshold value); the limitation that safety monitoring is inconvenient to be performed when vehicle operation parameters do not exceed the safety limit threshold value in the prior art can be broken, and see in examples 1 and 2 for details. The contents in this part refer to preferable rules for setting a range of the reference data.

### EXAMPLE 1

if longitudinal velocity (unit: KM/H) of the vehicle is taken as a measurement and calculation object, assuming that the (upper limit) safety limit threshold value is 200 (the value is a maximum value in the safety limit threshold value; and a minimum value in the safety limit threshold value of the parameter is generally 0); assuming that the vehicle is operated at the longitudinal velocity of 60, an actual value is generally set as 60, and then the power transmission condition identification difference value is generally set between 10 and 20, the power transmission condition identification upper limit value is generally set between 70 and 80, and the power transmission condition identification lower limit value is generally set between 40 and 50; then as long as a joint operation value of a longitudinal operation speed of the vehicle is greater than the power transmission condition identification upper limit value or smaller than the power transmission condition identification lower limit value, the power transmission condition result is judged to be abnormal, and then monitoring protection can be realized. Therefore, the measurement and calculation object is far less than the safety limit threshold value (far less than the maximum value of 200 in the safety limit threshold value and far higher than the minimum value of 0 in the safety limit threshold value).

In the present invention, as shown in demonstration methods 4 and 5 for setting the reference data, the source power parameters, mechanical operation parameters and mass change type object mass have the same characteristic type (all belonging to measurement and calculation objects of which amplitudes may be greatly changed), and when the measurement and calculation object is any one parameter of the source power parameters and the mass change type object mass, a range setting method for the reference data in the example 1 above can be referred.

### EXAMPLE 2

if vehicle carrying mass (i.e., carried goods mass) is taken as a measurement and calculation object, assuming that the upper safety limit threshold value is a limited load of 7 persons/560 KG (apparently, the value is a maximum value in the safety limit threshold value, and a minimum value in the safety limit threshold value of the parameter is generally 0); assuming that the vehicle is operated at an actual load of 4 persons/320 KG, an actual value is generally set as 320 KG, the power transmission condition identification difference value (i.e., the first permissive range) is generally set between 80 KG and 160 KG the power transmission condition identification upper limit value is generally set as 480 KG, and the power transmission condition identification lower limit value is generally set as 160 KG; as long as a joint operation value of the vehicle carrying mass is greater than the power transmission condition identification upper limit value or smaller than the power transmission condition identification lower limit value, the power transmission condition result is judged to be abnormal, and then monitoring protection can be realized. Therefore, the measurement and calculation object is far less than the safety limit threshold value (apparently, i.e., the power transmission condition identification upper limit value of the measurement and calculation object is far lower than the maximum value of 560 KG in the safety limit threshold value then, and the power transmission condition identification lower limit value is far higher than the minimum value (0 KG) in the safety limit threshold value).

In the existing well-known technical solution, only when the joint operation value of the vehicle carrying mass (i.e., carried goods mass) is higher than the maximum value (560 KG) in the safety limit threshold value or is lower than the minimum value (0 KG) in the safety limit threshold value, a response is made; (even if three of the four persons in the vehicle crash or a tail carriage of a high-speed rail train is split) a wrong judgment that the safety condition is normal is made.

When the measurement and calculation object is gross vehicle mass (naturally including a value of the carried goods mass due to the value of the gross vehicle mass) and when the measurement and calculation object is the system intrinsic parameter, because the gross vehicle mass has another common characteristic with the vehicle mass (value change is small in an operation process at that time), a range setting method for the reference data in the example 2 above can be adopted:

Based on the extended solution 1 of the solution B1 above (judging whether the power transmission conditions of the vehicle are abnormal based on the data including the reference data of the measurement and calculation object and the joint operation value of the measurement and calculation object at least), the extended solution 1 can further include the following step: starting a set power transmission abnormality processing mechanism when the judgment result is that the power transmission conditions are abnormal.

The power transmission abnormality processing mechanism in the present invention includes, but not limited to, voice or audible and visual warning, selective execution of protection actions based on current operation conditions of the vehicle, activation of a power transmission fault monitoring mechanism, output of warning information, deceleration stop, emergency stop, etc.; and a machine system and manpower can be combined arbitrarily to set various safety processing mechanisms. The power transmission abnormality processing mechanism in the present invention can also be called the safety processing mechanism for short. The warning information in the present invention may include, but not limited to, time, location, warning reasons, a value of any one or more vehicle operation parameters at the time of warning, etc.; the selective execution of protection actions based on current operation conditions of the vehicle in the present invention refers to checking whether the reference data are set correctly first and then deciding whether to protect and the like.

The output in the present invention includes outputting the data to the in-vehicle man-machine interaction interfaces, the network systems, connection ports, external control systems, the mobile phone APP systems, etc., the man-computer interaction interfaces include displays, voice systems, indicator lights, etc.; the connection ports are available for the external man-machine interaction interfaces and the network systems to read the data directly or in a way of communication, so that the vehicle operation-related personnel or mechanisms (such as drivers and passengers, operation management parties, traffic polices and fault diagnosis centers) can directly or indirectly view, listen to and monitor the data.

The storage in the present invention includes storing the data in a storage module in the monitoring system, an in-vehicle storage system, the network systems, the external control systems, the mobile phone APP systems, etc., so that the vehicle operation-related personnel or mechanisms (such as the drivers and the passengers, the operation management parties, the traffic polices and the fault diagnosis centers) can take and monitor the data arbitrarily; and the in-vehicle storage module includes U disks, hard disks, etc., and can form a function similar to an aircraft black box for facilitating postmortem analysis.

Embodiment 34: When setting conditions (e.g., when the vehicle enters set time (such as 1.0 second or 5 seconds) in the power unit-controlled operation process) of the reference data are satisfied, an actual value (a reference value m1_ref) is automatically set according to the joint operation value m1 of the vehicle mass calculated in the previous step A, e.g., m1_ref=m1; then the power transmission condition identification difference value (also called an error threshold value m1_gate) is set, e.g., m1_gate=m1_ref/4; and if |m1−m1_ref|>m1_gate, the set safety processing mechanism is started, e.g., voice prompt warning. The formula of (|m1−m1_ref|>m1_gate) can also be transformed into two formulas including (m1>m1_ref(1+¼)) and (m1<m1_ref(1−¼)).

Specific note 3: the power transmission condition identification difference value in the present invention can also be called the error threshold value or the threshold value.

The power transmission condition identification upper limit value of the vehicle mass in the present invention can also be called a reference value m1_ref1; and the power transmission condition identification lower limit value of the vehicle mass in the present invention can also be called a reference value m1_ref2.

When the Chinese “reference value” is followed by an “English label” and then is suffixed by “_ref” in the present invention, the meaning of the statement is the reference value of the measurement and calculation object; for example, the reference values “m1_ref” and “m1_ref” are equivalent and both represent the reference value of the measurement and calculation object (m1).

When the Chinese “reference value” is followed by an “English label” and then is suffixed by “_ref1”, the meaning of the statement is a second permission upper limit value of the measurement and calculation object; for example, the reference values “m1_ref1” and “m1_ref1” are equivalent and both represent the second permission upper limit value of the measurement and calculation object (m1); for example, the reference values “m2_ref1” and “m2_ref1” are equivalent and both represent the second permission upper limit value of the measurement and calculation object (m2); and for example, the reference values “S_ref1” and “S_ref1” are equivalent and both represent the second permission upper limit value of the measurement and calculation object (f).

When the Chinese “reference value” is followed by an “English label” and then is suffixed by “_ref2”, the meaning of the statement is the power transmission condition identification lower limit value (i.e., a second permission lower limit value) of the measurement and calculation object; for example, the reference values “m1_ref2” and “m1_ref2” are equivalent and both represent the second permission lower limit value of the measurement and calculation object (m1); for example, the reference values “m2_ref2” and “m2_ref2” are equivalent and both represent the second permission lower limit value of the measurement and calculation object (m2); and for example, the reference values “S_ref2” and “S_ref2” are equivalent and both represent the second permission lower limit value of the measurement and calculation object (f).

In the present invention, the joint operation value of the carried goods mass can be expressed by m1, while the actual value can be expressed by m1_org or m1_ref; and the joint operation value of the gross vehicle mass can be expressed by m2, while the actual value can be expressed by m2_org.

Embodiment 35: the relevant state information is automatically set when a period of time in the “vehicle controlled to operate by the power unit” state is entered every time: “the power transmission condition identification upper limit value (the reference value m1_ref1) and the power transmission condition identification lower limit value (the reference value m1_ref2) are not set”.

When the setting conditions of the reference data are satisfied, e.g., the moment of entering the set time (such as 2.0 seconds) for reaching the “vehicle controlled to operate by the power unit” state, the power transmission condition identification value is set according to the joint operation value m1 of the vehicle mass. In order to facilitate understanding, the value m1 of the vehicle mass serving as a basis for setting the power transmission condition identification value is described as m1_org, for example, m1_ref1=m1_org*1.2, and the state information is automatically set as follows: “m1_ref1 has been set”; and for example, m1_ref2=m1_org−Δ2, Δ2=30 KG, and the state information is automatically set as follows: “m1_ref2 has been set”.

When the state information is “m1_ref1 has been set”, whether (m1>m1_ref1) is true is judged; if (m1>m1_ref1) is true, the set safety processing mechanism is started; for example, the audible and visual warning is performed, the warning information is outputted to the network systems, etc.; and when the state information is “m1_ref2 has been set”, whether (m1<m1_ref2) is true is judged; if (m1<m1_ref2) is true, the set safety processing mechanism is started; for example, the audible and visual warning is performed, the warning information is outputted to the network systems, etc.

Alternative solution 1 for embodiment 35: m1_ref2=m1_org/1.5 can be set.

Alternative solution 3 for embodiment 35: the setting conditions of the reference data can be replaced by any one of the following solutions A, B, C and D:

A, if the drivers and the passengers subjectively determine that the joint operation value of the current vehicle mass is suitable for setting the reference data (also called a reference), a “confirmation” signal can be inputted manually;

B, when the vehicle is operated to the set longitudinal speed (e.g., 5 KM/hour);

C, when the motor driving device is operated to the set frequency (e.g., 5 HZ);

D, on the basis of the above conditions, along with a vehicle door opening/closing triggering signal, as long as a door opening/closing action of the vehicle is not generated, the power transmission condition identification data can remain unchanged; and some power transmission condition identification data can be shared in periods of time for a plurality of independent power units to control operation as long as the door opening/closing action is not generated.

Alternative solution 4 for embodiment 35: the power transmission condition identification data in the embodiment 35 can be adjusted manually by the user or automatically by the system; certainly, the vehicle is not allowed to unload cargos or pick up/drop off passengers (even jump) during operation in normal conditions; and such conditions can be included in the monitoring range by the monitoring system and can trigger the corresponding safety processing mechanism.

Embodiment 36: When the measurement and calculation object is the electromechanical transmission integrated efficiency coefficient,

Mode 1: the joint operation value Kem_cal of the electromechanical transmission integrated efficiency coefficient acquired in step A is set as the actual value, i.e., the calibration value (i.e., the reference value Kem_ref); and the power transmission condition identification difference value (i.e., the error threshold value) Kem_gate can be set according to the system default value; for example, the system automatically sets a fixed error threshold value: Kem_gate=0.2.

Mode 2: the calibration value (the reference value Kem_ref) certainly can also be set according to the preset value (the mesosystem default value), or the power transmission condition identification difference value is set according to the joint operation value Kem_cal of the electromechanical transmission integrated efficiency coefficient acquired in step A; for example, Kem_gate=Kem_cal/5.

If |Kem_cal−Kem_ref|>Kem_gate, the set safety processing mechanism is started; for example, the voice prompt warning is sent into the network systems.

In a branch solution including the reference data setting mode 2 in the embodiment 36, the calculation formula of (Kem_cal−Kem_ref|>Kem_gate) can also be transformed into (Kem_ref>Kem_cal (1+⅕)) simply; the value of the calculation formula is the upper limit value set according to the joint operation value, i.e., it is judged that whether the calibration value is greater than the upper limit value set according to the joint operation value is true.

Embodiment 37: When the measurement and calculation object is the rolling resistance coefficient of the vehicle,

(Mode 1): the reference value μ1_ref is set for the joint operation value μ1_cal of the rolling resistance coefficient acquired in step A; and the power transmission condition identification difference value μ1_gate can be set according to the system default value; for example, μ1_gate=0.2.

(Mode 2): the reference value μ1_ref certainly can also be set according to the system default value (i.e., the calibration value), or the power transmission condition identification difference value is set according to the joint operation value μ1_cal of the rolling resistance coefficient acquired in step A; for example, ∥1_gate=μ1_cal/4.

If |μ1_cal−μ1_ref|>μ1_gate, the set safety processing mechanism is started; for example, the voice prompt warning is sent into the network systems.

Embodiment 38: The rolling resistance coefficient of the vehicle is used as the measurement and calculation object;

Step A: the joint operation value f_cal of the rolling resistance coefficient of the vehicle is acquired; the power transmission condition identification upper limit value (S_ref1) is set as follows: S_ref1=f+Δ1, based on a system set value (i.e., the calibration value) of the measurement and calculation object; the power transmission condition identification lower limit value (S_ref2) is set as follows: S_ref2=f*0.8; and the f, the deviation value Δ1 and the product coefficient 0.8 are the preset values (the mesosystem default values).

Step B: If (f_cal>S_ref1) and/or (f_cal<S_ref2), the set safety processing mechanism is started; for example, the voice prompt warning is sent into the network systems.

Embodiment 39: Step A includes: the joint operation value m2 of the vehicle mass is acquired; for example, the own mass of an unmanned automatic vehicle is 1200 KG; for example, the power transmission condition identification upper limit value (i.e., m2_ref1) preset by the system is m2_ref1=1500 KG; and for example, the power transmission condition identification lower limit value (i.e., m2_ref2) preset by the system is m2_ref2=800 KG;

whether (m2>m2_ref1) and/or (m2<m2_ref2) is true is judged; if so, the set safety processing mechanism is started; for example, the warning information is outputted into the network systems.

Embodiment 40: The electromechanical combined parameter fq is used as the measurement and calculation object; the calculation formula of fq is fq=(Ke*Km)*(Te*im/R); and the actual value of fq is acquired based on a measured value.

Step A: the joint operation value fq_cal of the electromechanical combined parameter of the vehicle is acquired; the power transmission condition identification upper limit value S_ref1 is set as follows: S_ref1=fq*1.2; and for example, the power transmission condition identification lower limit value S_ref2 is set as follows: S_ref2=fq*0.7.

Step B: if (fq_cal>S_ref1) and/or (fq_cal<S_ref2), the set safety processing mechanism is started; for example, the voice prompt warning is sent into the network systems.

In general, the joint operation value, the actual value or the calibration value, the reference data, etc. of the measurement and calculation object in the present invention refer to amplitudes/magnitudes of the parameters in absence of limited description and/or additional description; and certainly, the measurement and calculation object itself can also be time parameters, such as response time, parameter variation rate and the like.

When the power unit of the vehicle includes the fuel engine and the vehicle is controlled to operate by the fuel engine, alternative implementation solutions for the foregoing embodiment 1 to the embodiment 40 are as follows:

An alternative solution 1 for the fuel power: in the foregoing embodiments 1, 3, 5, 6, 7, 8, 9, 11, 13, 17, 18, 21, 22, 24, 25, 28, 29, 31, 32 and 33, if the calculation formula contains Kem, Kem is split into Ke*Km; the operation for the efficiency coefficient Km of the mechanical transmission system can remain unchanged; the operation for the electromagnetic torque Te and the motor efficiency coefficient Ke is replaced by the operation for the fuel power parameter of the corresponding front end and the efficiency coefficient or the conversion coefficient Kfa of the corresponding fuel power system; and the driving torque Tr1 of the fuel engine can be calculated through the fuel power parameter and Kfa (refer to contents of Section 4.2.2.3 in the first part of the present invention for the specific acquisition of the fuel power parameters and the calculation modes of Tr1).

For example, the expression ((Ke*Km)*(Te*im/R)) in the embodiment 1 is replaced by (Km*Tr2*Kf6*im/R1), and then is replaced by (Km*F1*Kf3*R0*im/R1), which indicates that the cylinder pressure F1 in the engine is used as the source power parameter to calculate the joint operation value of the vehicle mass; and the formula can be sorted as: m2=(Km*F1*Kf3*R0*im/R1)/(g*μl) (Formula R-A1-1) according to the alternative solution.

For example, the expression ((Ke*Km)*(Te*im/R)) in the embodiment 11 is replaced by (Km*Tr2*Kf6*im/R1), which indicates that the load report data (the torque value) Tr2 of the engine is used as the source power parameter to calculate the joint operation value of the vehicle mass; and the formula can be sorted as: m2=((Km*Tr2*Kf6*im/R1)−fw)/(g*f*cos θ+g*sin θ+a) according to this alternative solution.

Alternative solution 2 for the fuel power: in the embodiment 4 or the embodiment 10, if the calculation formula includes Kem, Kem is split into Ke*Km; the operation for the efficiency coefficient Km of the mechanical transmission system can remain unchanged; the operation for the electric power Pm in the motor driving parameter and the efficiency coefficients (such as Ke, k13, k14, etc.) of the related electric power system is replaced by the operation for the fuel power parameter of the corresponding front end and the efficiency coefficient or the conversion coefficient Kfa of the corresponding fuel power system; and the driving power Pr1 of the fuel engine can be calculated through the fuel power parameter of the front end and Kfa (refer to contents of Section 4.2.2.3 in the first part of the present invention for the specific acquisition/calculation mode of Pr1).

For example, in the embodiment 10, when the power unit operation condition is the power unit driving state, in the expression ((Kem*(|k12*cos φ*Uo*Io|))=(Kem*k12*cos φ*Uo*Io), (Kem*k12*cos φ*Uo*Io) is replaced by (Km*Pr1) and then is replaced by (Km*fm1*Kf1), which indicates that the fuel consumption rate fm1 in the engine is used as the source power parameter to calculate the joint operation value of the vehicle mass; and according to the alternative solution, the formula can be sorted as:

μ1_cal=((Km*fm1*Kf1)/V1)−m2*g*sin θ−m2*a−fw)/(m2*g*cos θ) (Formula A 13-1-2).

If fm1 is used as the source power parameter, the calculation can be stopped in the power unit braking state.

Alternative solution 3 for the fuel power: in the embodiments 12, 15, 16, 19, 20, 23, 26, 27 and 30, the operation for the motor driving parameters (such as Po, P2o, P2i, P3o, P3i, etc.) and the efficiency coefficients (such as Ke, k31, k21, etc.) of the related electric power system is replaced by the operation for the fuel power parameter of the corresponding front end and the corresponding efficiency coefficient or conversion coefficient Kfa; and the driving power Pr1 of the fuel engine can be calculated through the fuel power parameter of the front end and Kfa (refer to contents of Section 4.2.2.3 in the first part of the present invention for the specific acquisition/calculation mode of Pr1).

For example, in embodiment 12, the expression ((Ke*Km)*(P2o/Vₓ)) can be written as (Ke*Km*P2o/Vₓ); (Ke*Km*P2o) is replaced by (Km*Pr1) and then is replaced by(Km*fm2*Kf2), which indicates that the fuel consumption rate fm2 at the fuel input end of the fuel injection system is used as the source power parameter to calculate the joint operation value of the vehicle mass; and according to the alternative solution, the formula can be sorted as:

m2((Km*fm2*Kf2)/Vₓ)−fw)/(g*f*cos θ+g*sin θ+a).

If (Km*fm2*Kf2) is replaced by (Km*C1*Kf4), it indicates that the airflow C1 of the fuel engine is used as the source power parameter to calculate the joint operation value of the vehicle mass and can be used for gasoline-powered vehicles.

If (Km*fm2*Kf2) is replaced by (Km*Pr2*Kf5),it indicates that the load report data (the power value) Pr2 of the engine is used as the source power parameter to calculate the joint operation value of the vehicle mass.

According to the above alternative solutions 1, 2 and 3 for the fuel power, the joint operation value of the measurement and calculation object can be acquired when the vehicle is controlled to operate by the fuel engine; and further, by reference to the reference data setting solutions and the power transmission condition judgment solutions in the embodiment 34 to the embodiment 40, whether the power transmission condition of the vehicle is abnormal can be judged according to the acquired joint operation value and the reference data of the measurement and the calculation object, thereby realizing complete power transmission abnormality monitoring.

Embodiment 41: (The present embodiment is a preferred embodiment of the handling method provided by the present invention)

The handling method includes steps A, B and C.

The vehicle operation conditions are as follows: a default power unit operation condition is power unit driving operation; the vehicle is the hybrid power vehicle; the power unit includes the fuel engine and the motor; the fuel engine and the motor are operated simultaneously to drive the vehicle to operate; the electric power system drives the front wheels to operate; Te is the electromagnetic torque of the motor; im1 is the transmission ratio of the electric power system; R1_1 is a radius of the front wheels; Km1 is the efficiency coefficient of the mechanical transmission system of the electric power system; the fuel power system drives the rear wheels to operate; F1 is the cylinder pressure in the engine; im2 is the transmission ratio of the fuel power system; R1_2 is a radius of the rear wheels; and Km2 is the efficiency coefficient of the mechanical transmission system of the fuel power system.

The handling method is start-on-boot; Step A: the step includes step A1, step A2 and step A3;

Step A1: the calculation formula of the gross vehicle mass m2 (direct joint operation value) is:

m2=(Ke*Km1*Te*im1/R1_1+Km2*F1*Kf3*R0*im2/R1_2−fw)/(g*f*cos θ+g*sin θ+a) (Formula 41-1);

m1=m2−m0=mf0 (Formula 41-2).

The source power parameters (Te and F1) and the system operation parameters (Ke, Km1, im1, R1_1, Km2, Kf3, R0, im2, R1_2, fw, g, f, θ, a, m0 and mf0) within the preset time range are acquired; the joint operation value of m2 is calculated according to the acquired parameter values and the longitudinal dynamic model of the vehicle (Formula 41-1); and then the joint operation value of m1 is calculated.

Step A2: Step A3 can be performed directly when the reference data is set; and when the reference data is not set, the following steps can be first performed to set the reference data:

When the vehicle operation speed reaches 5 KM/H for the first time, the joint operation value of m1 is acquired and set as the actual value m1_org; the power transmission condition identification upper limit difference value m1_def1 and the power transmission condition identification lower limit difference value m1_def2 are set according to historical record values calculated based on vehicle motion balance calculation; further, the power transmission condition identification upper limit difference value m1_ref1 and the power transmission condition identification lower limit difference value m1_ref2 can be set; m1_def1 and m1_def2 both are positive values; the state information that “the reference data is set” is set; and the reference formulas are as follows: m1_ref1=m1_org+m1_def1 and m1_ref2=m1_org−m1_def2.

Step A3: after the reference data is set, any one or more of the following four power transmission condition judgment conditions are performed: Condition 1: ((m1−m1_org)>m1_def1); Condition 2: ((m1−m1_org)<(−m1_def2)); Condition 3: (m1>m1_ref1); and Condition 4: (m1<m1_ref2).

Step B: when the reference data is not set or when the vehicle is in an unstable driving state (when Te is less than the preset threshold value 1 (e.g., 5% of the rated value) or F1 is less than the preset threshold value 1 (e.g., 10% of the rated value), and it can be judged that the vehicle is in the unstable driving state), the step C is performed directly; and in the present embodiment, the power unit braking state and the critical switching areas can be used as the unstable driving state.

When the reference data is set and the power unit operation conditions are not in the unstable driving state, the following steps B1 and B2 are performed in parallel, and then step C is performed.

B1. if the judgment result of any one of the four conditions in step A is yes, the power transmission abnormality processing mechanism (such as voice alarm) is started; and B2. the judgment result is outputted to the network systems and the in-vehicle man-machine interfaces.

Step C: Step A and Step B1 are circularly performed in real time in a cycle of 0.1 ms; step B2 is performed in a cycle of 1 second;

Alternative embodiment 1 for embodiment 41: when the vehicle is operated in a pure fuel engine driving state or a motor unstart state or in absence of the electric power system, Te=0 is set, substantially for canceling the calculation formula (Ke*Km1*Te*im1/R1_1); and when the vehicle is operated in a pure motor driving state or a fuel engine unstart state or in absence of the fuel power system, F1=0 is set, substantially for canceling the calculation formula (Km2*F1*Kf3*R0*im2/R1_2).

Alternative embodiment 2 for embodiment 41: when the calculation process of the joint operation value of the vehicle mass in step A (or setting of the reference data) is not performed within the monitoring system, the result of the joint operation value m1 (or the reference data) inputted from the external apparatus can be directly read to replace step A1.

Alternative embodiment 5 for embodiment 41: the power transmission condition identification upper limit difference value m1_def1 and the power transmission condition identification lower limit difference value m1_def2 are preset according to a fuzzy algorithm (e.g., the reference data at the latest operation time is selected automatically) in step A2; or:

In the handling method provided by the present invention, the preferred solution is that the values of all the parameters are acquired in real time, and steps A and B are performed in real time and are circularly performed at a set time cycle.

Power and energy are easily confused from a physical concept, but are completely different in meaning for the vehicle operation safety. The power is a differential of energy to time, and has the concept of instantaneous-high speed. The energy has the concept of time delay-low speed. Even if second is used as the unit and the energy consumed per second is used as the measurement and calculation object, when the vehicle is operated at a speed of 120 KM per hour, the vehicle is moved by 33 meters for 1 second, the distance of 33 meters is enough to cross a highway guardrail and is enough to fall into cliffs or rivers and lakes beside the highway. 1 second is enough to cause serious safety accidents. From the values and calculation accuracy of the vehicle operation parameters, the distance of 33 meters is also enough to cross a slope peak thereby changing upslope into downslope; the θ value is changed from positive to negative; the slope resistance component (m2*g*sin θ) is changed; and the source power parameters of the vehicle at the moment of upslope and downslope may be changed greatly. If the source power parameters at the moment of upslope are used for downslope monitoring, wrong judgment may be made. In a similar way, due to presence of the variable speed component (m2*a), it is insignificant to use the source power parameters before change of the longitudinal acceleration a value for the power transmission abnormality monitoring after change of the a value. Therefore, if the solutions provided by the present invention are used for the power transmission abnormality monitoring, it is better to use instantaneous value power source parameters (such as instantaneous power, instantaneous torque, instantaneous driving force, instantaneous current, etc.) for performing real-time power transmission abnormality monitoring; if the energy type source power combined parameters are used for performing the power transmission abnormality monitoring result, the energy accumulation time needs to be controlled as short as possible (such as 100 mm, 10 ms, 1 ms and 0.1 mm); and if total fuel consumption or electric energy or average power or other parameters of 100 KM are used, the instantaneous power transmission abnormality monitoring crucial to the vehicle safety operation will have no warning significance, and can only play a role of post-inspection and postmortem analysis.

If the energy type source power combined parameters are used as the measurement and calculation object for identification of the power transmission condition, the following embodiment 42 can be used as a reference:

Embodiment 42: The processing method includes steps A, B and C; and the processing method is started after receiving a manual command.

Step A: this step includes step A1, step A2 and step A3.

Step A1: the values of the parameters (m1, m0, mf0, g, μ1, θa, fw, V1, Km and Ke) within the same time range are acquired (read or measured) first (if the vehicle is a plug-in pure electric vehicle, mf0 can be set to zero or is cancelled directly); the joint operation value Pm_cal of the electric power of the motor is calculated according to the obtained values of the parameters; and the calculation formula is as follows:

m2=m1+m0+mf0, Pm_cal=(m2*g*μ1*cos θ+m2*g*sin θ+m2*a+fw)*V1/(Km*Ke).

Further, the joint operation value Pm_cal is subjected to integration operation to acquire the electric energy value EM1_cal within two seconds; and EM1_cal is an indirect joint operation value.

Step A2: when the values of Pm_cal and EM1_cal are acquired, the actual value of the electric power Pm_r is acquired (the data measured by the power control unit is read or measured by a power meter), and then the measured value EM2 of the electric energy within two seconds in the same period of EM1_cal is acquired through Pm_r integration operation, or the EM2 value is acquired through direct measurement by using an active meter; EM2 is used as the actual value of the reference data; the power transmission condition identification difference value EM_def3 is set as follows: EM_def3=EM2/10; the power transmission condition identification upper limit value EM_ref1 is set as follows: EM_ref1=EM2+EM_def3; and the power transmission condition identification lower limit value EM_ref2 is set as follows: EM_ref2=EM2−EM_def3.

Step A3: any one or more of the following four power transmission condition judgment conditions are performed: Condition 1: ((EM1_cal−EM2)>EM_def3), Condition 2: ((EM1_cal−EM2)<(−EM_def3)), Condition 3: (EM1_cal>EM_ref1), and Condition 4: (EM1_cal<EM_ref2).

Step B: If the judgment result of any one of the four conditions in step A3 is yes, the power transmission abnormality processing mechanism (such as voice alarm) is started.

Alternative solution 1 for embodiment 42: when the vehicle is a fuel-powered vehicle, the electric power of the motor can be replaced by the fuel consumption rate fm1 in the engine, the electric energy is replaced by the fuel energy, and Ke is replaced by Kf1; and the joint operation formula in embodiment 42 is rewritten as follows:

fm1_cal==(m2*g*μ1*cos θ+m2*g*sin θ+m2*a+fw)*V1/(Km*Kf1).

Further, the joint operation value fm1_cal is subjected to integral operation to acquire the fuel energy value EM1_cal within two seconds, so as to realize that the fuel energy is used for the power transmission abnormality monitoring.

The identification of the power transmission conditions allows the system to switch the measurement and calculation object as needed, even simultaneously enable multiple measurement and calculation objects to judge multiple power transmission conditions of multiple different measurement and calculation objects, and also allows to use the same measurement and calculation object for judging and monitoring the multiple power transmission conditions by using multiple source power parameters for simultaneously measuring and calculating multiple joint operation values of the same measurement and calculation object; for example, in a high-speed rail powered by an external power grid, the vehicle mass is used as the measurement and calculation object, and the electromagnetic torque Te of the motor is used as the source power parameter for constructing a power transmission condition judgment and monitoring #100 system, the system can monitor the motor and the rear-end mechanical transmission system; meanwhile, the electric power P3i inputted by the power supply as well as the electric power Pm and the efficiency coefficient k31 of the motor are used for verifying whether the power transmission conditions of the power unit and the motor driving device of the high-speed rail are normal; the verification method is to judge whether the calculation result of ((P3i*k31)−Pm) exceeds the preset threshold value (such as P3i/20); if so, the operation of the power unit or the motor driving device is abnormal.

For example, in the fuel-powered vehicle, the cylinder pressure F1 is used as the fuel power parameter for constructing a power transmission condition judgment and monitoring #102 system to monitor the piston of the fuel engine and the rear-end mechanical transmission system; meanwhile, whether the power transmission conditions of the fuel injection system and the combustion system in the engine cylinder are normal is judged according to the fuel consumption rate fm2 and the energy conversion coefficient Kf2 of the fuel input end of the fuel injection system; whether ((fm2*Kf2)−(F1*Kf3*R0*n1/9.55)) exceeds the preset threshold value (such as (F1*Kf3*R0*n1/9.55)/20) is judged; and if so, the fuel injection system or the combustion system in the engine cylinder is abnormal.

In general, on the basis of the processing method and system of the present invention, the power transmission condition identification (i.e., abnormality monitoring) is performed layer by layer or by multiple layers according to the power transmission principle of the vehicle, thereby facilitating the safety monitoring for the overall power system and/or the mechanical transmission system and/or the wheels of the vehicle, for all-round sensitive and accurate protection; and especially, the power transmission condition identification can be performed when the vehicle operation parameters do not exceed a safety limit threshold value.

In the electric vehicle powered by fuel cells, the fuel refers to the type of energy supply; and because the power unit for directly driving the vehicle to operate longitudinally is the motor, the vehicle is regarded as the electric power vehicle. If the source power parameters in the vehicle motion balance calculation are the motor driving parameters, the power transmission condition monitoring solution of the electric power vehicle can be adopted naturally; the fuel cells and the motor connected with the fuel cells can also be integrally regarded as the fuel power unit; and if the source power parameters involved in the vehicle motion balance calculation are directly used as the fuel-related parameters (such as the fuel consumption rate, the fuel consumption, etc.), the power transmission condition monitoring solution of the fuel-powered vehicle can also be adopted at the moment.

Embodiments 1 to 33 and the formulas 13.1 to 13.6 in the present invention are focused on providing an embodiment for measuring and calculating the joint operation value of the measurement and the calculation object based on the vehicle motion balance calculation in various conditions; and embodiments 34 to 42 in the present invention are focused on providing multiple reference data setting modes and embodiments for judging the power transmission conditions.

The present invention allows to use any one of the vehicle operation parameters as the measurement and calculation object, allows to use the transformation of any calculation formula in the present invention as a calculation mode of the joint operation value of a new measurement and calculation object, allows to acquire the joint operation value by reference to any acquisition of the joint operation value of the measurement and calculation object in the present invention, allows to acquire the reference data by reference to any one reference data setting mode of in the present invention, allows to judge by reference to any power transmission condition judgment mode in the present invention, allows to process by reference to any subsequent processing mode in the present invention, and can construct a new handling method arbitrarily.

For example, the longitudinal velocity Vx can be used as the measurement and calculation object, the transformation is performed and a new calculation mode Vₓ=(Ke*Km)*P2o/(m2*(g*f*cos θ+g*sin θ+a)+fw) is set by reference to the calculation formula (m2=((Ke*Km)*(P2o/Vₓ)−fw)/(g*f*cos θ+g*sin θ+a)) in embodiment 12; further, the measured value of the longitudinal velocity is used as the actual value by reference to other part of contents in the present application document; the reference data are further set; the power transmission condition is judged; and the judgment post-processing in Step B is further performed.

For example, the electromagnetic torque of the motor of the vehicle can be used as the measurement and calculation object, the joint operation value of the measurement and calculation object is acquired by reference to the calculation formula (Te_cal=(m2*(g*f*cos θ+g*sin θ+a)+fw)/((Ke*Km)*im/R)) in embodiment 28 and by reference to embodiment 41 or alternative embodiment thereof or extended embodiment thereof; further, the power transmission conditions are judged by reference to embodiment 40 or other parts of contents in the present application document according to the measured value Te of the electromagnetic torque serving as the actual value and the set reference data; the judgment post-processing in Step B is performed; for example, if the judgment result is yes, the set power transmission abnormality processing mechanism is started and/or the judgment result is stored and/or the judgment result is outputted.

For example, a formula of embodiment 28 is: Te_cal=(m2*(g*f*cos θ+g*sin θ+a)+fw)/((Ke*Km)*im/R)).

The formula can be transformed into ((Ke*Km)*im/R)*Te_cal=(m2*(g*f*cos θ+g*sin θ+a)+fw).

The calculation formula of (((Ke*Km)*im/R)*Te_cal) on the left of the formula represents the vehicle driving force (called F1) generated by the power unit; the calculation formula of (m2*g*f*cos θ+m2*g*sin θ+m2*a+fw) on the right represents the mechanical integrated operation force (called Y1) of the vehicle; and if all carriages of a high-speed rail vehicle are regarded as an integral vehicle, the calculation formula can be adopted directly.

Assuming that the high-speed rail vehicle can be divided into three sections (or three segments) and each section (or each segment) has a separate power unit, multiple vehicle driving forces (such as F1, F2 and F3) and the corresponding mechanical integrated operation force (such as Y1, Y2 and Y3) of each section (or each segment) of the vehicle can be generated; when the operation parameters (f, θ, a and fw) of all sections (or all segments) of the vehicle are different (especially when the pavement slopes θ are different), the mechanical integrated operation force (such as Y1, Y2 or Y3) of each section (or each segment) of the vehicle can be measured and calculated respectively, and then the formula F1+F2+F3=Y1+Y2+Y3 is used; and the mode is applicable to the operation of vehicles with multiple sections (or multiple segments).

The above solutions are basic solutions of the method (#2) or the system (#2); and any one or more of the following preferred solutions 1, 2, 3, 4, 5, 6, 7, 8, 9, 10, 11, 12, 13, 14, 15, 16 and 17 are further provided based on the basic solutions of the method (#2) or the system (#2).

1. Further, in the method (#2) or the system (#2), the “data at least including the joint operation value of the measurement and calculation object” further include operation environment information; the data at least including the joint operation value of the measurement and calculation object and the operation environment information are acquired to identify the power transmission conditions of the vehicle. The solution can further improve the accuracy for identifying the power transmission conditions of the vehicle.

In the present invention, the operation environment information of the vehicle includes the road conditions, the load conditions, whether the vehicle skids, whether the vehicle is tilted, etc.; the vehicle operation environment abnormality includes road condition abnormality, load condition abnormality, vehicle skidding, tilting, etc., so that the road condition abnormality, the load condition abnormality and other abnormal conditions can be excluded by acquiring the operation environment information of the vehicle. Specific note: the load condition abnormality in the present invention refers to abnormal changes of the vehicle mass during operation (e.g., the personnel jump out of the vehicle, the carried goods mass is abnormal, a tail carriage falls off, etc.), and is significantly different from overload. The typical road conditions include road roughness, etc.

The operation environment information is acquired in multiple modes: road bump and personnel jumping in the vehicle can be measured by a related vibration sensor and an acceleration sensor; the road condition abnormality can be measured and identified by optical facilities, radar and other facilities; sliding humidity of the pavement can be identified by a rain sensor; the vehicle tilting can be identified by a transversely arranged tilting angle sensor or acceleration sensor; the vehicle skidding can be learned by comparing the rotating speed data of the vehicle rotating component with the measured longitudinal velocity; and the selection time of the joint operation value and the selection time of the operation environment information are within the preset time range. The operation environment information is the external environment information. The operation environment information abnormality indicates that the value of the information exceeds the preset normal range.

2. Further, the previous method (#1) or system (#1) or method (#2) or system (#2) also includes the following solutions:

When the measurement and calculation object is any one parameter of the vehicle operation parameters except the vehicle mass, the value of the gross vehicle mass included in the input parameters (i.e., required to calculate the joint operation value) is obtained based on the vehicle motion balance calculation prior in time, and the value refers to the actual value; that is, before the processing solutions in the method (#1) or the system (#1) or the method (#2) or the system (#2)are performed, the gross vehicle mass is used as the measurement and calculation object first to perform the vehicle motion balance calculation (the calculation is the prior calculation) so as to obtain the value of the gross vehicle mass; the value is usually the actual value at the time of the prior calculation; and then the actual value is used for the vehicle motion balance calculation of step S2 in the measurement and calculation method (#1).

The value of the vehicle mass is acquired in multiple modes, including manual inputting, system presetting, etc.; but it is preferred to acquire the value of the vehicle mass through the vehicle motion balance calculation, because the solution can be adopted to automatically follow great changes of the carried goods mass (such as buses, trucks and ordinary private vehicles), and improve the power transmission abnormality monitoring accuracy.

3. Preferably, in the previous measurement and calculation method (#1) or system (#1) or method (#2) or system (#2), any one parameter of the vehicle mass, the system intrinsic parameters and the mass change type object mass is used as the measurement and calculation object; or, any one parameter of the vehicle operation parameters except the longitudinal acceleration is used as the measurement and calculation object; or, any one parameter of the vehicle operation parameters except the source power parameters is used as the measurement and calculation object; or, any one parameter of the vehicle operation parameters except the longitudinal acceleration and/or the source power parameters is used as the measurement and calculation object.

The solution has the following beneficial significances:

The preferred measurement and calculation object is the vehicle mass which is relatively stable in current operation of the vehicle and is convenient for the vehicle operator to intuitively and visually judge the monitoring effect, thereby greatly improving the monitoring credibility.

The second preferred measurement and calculation object is the system intrinsic parameters (especially the rolling resistance coefficient or the efficiency coefficient); and the parameters have little change in the amplitude during vehicle operation, and are easy to be measured, controlled and compared.

The next preferred measurement and calculation object is the mass change type object mass (the fuel mass); because the fuel mass is changed relatively slowly, the effect is better than that of using the source power parameters or the mechanical operation parameters as the measurement and calculation object; but the joint operation value and the reference value may be close to zero (e.g., fuel shortage) and cannot be calculated/monitored accurately, so the monitoring effect is worse than that of using the vehicle mass and the system intrinsic parameters as the measurement and calculation object.

If the source power parameters or the mechanical operation parameters (such as the longitudinal velocity, longitudinal acceleration, etc.) are used as the measurement and calculation object, because the joint operation value and the amplitude of the measured value serving as the reference data may be changed rapidly and may be in a low amplitude state at any time, it is more likely to cause a measurement error relative to full-scale measurement, thereby reducing the accuracy/performance, even invalidating the monitoring.

The vehicle may be mostly in a constant-speed operation state (including constant-high-speed operation), the longitudinal acceleration is close to zero at this moment; compared with the solution of using any one parameter of the vehicle operation parameters except the longitudinal acceleration as the measurement and calculation object, using the longitudinal acceleration as the measurement and calculation object is a poor choice and may lead to inaccurate monitoring mostly.

III. The present invention provides a method (#3) for monitoring vehicle overload, including the following steps:

obtaining the joint operation value of the vehicle mass of the vehicle, wherein the joint operation value is calculated based on the longitudinal dynamic model of the vehicle; and judging whether the vehicle is overloaded according to the acquired joint operation value and the maximum vehicle load safety permissive value of the vehicle.

The present invention provides a system (#3) for monitoring vehicle overload, including a monitoring module (#3) for realizing the method (#3); i.e., the system (#3) includes a joint operation value acquisition module (1) and an overload judgment module (2); the joint operation value acquisition module (1) is used for acquiring the joint operation value of the vehicle mass of the vehicle; the joint operation value is calculated based on the longitudinal dynamic model of the vehicle; and the overload judgment module (2) is used for judging whether the vehicle is overloaded according to the acquired joint operation value and the maximum vehicle load safety permissive value of the vehicle.

Implementation description for the technical solution: the overload judgment and the power transmission condition judgment are essentially and significantly different.

The purpose of the overload judgment is as follows: to judge whether the personnel/goods carried by the vehicle are overweight.

The technical solution for the overload judgment: a standard setting manner: the judgment standard is set according to legal vehicle capacity that is some safety limit threshold value; and a specific triggering manner is as follows: the alarm is started as long as the vehicle mass exceeds 1.0 time of the maximum legal vehicle capacity.

The purpose of power transmission condition judgment: to identify the operation conditions of the power or transmission system (itself) of the vehicle (and whether it is abnormal).

A setting manner of the reference data for power transmission condition judgment is as follows: the power transmission condition identification value (i.e., the second permissive range) is required to be as close to the actual value of the vehicle mass as possible, and the value can flexibly shift along with the actual value of the vehicle mass; the power transmission condition identification value can be much smaller than the maximum legal vehicle capacity, and can also be greater than the maximum legal vehicle capacity; and it is completely different from the setting standard based on fixed type and limited type maximum legal vehicle capacity.

Further, the method (#3) further includes a step B: performing any one or more of the following solutions B1, B2 and B3:

B1. If the judgment result includes yes, the set overload processing mechanism is started; B2. the judgment result is outputted; and B3. the judgment result is stored.

Preferably, in the solution B2 or the solution B3 of the method (#2) or the step B of the method (#3), the output is performed on the man-machine interfaces of the in-vehicle electronic device and/or the portable personal consumer electronic product.

Compared with a special monitoring system for monitoring, the solution can greatly reduce hardware cost of monitoring. In the present invention, output on the man-machine interfaces includes displaying and/or voice-prompting output in one or more manners of word, image, sound, voice and the like. The technical solution is contributive to and used for reflecting or analyzing or judging the vehicle operation conditions (by the drivers and the passengers in an intuitive and audible manner).

The in-vehicle electronic device includes any one or more of a special electronic surveillance device, an in-vehicle navigation system, reversing radar, an in-vehicle center console, a driving screen display system, an in-vehicle dashboard, a driving recorder and an in-vehicle video monitoring system; the portable personal consumer electronic product includes any one or more of a mobile phone, a smart watch, a smart hand ring, a palmtop computer, a digital camera and a game machine; other electronic devices (such as experimental computers, oscilloscopes, etc.) temporarily placed in the vehicle for an experimental purpose to do not belong to the in-vehicle electronic device in the present invention; and only electronic devices configured on the vehicle for normal operation of the vehicle can be called the in-vehicle electronic device.

The drivers and the passengers refer to the drivers and/or the passengers in the vehicle; the drivers and the passengers also are personnel in the vehicle; for example, when the carried goods mass in the vehicle mass is used as the measurement and calculation object, the drivers and the passengers directly judge whether the current operation of the vehicle is normal through the joint operation value of the weight of the passengers displayed on the electronic device.

For example, when the longitudinal velocity (or the source power parameters) is used as the measurement and calculation object, the drivers and the passengers can directly judge whether the current operation of the vehicle is normal through the joint operation value displayed on the electronic device and the actual value of the measurement and calculation object observed on the dashboard. Therefore, the technical solution is also an important progress compared with the prior art.

4. Further, the previous method (#1) or system (#1) or method (#2) or system (#2) or method (#3) or system (#3) further includes the following solution (a solution 1 for identifying the operation conditions and improving calculation performance): the joint operation value of the measurement and calculation object is calculated according to different power unit operation conditions respectively; i.e., the power unit operation conditions are acquired first, and then the power unit operation conditions are associated with the calculation.

Implementation details of the solution: the vehicle is usually in the power unit driving state during acceleration, on a flat road or during uphill operation; and the vehicle is easy to enter the power unit braking state during deceleration or downhill operation.

As shown in embodiment 17 or the alternative embodiment 9 for embodiment 41, when the power unit operation condition is the power unit driving state, the energy/power transmission direction is usually from the power unit to the mechanical transmission system and then to the vehicle body; and the joint operation value of the measurement and calculation object is calculated by multiplying the value of the source power parameter by the efficiency coefficient less than 1.

As shown in embodiment 17, when the power unit operation condition is the power unit braking state, the energy/power transmission direction is usually from the vehicle body to the mechanical transmission system and then to the power unit; and the joint operation value of the measurement and calculation object is calculated by dividing the value of the source power parameter by the efficiency coefficient less than 1.

The solution has the following beneficial significances: because the vehicle is often decelerated or runs downhill and often enters the power unit braking state, the existing well-known technology is still in a blind area in the research on the power unit braking state when the joint operation is performed, and the same calculation formula is adopted at the moment of driving and braking in the existing well-known technology, thereby leading to an error naturally; and compared with the prior art, the solution of the present invention can greatly increase the calculation accuracy of the joint operation value of the measurement and calculation object.

5. Further, the previous method (#1) or system (#1) or method (#2) or system (#2) or method (#3) or system (#3) also includes the following solution (the solution 1 for acquiring the fuel mass and improving calculation performance): the parameters involved in the calculation include the mass change type object mass.

Implementation Description for the Solution:

An acquisition method of residual fuel mass mf0 is as follows: a sensor measures the value of mf0 through weighing; or a residual fuel volume is measured first through liquid level volume, a fuel gauge, etc., and then the value of mf0 is calculated through related coefficients. The acquisition method of consumed fuel mass mf1 is as follows: the flow or volume of the consumed fuel is acquired by measuring with a flow meter or reading OBD data or reading data of an electronic-controlled fuel injection system, and then the value of mf1 is calculated through the related coefficients.

When the measurement and calculation object is the gross vehicle mass m2, the joint operation value of m2 is acquired by vehicle motion balance calculation; the value of mf0 can be acquired; and the actual value m2_org of the gross vehicle mass is calculated by the following formula: m2_org=m1+m0+mf0. When the measurement and calculation object is the source power parameter or the system operation parameter (non-fuel mass), the value of mf0 can also be acquired or the value adjustment of (mf2−mf1) can be acquired through the actual value of the gross vehicle mass m2 required to calculate the joint operation value of the measurement and calculation object through the vehicle motion balance calculation.

Embodiment 43: when the measurement and calculation object is the residual fuel mass, the joint operation value of the gross vehicle mass m2 is acquired by the vehicle motion balance calculation first, and then the joint operation value mf0_cal of the residual fuel mass is acquired as follows: mf0_cal=m2−m0−m1; the measured value mf0 (obtained through fuel gauge measurement) of the residual fuel mass is acquired; the measured value is used as the actual value in the reference data; meanwhile, the power transmission condition difference value is set as mf0/5; whether (|mf0_cal−mf0|>(mf0/5)) is true is judged; and if (|mf0_cal−mf0|>(mf0/5)) is true, it is judged that the power transmission conditions are abnormal.

When the mass change type object mass further contains the mass of other objects besides the fuel mass, the mass can also be calculated by referring to the above method.

The solution has the following beneficial significances: the calculation monitoring sensitivity and accuracy can be improved; especially for the fuel cell type electric vehicles, the technical solution can track the change of fuel mass in fuel cells and has great significance.

6. Further, the parameters in the previous method (#1) or system (#1) or method (#2) or system (#2) or method (#3) or system (#3) involved in the calculation include any one or more parameters of the efficiency coefficient, the rolling resistance coefficient and the pavement gradient.

When the vehicle runs uphill, downhill and on a flat road, the slope resistance component (m2*g*sin θ) is changed greatly; and the parameters of the pavement gradient are acquired during calculation to greatly improve the accuracy and avoid errors.

Implementation description for the solution: (the solution 1 for calculating the longitudinal dynamic model of the vehicle obtained based on the difference value between the parameters acquired at two different time points):

As shown in embodiment 3 and/or embodiment 15, the longitudinal dynamic model of the vehicle obtained based on the difference value between the parameters acquired at two different time points (such as time1 and time2) is (m2=ΔF/Δa) or transformation of the expression; the typical transformation is (Δa=ΔF/m2) or (ΔF=m2*Δa); the model is a special transformation of the basic and typical longitudinal dynamic model of the vehicle (such as fq=m2*(g*f*cos θ+g*sin θ+a)+fw); the model does not adopt a regular Newton's second law (at a single time point, the resultant external force applied to the object is 0), ΔF does not refer to the resultant external force for single operation, nor driving force measured at some time point, but refers to the difference value (fq2−fq1) of power obtained by calculation at two different time points; Δa refers to the difference value between accelerations at two different time points, Δa=(a2−a1); the parameters of the rolling resistance coefficient f and the pavement gradient θ are eliminated from the formula, so that the calculation is simple, but it should be ensured that f, θ, the wind resistance fw and the gross vehicle mass m2 at two different time points are close, otherwise, the calculation is inaccurate; and it should be ensured that Δa is not zero.

The solution has the following beneficial significances: the system operation parameter group involved in the vehicle motion balance calculation includes the rolling resistance coefficient and the pavement gradient; and the monitoring accuracy, sensitivity and application range can be greatly improved in comparison with the solution for the calculation excluding the two parameters (usually using the longitudinal acceleration as the core calculation parameter).

7. Further, the previous method (#1) or system (#1) or method (#2) or system (#2) or method (#3) or system (#3) further includes the following steps:

outputting and/or storing the value of the vehicle mass; and/or outputting and/or storing the calculated value of the measurement and calculation object; and/or outputting and/or storing the value calculated based on the longitudinal dynamic model of the vehicle according to any one or more of the system intrinsic parameters, the longitudinal velocity and the source power parameters.

The solution has the following beneficial significances:

The value of the vehicle mass is outputted so as to facilitate an operator to intuitively judge the vehicle power transmission conditions, bring great significance for improving credibility of the processing method, and help the operator to identify whether the current power transmission abnormality judgment is normal at a glance; for example, when a driver with the weight of 70 kg drives individually, if the vehicle displays that the carried mass is 200 KG15 heavy as a calf or is 20 KG light as a small sheep, the driver can immediately identify whether it is normal; and the joint operation value of the vehicle mass, like a black box function for aircraft safety, is stored to facilitate postmortem analysis.

8. Further, in the previous method (#1) or system (#1) or method (#2) or system (#2) or method (#3) or system (#3), when the source power parameters are energy type source power combined parameters, the energy accumulation time is controlled within 1 day, 1 hour, 30 minutes, 10 minutes, 1 minute, 30 seconds, 20 seconds, 10 seconds, 5 seconds, 2 seconds, 1 second, 100 milliseconds, 10 milliseconds, 1 millisecond or 0.1 millisecond.

9. Further, the previous method (#1) or system (#1) or method (#2) or system (#2) or method (#3) or system (#3) further includes the following solution (the solution 1 for preferably using the source power parameters as the motor driving parameters): the source power parameters in the longitudinal dynamic model of the vehicle are the motor driving parameters; and the technical solution is particularly applicable to the conditions that the power unit of the vehicle is or includes the motor.

The solution has the following beneficial significances:

Because the application of the electric power parameters (especially the motor driving parameters) usually belongs to the technology known in the field of power electronics, it is convenient for low-cost and high-accuracy measurement and acquisition; and because the technology has low cost and high measurement accuracy and sensitivity, the technology has significant cost advantages and performance advantages relative to the application of high-cost torque sensor for acquiring signals. However, because the vehicle motion balance calculation belongs to an industrial technology in the field of whole vehicle operation control, the motor driving parameters are used as the source power parameters for performing the vehicle motion balance calculation, or further monitoring the vehicle power transmission conditions (or whether abnormal), or further monitoring the vehicle overload. According to the present invention, the electric power parameters (especially the motor driving parameters) are creatively combined with the vehicle motion balance calculation across the field; thus, the present invention is creatively applied to a new vehicle power transmission abnormality monitoring field and has great significance for the vehicle operation safety. The current mainstream overload monitoring usually belongs to a category of vehicle operation management (the prior art is usually performed by manual view and manual calculation of the number of passengers or weighing with scales).

10. Further, the previous method (#1) or system (#1) or method (#2) or system (#2) or method (#3) or system (#3) further includes the following solution (the solution 1 for preferably using the source power parameters in the fuel power parameters): when the longitudinal dynamic model of the vehicle includes the fuel power parameters, the fuel power parameters are any one or more parameters of the cylinder pressure, the fuel consumption rate, the engine airflow and the engine load report data; and the solution is particularly applicable to the conditions that the power unit of the vehicle is or includes the fuel engine.

The solution has the following beneficial significances: the cylinder pressure can directly monitor the operation conditions of an engine piston (e.g., whether the cylinder scoring/piston operation resistance is increased) and the rear-end rotary operation type power or transmission components; and the cylinder pressure can be measured by the pressure sensor arranged in a cylinder combustion chamber conveniently (because a cylinder cover is an inactive component, installation of the sensor and cables thereof is convenient).

The fuel combustion is a source of the driving energy and power of the fuel power vehicles; a fuel consumption rate can be accurately acquired by a flow sensor or the fuel injection parameters; the fuel consumption rate fm1 (the fuel consumption rate at an injection output side of the fuel injection system) in the engine is used as the source power parameter for monitoring the power transmission, for not only monitoring the operation conditions of the engine piston and the rear-end rotary operation type power or transmission components, but also directly monitoring whether the combustion of fuels in the cylinder is normal (poor combustion of the fuels is also one of vehicle abnormalities); if a signal acquisition point of the fuel consumption rate is the input side of the fuel injection system, whether the fuel injection system is operated normally can be monitored within a wider range; i.e., the operation conditions of the fuel injection system, the engine cylinder combustion system, the engine piston and the rear-end rotary operation type power or transmission components of the vehicle can be identified through a few drops of fuel, thereby bringing great significance for the vehicle safety.

Use of the engine airflow (essentially same as the fuel consumption rate) and the engine load report data as the source power parameters for monitoring the vehicle and the power transmission has greater cost advantages than use of high-cost torque sensor for acquiring the signals.

The previous method (#1) or system (#1) or method (#2) or system (#2) or method (#3) or system (#3) also allows the system to switch the source power parameters; when the vehicle is operated at low speed and high torque, the torque type parameters can be used as the source power parameters; and when the vehicle is operated at high speed and low torque, the power type parameters can be used as the source power parameters, so as to improve the calculation accuracy of the joint operation value of the measurement and calculation object.

11. Further, in the previous method (#1) or system (#1) or method (#2) or system (#2) or method (#3) or system (#3), the vehicle operation parameters include the vehicle mass, the source power parameters and the system operation parameters; and the system operation parameters include the mechanical operation parameters, the system intrinsic parameters and the mass change type object mass.

12. Further, in the previous method (#1) or system (#1) or method (#2) or system (#2) or method (#3) or system (#3), the vehicle is any one of a high-speed rail vehicle, a bullet train, an electric locomotive, a streetcar, a maglev train, a pipe train, a bus, a truck, an ordinary private vehicle, an ordinary train, a track vehicle, an electric vehicle, a fuel cell power vehicle, a motorcycle, a two-wheeled or three-wheeled vehicle with a power system, and an aircraft which is operated on land and has an air lift lower than a preset threshold value or a longitudinal velocity lower than a preset value. The technical solution has the following beneficial significance: compared with other vehicles, such as electric bicycles and monocycles, the above vehicles have greater safety significance in power transmission monitoring.

13. Further, in the previous method (#1) or system (#1) or method (#2) or system (#2) or method (#3) or system (#3), when the vehicle is in the unstable driving state, the processing operation and/or the processing result is canceled; correspondingly, the processing is calculation, identification or monitoring. When at least one of the source power parameters, the mechanical integrated operation force and the velocity of the vehicle is less than the preset threshold value, or when the power unit operation condition of the vehicle is the power unit braking state, the vehicle is in the unstable driving state.

14. Further, the previous method (#1) or system (#1) or method (#2) or system (#2) or method (#3) or system (#3) is performed when the vehicle is controlled to operate by the power unit.

15. In the previous method (#1) or system (#1) or method (#2) or system (#2) or method (#3) or system (#3), a basic setting solution for the values of the input parameters is as follows: in any one of the methods and/or systems according to the present invention, the acquired values of the input parameters of the longitudinal dynamic model of the vehicle are reasonable values (also called acceptance values or acceptable values); different input parameters have different reasonable values; the reasonable values of the parameters (including the input parameters) refer to the values of the parameters capable of realizing use with practical value (including use for identifying the power transmission conditions of the vehicle or monitoring the overload) or representing natural attributes of the parameters.

At least one of the parameters to be measured and/or the source power parameters and/or the mechanical operation parameters and/or the mass change type object mass included in the input parameters is set based on the actual value; and at least one of the unmeasurable parameters and/or the system intrinsic parameters included in the input parameters is set based on the preset value.

For example, the value of the gross vehicle mass included in the input parameters is the actual value; the actual value may be either a current actual value or a preset actual value; the current actual value or the preset actual value both is a reasonable value of the gross vehicle mass included in the input parameters; and the meaning of the preset actual value of the parameter is that the value is a value close to the actual value of the parameter at a preset time point (not a current time point).

For example, if the input parameters include the gross vehicle mass, it is assumed that the vehicle is weighed 1500 KG and has a limited load capacity of 500 KG; if the value of the gross vehicle mass is set to the maximum value (2000 KG) or the minimum value (1500 KG), when the conditions of other input parameters are unchanged, a difference between the results obtained through the vehicle motion balance calculation may be 25%, causing a decrease of the vehicle motion balance calculation accuracy and no significance for the safety monitoring.

The meaning of the preset actual value in the present invention can also be understood as the actual value of the parameter acquired at the preset time point (not the current time point); and the meaning of the preset actual value of the vehicle gross mass is that the value is a value close to the actual value of the gross vehicle mass at the preset time point.

For example, the value of the parameter in a first type of parameters except the gross vehicle mass included in the input parameters is set based on the current actual value of the parameter; the current actual value is the reasonable value of the first type of input parameters; and in the present invention, the first type of parameters refer to any one parameter of the parameters to be measured and/or the source power parameters and/or the mechanical operation parameters and/or the mass change type object mass.

Preferably, at least one parameter in the first type of parameters except the gross vehicle mass in the input parameters is set based on the measured value, such as the source power parameter, the velocity, the acceleration, etc.; preferably, at least one is all.

Another possibility is that if the difference between the vehicle operation conditions at the moment of selecting the historical record value of the parameter and the current vehicle operation conditions is lower than the preset threshold value, the historical record value is also the reasonable value of the first type of input parameters.

For example, the value of the parameter in a second type of parameters except the gross vehicle mass included in the input parameters is set based on the current actual value of the parameter or the value within the safety range of the parameters. In general, the value within the safety range of the parameters is set in a preset manner; and the current actual value of the parameter or the value within the preset safety range of the parameters is the reasonable value of the second type of input parameters. In the present invention, the second type of parameters refer to any one or more parameters of the unmeasurable parameters and/or the system intrinsic parameters; for example, the efficiency coefficient, the rolling resistance coefficient, the integrated transmission ratio, the driving wheel radius and the gravity acceleration are usually parameters in the second type of parameters; and preferably, the value within the safety range is the calibration value.

Selection time of the parameter values: the selection time of the value of each parameter is controlled in a preset time range, such as 10 milliseconds or 1 mm, so the preset time range of the valuing time of each parameter value can be adjusted according to the vehicle operation conditions, i.e., when the vehicle operation conditions are unchanged, the value of the parameter at any time point when the operation conditions are unchanged can be acquired. In the absence of limited description, the value of the parameter is usually the current value which is a value close to the actual value. When the measurement and calculation object is any one parameter of the vehicle mass and the system intrinsic parameters, the valuing time of the joint operation value (along with the values of the parameters required to calculate the joint operation value) is preferably that the valuing is performed within the preset time range (synchronously as far as possible); but the valuing time (the set time) of the reference data is not required to be same as the valuing time of the joint operation value; and the descriptions for the valuing time and the acquisition time of the parameter values are applicable to any embodiment of the present invention.

16. Preferably, in the previous method (#1) or system (#1) or method (#2) or system (#2) or method (#3) or system (#3), the parameters (or the number of the parameters) valued through measurement in the input parameters are set; the parameters are set based on the measured value; other parameters can be set by the preset value; the more the measured parameters are, the higher the accuracy is and the better the monitoring performance is; the fewer the measured parameters are, the lower the cost is; and users and manufacturers can customize according to respective different situations.

17. Preferably, in the previous method (#1) or system (#1) or method (#2) or system (#2) or method (#3) or system (#3), the method and/or the system is started on boot or started after receiving a manual command. In the present invention, the method and/or the system can be started on boot without human operation, and is self-operated after the electronic device integrated with the processing method is powered on; and the self-operation can be started immediately after power-on and can also be started after the preset time. The preset time can be used as standby time only; other application programs are not performed in the period of time; meanwhile, other application programs can also be performed within the preset time; the self-operation can be started by further using the time of performing other application programs to a certain extent (such as performing half or finishing performing) as the time point, or can be started directly through the start command transmitted by the other application programs. In the operation mode of starting after receiving the manual operation command, the operation command is used for controlling the measurement and calculation method to be operated, and is especially generated after an operation button, a touch screen voice system, other mobile electronic devices (such as mobile phones) and the like in the vehicle are operated manually.

Optionality of the start-on-boot or manual start has great significance. Because the method and/or the system is important to the vehicle operation safety, the start-on-boot can be chosen to prevent the personnel from forgetting to start, operating by mistake and other unfavorable factors, and help to record the entire safety monitoring data; and in some cases, when the vehicle processing method is not adjusted, if the automatic start is chosen, it may lead to increase of false alarm rate and other adverse effects, so it is beneficial to choose manual start in some cases.

The research of the data (especially big data) is an important scientific subject. The calculation for the joint operation value of the measurement and calculation object of the vehicle based on the longitudinal dynamic model of the vehicle (i.e., the vehicle motion balance calculation) can be regarded as unique data; and in the prior art, there is a lack of research on the influence of “vehicle motion balance calculation” on the vehicle operation safety.

In the prior art, the research on influence of the parameters involved in the vehicle motion balance calculation, in particular the parameters (especially the efficiency coefficient and the rolling resistance coefficient) closely related to the safety in the unmeasurable parameters and/or the system intrinsic parameters, on the vehicle operation safety is insufficient; and the method (#1) proposed by the present invention achieves a major breakthrough for the vehicle operation safety technology.

In the prior art, the research on the influence of different values (the minimum value, the maximum value and the actual value) of the vehicle mass on the vehicle operation safety is insufficient; and a complete and automatic power transmission condition monitoring system cannot be constructed. The method (#2) of the present invention proposes that the actual value of the vehicle mass is used for performing the vehicle motion balance calculation; in particular, the normal change of the load is tracked automatically through a self-learning mechanism to flexibly adjust the reference data (the actual value or the second permissive range), thereby realizing the major breakthrough for the vehicle operation safety monitoring technology.

In the method (#2), a huge difference in actual effects caused by using different parameters as the measurement and calculation objects is intensively explored. If the acceleration is used as the measurement and calculation object for safety monitoring, since the vehicles similar to the high-speed rail vehicles are operated at a constant speed (300 km/h) mostly, i.e., the acceleration is close to zero, the measurement accuracy is very low, so the subsequent safety effect is very bad when the vehicle mass is used as the measurement and calculation object.

In the present invention, the data characteristics of various source power parameters (in terms of acquisition ways, acquisition cost, parameter sensitivity, accuracy, etc.) are intensively researched. The motor driving parameters are preferably used as the source power parameters in the vehicle motion balance calculation; and the cylinder pressure, the fuel consumption rate, etc. in the fuel power parameters are preferably adopted to realize significant improvement in cost, sensitivity, accuracy and other performance.

The present invention is directed to the data characteristics of various data (such as the rolling resistance coefficient, the pavement gradient, the mass change type object mass, the power unit operation condition and the operation environment information), and how to output and store the data, in order to achieve a better safety monitoring effect; and it is an important creative point of the concept of the present invention that the knowledge of completely different fields, such as air lift factors in the field of aircrafts, is combined with the calculation of the longitudinal dynamic model of the vehicle to perform the safety monitoring on the aircraft operated on the ground at a low speed.

The explanation of terms, word explanation, calculation formulas, parameter acquisition methods, implementation modes, embodiments and alternative embodiments, extended embodiments and other contents at any position in the present application document are applicable to any one of the front and rear technical solutions; and the contents of all parts can be combined and replaced arbitrarily.

Because the modern vehicle has a mature power control unit, a central controller, a navigation system and a network transmission system, and has a mature software and hardware platform, the power control unit has a mature internal source power parameter measurement system and a mature in-vehicle man-machine interaction interface (display or voice mode).

The method (#1) or the method (#2) or the method (#3) provided by the present invention can be operated either in an individual device or can also be integrated into the existing central controller, the power control unit, the navigation system or other in-vehicle electronic devices for operation.

The system (#1) or the system (#2) or the system (#3) provided by the present invention may exist either as the individual device, and can also be integrated into the existing central controller, the power control unit, the navigation system or other in-vehicle electronic devices for operation.

The threshold value in the present invention can also be called a threshold, and they are equivalent. The solution in the present invention can also be used directly when the aircraft (such as a flyable vehicle, etc.) is operated on land in a vehicle mode; or when the aircraft (such as a jet aircraft, a piston type aircraft, etc.) is operated on land at a low speed, and the longitudinal operation speed is lower than a certain amplitude value, or when the air lift force generated by the aircraft is lower than the preset threshold value (such as 5%-10% of the weight of the aircraft); the aircraft is used as the vehicle according to the present invention; i.e., the vehicle is the aircraft which is operated on land and has the air lift force lower than the preset threshold value or has the longitudinal velocity lower than the preset value; the joint operation value of the measurement calculation object is calculated based on the longitudinal dynamic model of the vehicle; the source power parameters of the aircraft can be acquired by the above multiple source power parameter acquisition ways; in addition, a pressure sensor or a flow sensor can also be set at a position behind an engine nozzle; the driving force signal outputted by the engine is calculated by a sensor signal; and the fuel consumption rate, the air pressure or the combustion gas pressure in the engine, etc. can be acquired from the fuel supply system of the engine and the engine. The solution of the present invention is convenient for the aircraft to monitor the power transmission conditions (and whether the power transmission conditions are abnormal) at the moment of operating on land at a low speed; once the abnormality is found, a power transmission abnormality warning signal can be sent out before the aircraft flies to the sky, to start the power transmission abnormality processing mechanism (e.g., check abnormality reasons, fault reasons, refuse to take off, etc.); thus, the abnormalities are found on the ground to avoid finding the fault (which may lead to fatal crash) after the aircraft flies to the sky; and the solution has significant value for the safety operation of the aircraft. The above contents are further detailed descriptions for the present invention in combination with specific preferred embodiments. The specific embodiments of the present invention shall not be considered to be limited to the descriptions. Several simple deductions or substitutions can also be made for those ordinary skilled in the art of the present invention without departing from conception of the present invention, and should be considered as falling within the protection scope of the present invention.

What is claimed is:

1. A method for identifying power transmission conditions of a vehicle, comprising a solution:
a measurement and calculation object is one of vehicle operation parameters; the data at least comprising a joint operation value of the measurement and calculation object are acquired for identifying the power transmission conditions of the vehicle; the joint operation value of the measurement and calculation object is a result calculated based on the acquired values of the input parameters; the calculation is a calculation based on the longitudinal dynamic model of the vehicle; and the input parameters are all parameters in the model except the measurement and calculation object.

2. The method of claim 1, wherein the method further comprises any one or more of the following characteristics A1, A2 and A3: A1, the parameter during calculation comprises or is a pavement slope; A2, if the model comprises rolling resistance, a calculation formula of the rolling resistance comprises the rolling resistance coefficient; and A3, when the measurement and calculation object is any one of the parameters to be measured and/or the source power parameters and/or the mechanical operation parameters, the acquired value of the gross vehicle mass included in the input parameters is the actual value.

3. The method of claim 1, wherein “the measurement and calculation object is one of the vehicle operation parameters, and the data at least comprising the joint operation value of the measurement and calculation object is acquired for identifying the power transmission conditions of the vehicle” comprises any one or more of the following solutions B1, B2, B3 and B4:
B1: the measurement and calculation object is one of the vehicle operation parameters; the data at least comprising the reference data of the measurement and calculation object and the joint operation value of the measurement and calculation object are acquired; and the power transmission conditions of the vehicle are identified based on the data;
B2: when the measurement and calculation object is any one of the vehicle mass and/or the unmeasurable parameters and/or the system intrinsic parameters, the data at least comprising the joint operation value of the measurement and calculation object are acquired; and the data are outputted and/or stored;
B3: when the measurement and calculation object is any one of the vehicle operation parameters except the unmeasurable parameters and/or the system intrinsic parameters, the data at least comprising the joint operation value of the measurement and calculation object and related data of the measurement and calculation object are acquired; the data are outputted and/or stored; the related data of the measurement and calculation object are data comprising the second permissive range of the measurement and calculation object and/or the actual value of the measurement and calculation object; and
B4: when the related data of the measurement and calculation object are displayed on the man-machine interfaces of an in-vehicle electronic device and/or a portable personal consumer electronic product, the data at least comprising the joint operation value of the measurement and calculation object are acquired; and the data are outputted on the man-machine interfaces of the in-vehicle electronic device and/or the portable personal consumer electronic product.

4. The method of claim 3, wherein the solution B1 comprises any solution of 4A1 and 4A2:
4A1, when the measurement and calculation object is any parameter of the parameters to be measured and/or the source power parameters and/or the mechanical operation parameters and/or the mass change type object mass and/or the vehicle mass: reference data of the measurement and calculation object is data at least comprising an actual value of the measurement and calculation object and/or a second permissive range of the measurement and calculation object; the second permissive range is a range used for identifying the power transmission conditions; and the second permissive range is set based on the actual value; and
4A2, when the measurement and calculation object is any parameter of unmeasurable parameters and/or system intrinsic parameters: the reference data of the measurement and calculation object is data comprising a calibration value and/or an actual value and/or a second permissive range at least, and the second permissive range is a range used for identifying the power transmission conditions.

5. The method of claim 1, wherein the vehicle is any one of a high-speed rail vehicle, a bullet train, an electric locomotive, a streetcar, a maglev train, a pipe train, a bus, a truck, an ordinary private vehicle, an ordinary train, a track vehicle, an electric vehicle, a fuel cell power vehicle, a motorcycle, a two-wheeled or three-wheeled vehicle with a power system, and an aircraft which is operated on land and has air lift lower than a preset threshold value or a longitudinal velocity lower than the preset value.

6. The method of claim 1, wherein the source power parameters in the longitudinal dynamic model of the vehicle are the motor driving parameters; and/or when the longitudinal dynamic model of the vehicle comprises the fuel power parameters, the fuel power parameters are any one or more of the cylinder pressure, the fuel consumption rate, the engine airflow and the engine load report data.

7. The method of claim 1, wherein the measurement and calculation object is any one parameter of the vehicle mass, the system intrinsic parameters and the mass change type object mass; or the measurement and calculation object is any one parameter of the vehicle operation parameters except the longitudinal acceleration; or the measurement and calculation object is any one parameter of the vehicle operation parameters except the source power parameters; or the measurement and calculation object is any one parameter of the vehicle operation parameters except the longitudinal acceleration and/or the source power parameters.

8. The method of claim 1, wherein when the source power parameters in the longitudinal dynamic model of the vehicle are energy type source power combined parameters, the energy accumulation time is controlled within 1 day, 1 hour, 30 minutes, 10 minutes, 1 minute, 30 seconds, 20 seconds, 10 seconds, 5 seconds, 2 seconds, 1 second, 100 milliseconds, 10 milliseconds, 1 millisecond or 0.1 millisecond.

9. The method of claim 1, wherein the vehicle operation parameters comprise the vehicle mass, the source power parameters and the system operation parameters; and the system operation parameters comprise the mechanical operation parameters, the system intrinsic parameters and the mass change type object mass.

10. The method of claim 3, wherein the identification for the power transmission conditions of the vehicle in the solution B1 is to judge whether the power transmission conditions of the vehicle are abnormal.

11. The method of claim 3, wherein the output in the solution B2 or B3 is performed on man-machine interfaces of an in-vehicle electronic device and/or the portable personal consumer electronic product.

12. The method of claim 4, wherein in the solution 4A1 or 4A2, a second permissive range of the measurement and calculation object is within a safety range.

13. The method of claim 1, wherein the power transmission conditions of the vehicle are conditions of a system related to power transmission in the vehicle.

14. The method of claim 1, wherein the longitudinal dynamic model of the vehicle is a formula (fq=m2*(g*f*cos θ+g*sin θ+a)+fw) or a transformation of the formula, or the longitudinal dynamic model of the vehicle is a formula (Δa=ΔF/m2) or a transformation of the formula.

15. The method of claim 1, wherein when the input parameters comprise the gross vehicle mass, the value of the gross vehicle mass is the actual value.

16. The method of claim 7, wherein the actual value of the gross vehicle mass is obtained based on the vehicle motion balance calculation prior in time.

17. The method of claim 4, wherein in the solution 4A1, when the measurement and calculation object is any parameter of the vehicle mass, the actual value of the measurement and calculation object is set according to a joint operation value acquired by the vehicle motion balance calculation when the set conditions are met.

18. The method of claim 1, wherein the processing method also comprises the following solution: the power unit operation conditions are acquired, and the power unit operation conditions are associated with the calculation.

19. The method of claim 1, wherein the parameters involved in the calculation comprise any one or two of the efficiency coefficient and the mass change type object mass.
